(19) United States
(12) Patent Application Publication
(10) Pub. No.: US 2011/0032252 A1
(43) Pub. Date: Feb. 10, 2011

(54) STORAGE MEDIUM STORING DISPLAY CONTROL PROGRAM FOR CONTROLLING DISPLAY CAPABLE OF PROVIDING THREE-DIMENSIONAL DISPLAY AND INFORMATION PROCESSING SYSTEM

(75) Inventor: Keizo Ohta, Kyoto-shi (JP)

Correspondence Address: NIXON & VANDERHYE, P.C., 901 NORTH GLEBE ROAD, 11TH FLOOR, ARLINGTON, VA, 22203, US

(73) Assignee: NINTENDO CO., LTD., Kyoto (JP)

(21) Appl. No.: 12/845,970

(22) Filed: Jul. 29, 2010

(30) Foreign Application Priority Data
Jul. 31, 2009 (JP) 2009-178848

(51) Int. Cl. G06T 15/00

(52) U.S. Cl. 345/419

(57) ABSTRACT

A display control program includes three-dimensional display processing instructions for performing display processing using first and second input images containing a common object to be displayed and having a parallax so that the object is three-dimensionally displayed by a display, two-dimensional display processing instructions for performing display processing so that the object is two-dimensionally displayed as a two-dimensional image by the display, and display switch instructions for making a switch between three-dimensional display and two-dimensional display of the display. The display switch instructions are adapted to perform display processing so that the object is substantially non-displayed by the display for a prescribed period when a switch is made between a state of three-dimensionally displaying the object and a state of two-dimensionally displaying the object.

This nonprovisional application is based on Japanese Patent Application No. 2009-178848 filed with the Japan Patent Office on Jul. 31, 2009, the entire contents of which are hereby incorporated by reference.

### BACKGROUND OF THE INVENTION

1. Field of the Invention

The present invention relates to a storage medium storing a display control program capable of making a switch from three-dimensional display to two-dimensional display in such a manner that allows the switch to be perceived as natural, and to an information processing system.

2. Description of the Background Art

A method for providing three-dimensional display using two images having a prescribed parallax has conventionally been known. Namely, on the premise that a user views different images with the left and right eyes respectively in such a manner as seeing an image for the right eye in a field of view of the user's right eye and seeing an image for the left eye in a field of view of the user's left eye, a parallax is provided between the image for the right eye and the image for the left eye so that the user can perceive the stereoscopic depth.

Typically, images picked up by two respective image pick-up portions (what is called stereo cameras) arranged at a prescribed distance from each other symmetrically with respect to an optical axis to an object originally have a prescribed parallax. Therefore, by displaying images picked up by a right camera arranged on the right with respect to the optical axis to the object and a left camera arranged on the left thereto as the image for the right eye and the image for the left eye respectively on a display capable of providing three-dimensional display as described above, the object can three-dimensionally be displayed.

Alternatively, a plurality of images having a prescribed parallax can be obtained also by carrying out image pick-up a plurality of times by changing a position of one image pick-up portion along a horizontal direction, and thus the object can three-dimensionally be displayed also by using such picked-up images.

Such a display device capable of providing three-dimensional display can also display a two-dimensional image of an object by displaying an image for the right eye and an image for the left eye that are identical to each other (namely two-dimensional display). According to the disclosure of Japanese Patent Laying-Open No. 2004-294861 for example, a technique has been proposed that uses one display device switched between a three-dimensional display mode and a two-dimensional display mode so that both of the display modes are available.

In the case of the above-described three-dimensional display using a plurality of images (typically two images), the stereoscopic depth is obtained through the functions of human eyes and brain, and information provided to the right and left eyes is different from the information provided to the eyes seeing an ordinary space.

### SUMMARY OF THE INVENTION

The present invention has been made to solve such problems, and an object of the invention is to provide a storage medium storing a display control program capable of making a switch from three-dimensional display to two-dimensional display in such a manner that allows the switch to be perceived as natural, as well as an information processing system.

According to a first aspect of the present invention, a non-transitory storage medium encoded with a computer readable display control program and executable by a computer for controlling a display capable of providing three-dimensional display is provided. The computer readable display control program includes: three-dimensional display processing instructions for performing display processing using a first input image and a second input image containing a common object to be displayed and having a parallax, so that the object is three-dimensionally displayed by the display; two-dimensional display processing instructions for performing display processing so that the object is two-dimensionally displayed as a two-dimensional image by the display; and display switch instructions for making a switch between three-dimensional display and two-dimensional display provided by the display. The display switch instructions are adapted to perform display processing, when a switch is made between a state of three-dimensionally displaying the object and a state of two-dimensionally displaying the object, so that the object is substantially non-displayed by the display for a prescribed period.

For example, when a user's attention is given to a certain object to be displayed (subject) on a display and a switch is made from a state of three-dimensionally displaying the object to a state of two-dimensionally displaying the object, the stereoscopic depth is lost and the object seems to be discontinuous. In contrast, according to the first aspect of the present invention, display processing is performed so that the object is substantially non-displayed for a prescribed period, and therefore, the same object does not substantially appear continuously in time in a field of view of a user. Thus, user's eyes and brain are reset from three-dimensional display, and a switch from three-dimensional display to two-dimensional display can be made so that the switch is perceived as natural.

According to a preferred second aspect, the three-dimensional display processing instructions include stereoscopic depth determination instructions for determining a stereoscopic depth of three-dimensional display, by setting a relative positional relation, when the first input image and the second input image are displayed, between the first input image and the second input image having a prescribed parallax.

According to the second aspect of the present invention, the stereoscopic depth perceived by a user can be adjusted by appropriately setting the relative positional relation between the first and second input images. In this way, typically the stereoscopic depth of an object to which a user gives attention can be expressed as appropriate.

According to a preferred third aspect, the stereoscopic depth determination instructions include stereoscopic depth adjustment instructions for adjusting the stereoscopic depth of three-dimensional display by laterally changing the relative positional relation.

According to the third aspect of the present invention, when the stereoscopic depth is to be adjusted, it is only necessary to displace the first and second input images along a specific direction (lateral direction), and therefore, the amount of processing required for adjustment of the stereoscopic depth can be reduced.

According to a preferred fourth aspect, the stereoscopic depth adjustment instructions are adapted to successively change the relative positional relation, and the display switch instructions are adapted to make a switch from three-dimensional display to two-dimensional display when the relative positional relation satisfies a prescribed condition.

According to a preferred fifth aspect, the stereoscopic depth adjustment instructions are adapted to successively adjust the stereoscopic depth of three-dimensional display within a prescribed range from a shallowest side to a deepest side, by changing the relative positional relation, and the display switch instructions are adapted to make a switch from three-dimensional display to two-dimensional display when the stereoscopic depth reaches the deepest side of the prescribed range.

According to the fourth and fifth aspects of the present invention, the stereoscopic depth can be adjusted successively by successively varying the relative relation between the first and second input images. Further, when the relative positional relation between the first and second input images satisfies a prescribed condition, a switch is made from three-dimensional display to two-dimensional display. In this way, a user can seamlessly adjust the stereoscopic depth and seamlessly make a switch between three-dimensional display and two-dimensional display. Further, when the switch is made, display processing is performed so that the object is non-displayed. Thus, the switch from three-dimensional display to two-dimensional display can be made so that the switch is perceived as natural.

According to a preferred sixth aspect, the three-dimensional display processing instructions include partial image determination instructions for determining a first partial image and a second partial image that are respectively a partial area of the first input image and a partial area of the second input image and to be output to the display, in accordance with the relative positional relation set by execution of the stereoscopic depth determination instructions.

According to a preferred seventh aspect, the stereoscopic depth determination instructions include stereoscopic depth adjustment instructions for adjusting the stereoscopic depth of three-dimensional display by laterally changing the relative positional relation, and the partial image determination instructions are adapted to change at least one of the partial area of the first input image and the partial area of the second input image to be output to the display, in accordance with adjustment of the stereoscopic depth made by execution of the stereoscopic depth adjustment instructions.

According to the sixth and seventh aspects of the present invention, three-dimensional processing is performed for the first partial image and the second partial image, so that display without non-displayed portions at the opposing ends can be provided on a display surface of a display.

According to a preferred eighth aspect, the stereoscopic depth determination instructions include stereoscopic depth adjustment instructions for adjusting the stereoscopic depth of three-dimensional display by successively changing the relative positional relation, and the two-dimensional display processing instructions are adapted to determine at least one of the first partial image and the second partial image, in accordance with a relative positional relation determined independently of change of the relative positional relation by execution of the stereoscopic depth adjustment instructions, immediately after a switch is made from three-dimensional display to two-dimensional display by execution of the display switch instructions, and adapted to cause the display to display an image based on at least one of the first partial image and the second partial image.

According to the eighth aspect of the present invention, two-dimensional display in a prescribed state can be provided all the time independently of the stereoscopic depth of immediately preceding three-dimensional display.

According to a preferred ninth aspect, the two-dimensional display processing instructions are adapted to determine at least one of the first partial image and the second partial image based on a base relative positional relation between the first input image and the second input image, immediately after a switch is made from three-dimensional display to two-dimensional display by execution of the display switch instructions.

According to the ninth aspect of the present invention, two-dimensional display of an object can be provided in a state as close as possible to a state of the object in immediately preceding three-dimensional display. Therefore, a user can spontaneously accept two-dimensional display to which a switch has been made from three-dimensional display.

According to a preferred tenth aspect, the display control program further includes input instructions for accepting a user's operation for increasing or decreasing a prescribed parameter associated with a stereoscopic depth, and the input instructions are adapted to generate a request to make a switch between three-dimensional display and two-dimensional display based on a value of the prescribed parameter.

According to a preferred eleventh aspect, the input instructions are adapted to accept, as the user's operation for increasing or decreasing the prescribed parameter, an operation of sliding a slider in a prescribed direction.

According to the tenth and eleventh aspects of the present invention, typically a slider movable along a prescribed direction is employed as an input portion, and a user can operate the slider to increase or decrease a prescribed parameter involved with the stereoscopic depth. Therefore, the user can adjust the stereoscopic depth with one action. Namely, a more intuitive operation can be provided to the user.

According to a preferred twelfth aspect, the display switch instructions are adapted to substantially stop display provided by the display for a prescribed period of making a switch from a state of three-dimensionally displaying the object to a state of two-dimensionally displaying the object.

According to the twelfth aspect of the present invention, when a display is switched from three-dimensional display to two-dimensional display, the display provides no display so that user's eyes and brain can be reset and wasteful power consumption can be reduced.

According to a preferred thirteenth aspect, the display switch instructions are adapted to cause the display to display a presentation independent of the first input image and the second input image for a prescribed period of making a switch from a state of three-dimensionally displaying the object to a state of two-dimensionally displaying the object.

According to the thirteenth aspect of the present invention, when a switch is made from three-dimensional display to two-dimensional display, a user sees contents that are independent of an object in immediately preceding three-dimensional display. Therefore, even when the same object as the object having been three-dimensionally displayed is two-dimensionally displayed thereafter, the independent presentation has already caused user's eyes and brain to be reset, and the user can spontaneously accept the two-dimensionally displayed object.

In a typical embodiment, a presentation is made in such a manner that an object image resembling a shutter of a camera fades in. Since a user gives attention to such a presentation, a user's attention having been given to the object (subject) seen previously is lessened, and user's eyes and brain are more easily reset.

According to a preferred fourteenth aspect, the display switch instructions are adapted to cause the display to display an insert image independent of the first input image and the second input image for a prescribed period of making a switch from a state of three-dimensionally displaying the object to a state of two-dimensionally displaying the object.

According to the fourteenth aspect of the present invention, a user sees contents that are independent of an object in immediately preceding three-dimensional display. Therefore, even when the same object as the object having been three-dimensionally displayed is two-dimensionally displayed thereafter, the independent insert image has already caused user's eyes and brain to be reset, so that the user can easily accept the two-dimensionally displayed object.

According to a preferred fifteenth aspect, the display switch instructions are adapted to cause the insert image that has been prepared to be displayed.

According to a preferred sixteenth aspect, the insert image includes a substantially monochrome image.

According to a preferred seventeenth aspect, the substantially monochrome image is a black image.

According to the fifteenth to seventeenth aspects of the present invention, it may only be necessary to prepare an image (typically black image) that will not be displayed when a display is to express a photograph or the like taken by an image pick-up portion, for example. Therefore, an unnecessary increase of the storage capacity is avoided and user's eyes and brain can surely be reset.

According to a preferred eighteenth aspect, the two-dimensional display processing instructions are adapted to cause, immediately after a switch is made from three-dimensional display to two-dimensional display, the display to display an image that is based on at least one of the first input image and the second input image having been used for immediately preceding three-dimensional display.

According to a preferred nineteenth aspect, the two-dimensional display processing instructions are adapted to cause, immediately after a switch is made from three-dimensional display to two-dimensional display, the display to display an image that is one of the first input image and the second input image having been used for immediately preceding three-dimensional display.

According to the eighteenth and nineteenth aspects of the present invention, it is unnecessary to obtain an image dedicated to two-dimensional display. Namely, a plurality of input images used for providing three-dimensional display can be used to provide two-dimensional display, and therefore, the device configuration or the like can further be simplified.

An information processing system according to a twentieth aspect of the present invention includes: a display capable of providing three-dimensional display; a three-dimensional display processing unit for performing display processing using a first input image and a second input image containing a common object to be displayed and having a parallax, so that the object is three-dimensionally displayed by the display; a two-dimensional display processing unit for performing display processing so that the object is two-dimensionally displayed as a two-dimensional image by the display; and a display switch unit for making a switch between three-dimensional display and two-dimensional display provided by the display. The display switch unit is configured to control the display, when a switch is made between a state of three-dimensionally displaying the object and a state of two-dimensionally displaying the object, so that the object is substantially non-displayed for a prescribed period.

For example, when a user's attention is given to a certain object to be displayed (subject) on a display and a switch is made from a state of three-dimensionally displaying the object to a state of two-dimensionally displaying the object, the stereoscopic depth is lost and the object seems to be discontinuous. In contrast, according to the twentieth aspect of the present invention, display processing is performed so that the object is substantially non-displayed for a prescribed period, and therefore, the same object does not substantially appear continuously in time in a field of view of a user. Thus, user's eyes and brain are reset from three-dimensional display, and a switch from three-dimensional display to two-dimensional display can be made so that the switch is perceived as natural.

According to a preferred twenty-first aspect, the three-dimensional display processing unit includes: a first stereoscopic depth setting unit for setting a relative positional relation between the first input image and the second input image to a value in accordance with a requirement of three-dimensional display; and a first output unit for outputting to the display, for a first display target area and a second display target area that are set respectively for the first input image and the second input image in accordance with the relative positional relation, a first partial image included in the first display target area and a second partial image included in the second display target area. The two-dimensional display processing unit is configured to cause the display to display an image based on at least one of the first partial image and the second partial image obtained when the relative positional relation between the first input image and the second input image is substantially matched to a base relative positional relation determined based on a correspondence between the first input image and the second input image.

According to the twenty-first aspect of the present invention, when a switch is made from three-dimensional display to two-dimensional display, an amount of adjustment from the base relative positional relation made by a user can be reset to provide two-dimensional display. Thus, an object intended to be displayed originally can be displayed. The user can therefore spontaneously accept the two-dimensional display to which a switch is made from the three-dimensional display.

According to a preferred twenty-second aspect, the information processing system further includes: an image input unit for accepting a pair of images having a prescribed parallax; an image generation unit for generating a pair of images by taking pictures of an object on a virtual space using a pair of virtual cameras; and a mode switch unit for setting the pair of images accepted by the image input unit as the first input image and the second input image in a first mode, and setting the pair of images generated by the image generation unit as the first input image and the second input image in a second mode. The three-dimensional display processing unit includes: a second stereoscopic depth setting unit for setting a relative distance between the pair of virtual cameras to a value in accordance to a requirement of three-dimensional display, and a second output unit for outputting the first input image and the second input image to the display. The stereoscopic depth setting unit and the first output unit are activated in the first mode, and the stereoscopic depth setting unit and the second output unit are activated in the second mode.

According to the twenty-second aspect of the present invention, a pair of input images having a certain parallax can be used to provide three-dimensional display, and a pair of input images having a variable parallax can also be used to provide three-dimensional display.

According to a preferred twenty-third aspect, the three-dimensional display processing unit successively changes a relative positional relation between the first input image and the second input image in response to a user's operation of adjusting a stereoscopic depth in the first mode, and successively changes a relative distance between the pair of virtual cameras in response to a user's operation of adjusting a stereoscopic depth in the second mode.

According to the twenty-third aspect of the present invention, the relative relation between the first and second input images is changed in a non-stepwise manner, so that the stereoscopic depth can successively be adjusted. Further, when the relative positional relation between the first and second input images satisfies a prescribed condition (typically when an object to which a user's attention is given is located near a display surface of a display), a switch is made from three-dimensional display to two-dimensional display. Thus, the object of interest is naturally displayed two-dimensionally without considerable displacement from the position in the three-dimensional display.

According to a preferred twenty-fourth aspect, the two-dimensional display processing unit is configured to cause the display to display one of the pair of input images generated by the image generation unit when the relative distance between the pair of virtual cameras is made zero in the second mode.

According to the twenty-fourth aspect of the present invention, two-dimensional display is provided using input images obtained when the relative displacement amount between paired virtual cameras is zero, namely the two virtual cameras are arranged at the same position. Therefore, an input image necessary for providing two-dimensional display can easily be generated, and a successive switch (transition) from three-dimensional display to two-dimensional display can be achieved.

According to a preferred twenty-fifth aspect, in the second mode, the display switch unit makes a switch between three-dimensional display and two-dimensional display of the display by giving an instruction to the second stereoscopic depth setting unit so that the relative distance between the pair of virtual cameras is zero, while providing no period in which the object is substantially non-displayed.

According to the twenty-fifth aspect of the present invention, in the second mode, a successive switch (transition) from three-dimensional display to two-dimensional display can be achieved in the second mode. Therefore, in this second mode, the amount of processing in making a switch from three-dimensional display to two-dimensional display can be reduced and the processing for making a switch can be immediately completed.

According to a preferred twenty-sixth aspect, in the second mode, the display switch unit causes the object to be substantially non-displayed for a prescribed period of making a switch from three-dimensional display to two-dimensional display when a prescribed condition is satisfied.

According to the twenty-sixth aspect of the present invention, a successive switch (transition) from three-dimensional display to two-dimensional display can be achieved in the second mode. Therefore, in this second mode, the amount of processing in making a switch from three-dimensional display to two-dimensional display can be reduced and the processing for making a switch can be immediately completed.

According to a preferred twenty-seventh aspect, the image input unit includes a pair of image pick-up portions.

According to the twenty-second aspect of the present invention, an image picked up by a user using information processing system 1 can be three-dimensionally displayed, which can further enhance the usability.

According to a preferred twenty-eighth aspect, the information processing system further includes an input unit for accepting a user's operation on a prescribed parameter associated with a degree involved with three-dimensional display and associated with a switch between three-dimensional display and two-dimensional display.

According to a preferred twenty-ninth aspect, the three-dimensional display processing unit successively changes a relative positional relation between the first input image and the second input image, in accordance with a user's operation on the prescribed parameter in a first mode, and the three-dimensional display processing unit successively changes a relative distance between a pair of virtual cameras, in accordance with a user's operation on the prescribed parameter in a second mode.

According to a preferred thirtieth aspect, the input unit includes a mechanism capable of being slid along a prescribed uniaxial direction.

According to the twenty-eighth to thirtieth aspects of the present invention, typically a slider movable along a prescribed direction is employed as an input portion, and a user can operate this slider to make both of adjustment of the depth of three-dimensional display and a switch between three-dimensional display and two-dimensional display. Therefore, the user can adjust the stereoscopic depth and switch the display by one action. Namely, a more intuitive operation can be provided to the user.

In the description above, supplemental explanation and the like showing a correspondence with embodiments described hereinlater are provided for better understanding of the present invention, however, they are not intended to limit the present invention in any manner.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an internal configuration of an information processing system according to a first embodiment of the present invention.

FIG. 2 is a schematic cross section of a display of the information processing system according to the first embodiment of the present invention.

FIG. 3 is a schematic diagram showing a state of a certain object for illustrating image matching processing according to the first embodiment of the present invention.

FIGS. 4A and 4B are schematic diagrams showing images picked up by a first image pick-up portion and a second image pick-up portion respectively, in correspondence with FIG. 3.

FIG. 5 is a diagram for illustrating a relative relation between input images shown in FIGS. 4A and 4B that are to be three-dimensionally displayed in such a manner that what is contained in a focused area frame set for the input images appears to be located near a display surface of the display.

FIGS. 6A to 6D are diagrams for illustrating exemplary processing when the focused area frame shown in FIG. 5 is moved.

FIG. 7 is a diagram for illustrating an example of how an input image used for two-dimensional display is obtained according to the first embodiment of the present invention.

FIG. 8 is a diagram for illustrating switch from three-dimensional display to two-dimensional display according to the first embodiment of the present invention.

FIGS. 9A to 9C are (first) schematic diagrams showing an exemplary display manner in which three-dimensional display is switched to two-dimensional display according to the first embodiment of the present invention.

FIGS. 10A to 10C are (second) schematic diagrams showing an exemplary display manner in which three-dimensional display is switched to two-dimensional display according to the first embodiment of the present invention.

FIG. 11 is a functional block diagram for controlling the display of the information processing system according to the first embodiment of the present invention.

FIG. 12 is a diagram showing a form of an input portion according to the first embodiment of the present invention.

FIG. 13 is a diagram showing another form of the input portion according to the first embodiment of the present invention.

FIG. 14 is a diagram showing still another form of the input portion according to the first embodiment of the present invention.

FIGS. 15A to 15C are diagrams for illustrating virtual arrangement of input images in the information processing system according to the first embodiment of the present invention.

FIGS. 16A to 16D are schematic diagrams for illustrating processing for determining a base position of superimposition in the information processing system according to the first embodiment of the present invention.

FIGS. 17A and 17B are (first) diagrams for illustrating search processing according to the first embodiment of the present invention.

FIGS. 18A and 18B are (second) diagrams for illustrating search processing according to the first embodiment of the present invention.

FIGS. 19A and 19B are (third) diagrams for illustrating search processing according to the first embodiment of the present invention.

FIGS. 20A to 20D are diagrams for illustrating processing for determining a display displacement amount according to the first embodiment of the present invention.

FIGS. 21 and 22 are a flowchart showing an entire processing procedure of image display control in the information processing system according to the first embodiment of the present invention.

FIG. 23 is a flowchart showing processing in a search processing sub routine shown in FIG. 21.

FIG. 24 is a flowchart showing processing in a matching score evaluation sub routine shown in FIG. 23.

FIGS. 25 and 26 are a flowchart showing an entire processing procedure of image display control in an information processing system according to a first modification of the first embodiment of the present invention.

FIG. 27 is a functional block diagram for controlling a display of an information processing system according to a second embodiment of the present invention.

FIG. 28 is a more detailed functional block diagram of an object display mode controller shown in FIG. 27.

FIGS. 29A to 29C are schematic diagrams showing processing for generating input images in an object display mode according to the second embodiment of the present invention.

FIGS. 30A to 30C are diagrams showing an example of input images obtained at respective viewpoints shown in FIGS. 29A to 29C.

FIGS. 31A and 31B are schematic diagrams showing three-dimensional display provided in the object display mode according to the second embodiment of the present invention.

FIG. 32 is a flowchart showing an entire processing procedure of image display control in the information processing system according to the second embodiment of the present invention.

### DESCRIPTION OF THE PREFERRED EMBODIMENTS

Embodiments of the present invention will be described in detail with reference to the drawings. Like or corresponding components in the drawings are denoted by like reference characters, and a description thereof will not be repeated.

Terms

“Three-dimensional display” or “stereoscopic display” herein means that an image is represented in such a manner that enables a user to have three-dimensional visual perception of an object constituting at least a part contained in the image. This is typically achieved with the aid of physiological functions of human eyes and brain. When a plurality of images are displayed in order to allow “a user to have three-dimensional visual perception”, various factors contribute to the three-dimensional perception. In particular, the following factors enable “a user to have three-dimensional visual perception” of three-dimensional display.

(a) Camera Position

Three-dimensional display is provided using a plurality of images. In order to generate these images, cameras (points of observation) are set at respective positions different from each other and respective images from the cameras are used. Thus, a plurality of images from these cameras respectively have a parallax therebetween.

(b) Display Position

The images generated in the condition (a) above are displayed on a display device in such a manner that these images have a parallax as seen by the right and left eyes of a user. Here, the images may be displayed using the original parallax as it is between the images generated in the above condition (a). Instead, the parallax may be adjusted and then the images may be displayed with the adjusted parallax.

The two factors “(a) camera position” and “(b) display position” generate or adjust the stereoscopic depth perceived by a user. Namely, when the stereoscopic depth is to be adjusted, (a) camera position may be changed to make the adjustment. Instead, (b) display position may also be changed to make the adjustment. The former is herein also referred to as “adjustment of stereoscopic depth by camera position”. The latter is herein also referred to as “adjustment of stereoscopic depth by display position”, for example.

“Parallax” herein refers to a difference in how an object point appears, between a field of the right eye and a field of the left eye. When an object is observed from different points of observation and images are generated respectively based on respective observations at the points of observation, the resultant images have a parallax. Here, images having a parallax therebetween can also be pseudo-generated from one image. “Images having a parallax” herein also include such images generated from one image. Further, because of the difference between the point of observation for generating display for the right eye and the point of observation for generating display for the left eye, an image of the object in the displayed image for the right eye and an image of the object in the displayed image for the left eye are located at different positions. The amount of such a difference in position between the image of the object in the displayed image for the right eye and the image of the same object in the displayed image for the left eye is herein referred to as “amount of parallax or parallax amount”. The parallax amount can also be adjusted by displacing the display position, without changing the points of observation.

Regarding “(b) display position” described above, a relative relation between the display position of an image for the right eye IMGr and the display position of an image for the left eye IMGl that are used in generating three-dimensional display is referred to as “relative positional relation between two images” (or simply referred to as “relative positional relation” or “positional relation” as well). This relation may be represented, for a certain object of interest, by an amount of parallax between an image of the object in the displayed image for the right eye and an image of the object in the displayed image for the left eye.

What is meant by “relative positional relation between two images” will further be described. The three-dimensional display device is typically classified into the following types. It would certainly be seen that the present invention is also applicable to other types of three-dimensional display devices than the following ones, as long as the technical concept of the present invention is applicable thereto. Here, in order to explain the meaning of “relative positional relation between two images”, reference is made to the following three types merely for convenience sake.

(a) Like the parallax barrier and lenticular systems, a display area of an image for the right eye and a display area of an image for the left eye are arranged in a regular pattern (typically they are alternately arranged).

(b) Like the method using shutter glasses (time-division system), an image for the right eye and an image for the left eye are displayed alternately in a common area.

(c) Like the HMD (Head Mount Display), a display unit for an image for the right eye and a display unit for an image for the left eye are separately provided.

For any of (a) to (c) above, a point in a display area for the right eye/left eye has a certain positional relation with the right/left eye. When the positional relation between “point A in a display area for the right eye” and the right eye and the positional relation between “point B in a display area for the left eye” and the left eye are substantially identical to each other, point A in the display area for the right eye and point B in the display area for the left eye are referred to as corresponding points. The corresponding points are pixels adjacent to each other in the case of (a) above, and the same pixel in the case of (b) above. In the case of (c) above, for example, a representative point (central point for example) of the display for the image for the right eye corresponds to a representative point (central point for example) of the display for the image for the left eye. “Relative positional relation between two images” is thus determined based on the relation between corresponding points respectively in the display area for the right eye and the display area for the left eye. Namely, an image which is within an image for the right eye and which is displayed at point A in the display area for the right eye, and an image which is within an image for the left eye and which is displayed at “corresponding point of point A”, are referred to as having display positions corresponding to each other.

The above-described parallax amount is a value determined on the basis of the corresponding points. Specifically, it is supposed that an image of an object is displayed at a certain point in a display area for the right eye and the image of the object is displayed at the corresponding point in a display area for the left eye, the parallax amount of the object is zero and the object is perceived as being present on the display plane, for example. When an image of an object is displayed at a certain point in a right-eye image and the image of the object in a left-eye image is not displayed at the corresponding point corresponding to the point at which the image for the object is present in the right-eye image, the displacement from the corresponding point is the amount of parallax.

In the case of the three-dimensional display of the system (a) or (b) above, images IMGr and IMGl are superimposed on each other so that respective corresponding points are displayed at substantially the same position for generating three-dimensional display. Therefore, in these cases, “relative positional relation between two images” is also referred to as “position of superimposition of two images”.

Change of the relative positional relation between two images (change of the position of superimposition of two images) includes the following:

with “display position of IMGr in a first LCD 116” as it is, “display position of IMGl in a second LCD 126” is displaced;

with “display position of IMGl in second LCD 126” as it is, “display position of IMGr in first LCD 116” is displaced; and

“display position of IMGr in first LCD 116” is displaced, and “display position of IMGl in second LCD 126” is displaced (except that these two displacements are in the same direction and to the same extent).

To change the relative positional relation between IMGr and IMGl is as follows. For an image of a certain object included in IMGr/IMGl, the display position of the image of the object in IMGr and the display position of the image of the object in the IMGl are changed relative to each other. Therefore, in the case for example where the display area of IMGr/the display area of IMGl is fixed as well as in the case of the present embodiment described herein later where IMGr/IMGl is a larger image than first LCD 116/second LCD 126, the region where IMGr/IMGl is displayed in first LCD 116/second LCD 126 is changed to change the display position of an image included in IMGr/IMGl.

Here, a set of images IMGr and IMGl for creating three-dimensional display have a base value of the relative positional relation (referred to as “base relative positional relation” or “base position of superimposition”). In the present embodiment as described later, image matching processing is performed on two images IMGr and IMGl. The positional relation having the highest matching score is the base value for IMGr and IMGl. In this image matching processing, the whole IMGr and the whole IMGl may be subjected to the matching processing. Instead, a partial image of interest (specifically a focused area as described later) only may be subjected to the matching processing. The base value may be a fixed positional relation by which respective central points of IMGr and IMGl are correlated with each other, or a base value set in advance for two images IMGr and IMGl may also be used.

Two images IMGr and IMGl can be displaced relative to each other in the lateral direction, with respect to the base value. This is referred to as “to displace the positional relation between two images relative to each other” or “to displace the position where two images are superimposed relative to each other (also simply referred to as “relative displacement”). The degree of relative displacement (amount of displacement from the base relative positional relation) is referred to as “relative displacement amount”. Namely, “relative positional relation between two images” (“position of superimposition of two images”) may be adjusted by the relative displacement amount.

“Plane display” or “two-dimensional display” which are terms herein opposite to “stereoscopic display” or “three-dimensional display” means that an image is represented in such a manner that disables a user to visually perceive the stereoscopic depth.

For three-dimensional perception, two images having a parallax are necessary. Namely, image IMGr for the right eye and image IMGl for the left eye are necessary. Typically, these images are generated in one of the following two manners. Although other manners are also derived from the following manners, a detailed description will not be given here.

1. Manner of Statically Providing Images for Three-Dimensional Display

This is a manner in which a set of images IMGr and IMGl for generating three-dimensional display is statically provided in advance. Specifically, at two different camera positions (points of observation), respective images are generated. Then, the generated images are used as they are without changing the camera positions, so as to provide three-dimensional display. Typically, two cameras are fixed at respective positions laterally separated from each other by a prescribed distance, and two images (stereoscopic photographs) taken by the two cameras are used to generate three-dimensional display. This manner is referred to as “static manner”. If images of a virtual space are taken by virtual cameras and the images taken by the cameras are used as they are, this is also called static manner.

2. Manner of Dynamically Generating Images for Three-Dimensional Display

This is a manner in which two different camera positions (points of observation) are each dynamically changed while images taken at respective camera positions having been changed are used to provide three-dimensional display. Typically, by way of three-dimensional image processing, virtual cameras (a virtual camera for the right eye and a virtual camera for the left eye) are used to take pictures of a virtual space so as to enable images IMGr and IMGl to be dynamically generated. This manner is referred to as “dynamic manner”.

In the case of “1. manner of statically providing images for three-dimensional display”, the stereoscopic depth cannot be adjusted by the camera positions. The stereoscopic depth, however, can be adjusted by the display positions. More specifically, the positional relation between two displayed images can be laterally changed to adjust the stereoscopic depth (adjustment of stereoscopic depth by display position). This adjustment, however does not change the parallax of the two images generated by the camera positions, and therefore, even if “relative positional relation between two images” is changed so that the amount of parallax for any object in an image is zero, an amount of parallax of other objects remains. Namely, even if respective parallax amounts for all objects are tried to be increased or decreased, a difference between respective parallax amounts of respective objects remains the same while the parallax amounts are adjusted. Therefore, respective parallax amounts for all objects cannot be adjusted to zero.

In the case of “2. manner of dynamically generating images for three-dimensional display”, the stereoscopic depth can be adjusted by means of camera positions. Typically, parameters of virtual cameras can be appropriately set as desired to adjust the stereoscopic depth. For example, the distance between a virtual camera for the right eye and a virtual camera for the left eye is changed to change the width in the depth direction of a certain object. In this case, adjustments may be made so that respective parallax amounts for all objects become close to zero. Therefore, respective parallax amounts of all objects can be eliminated. The stereoscopic depth can be adjusted by means of camera positions and thereafter the stereoscopic depth can further be adjusted by means of display positions.

### First Embodiment

### Device Configuration

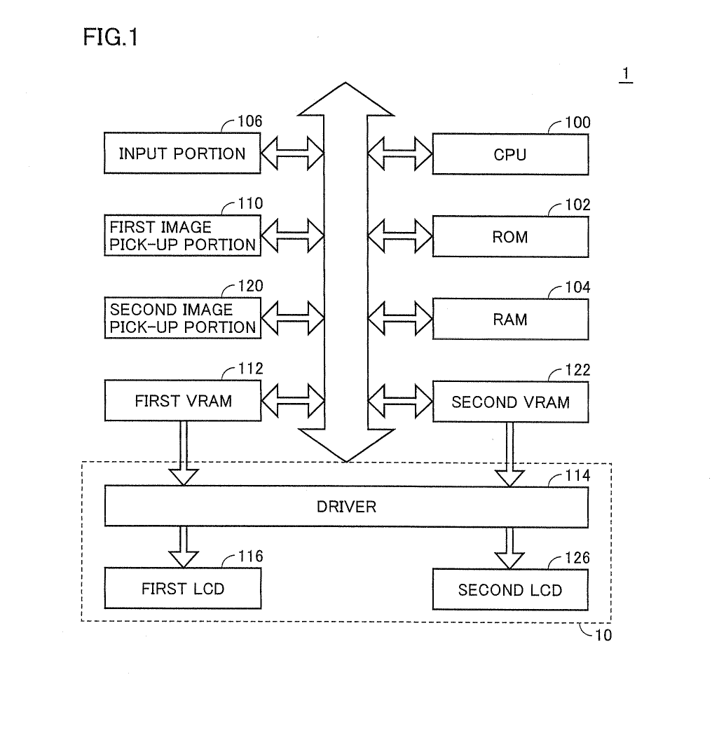

Referring to FIG. 1, an information processing system 1 according to a first embodiment of the present invention represents a typical example of a computer capable of performing processing using a processor. It is noted that information processing system 1 may be implemented by a personal computer, a work station, a portable terminal, a PDA (Personal Digital Assistant), a portable telephone, a portable game device, or the like.

Information processing system 1 includes a display 10, a CPU (Central Processing Unit) 100, a ROM (Read Only Memory) 102, a RAM (Random Access Memory) 104, an input portion 106, a first image pick-up portion 110, a second image pick-up portion 120, a first VRAM (Video RAM) 112, and a second VRAM 122. It is noted that these portions are connected to each other through an internal bus so that data can be communicated therebetween.

Display 10 is capable of providing three-dimensional display to a user. Typically, a front parallax barrier type configuration having a parallax barrier as a parallax optical system is adopted for display 10. Namely, display 10 is configured such that, when the user faces display 10, light beams from different pixels enter fields of view of the user's right and left eyes respectively, owing to the parallax barrier.

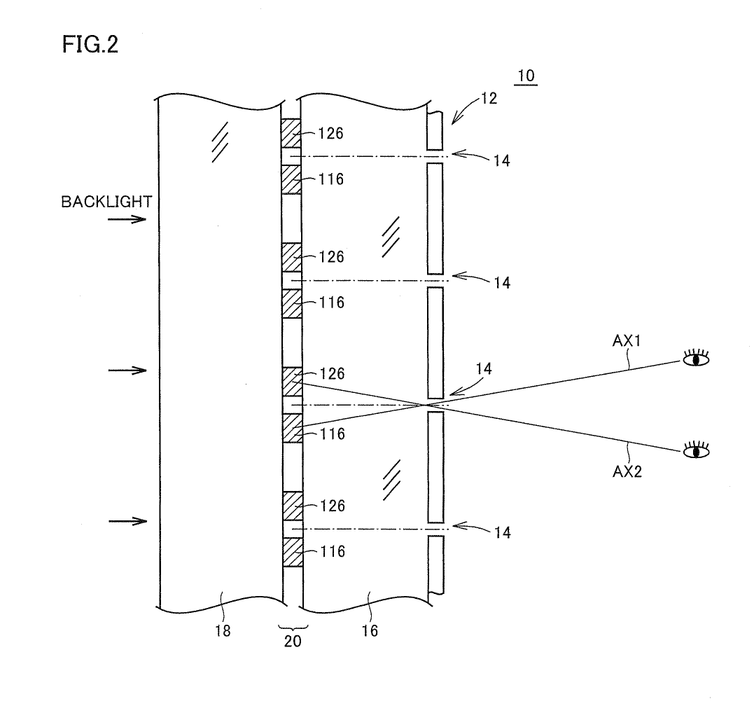

FIG. 2 shows a cross-sectional structure of a front parallax barrier type liquid crystal display device, as an example of display 10 of information processing system 1. This display 10 includes a first LCD 116 and a second LCD 126 provided between a glass substrate 16 and a glass substrate 18. Each of first LCD 116 and second LCD 126 includes a plurality of pixels and it is a spatial light modulator for adjusting light from a backlight for each pixel. Here, pixels in first LCD 116 and pixels in second LCD 126 are alternately arranged. A not-shown backlight is provided on a side of glass substrate 18 opposite to glass substrate 16 and light from this backlight is emitted toward first LCD 116 and second LCD 126.

A parallax barrier 12 representing a parallax optical system is provided on a side of glass substrate 16 opposite to the side thereof in contact with first LCD 116 and second LCD 126. In this parallax barrier 12, a plurality of slits 14 are provided in rows and columns at prescribed intervals. A pixel in first LCD 116 and a corresponding pixel in second LCD 126 are arranged symmetrically to each other, with an axis passing through a central position of each slit 14 and perpendicular to a surface of glass substrate 16 serving as the reference. By appropriately controlling positional relation with pixels corresponding to such slits 14 as well as first LCD 116 and second LCD 126 in accordance with an image to be displayed, a prescribed parallax can be created between the user's eyes.

Namely, since each slit 14 in parallax barrier 12 restricts a field of view of each of the user's right and left eyes to a corresponding angle, typically, the user's right eye can visually recognize only pixels in first LCD 116 on an optical axis Ax1, whereas the user's left eye can visually recognize only pixels in second LCD 126 on an optical axis Ax2. Here, by causing the pixels in first LCD 116 and the pixels in second LCD 126 to display corresponding elements of two images having a prescribed parallax, a prescribed parallax can be provided to the user.

Display 10 is not limited to the front parallax barrier type liquid crystal display device as described above, and for example, a display device of any type capable of providing three-dimensional display, such as a lenticular type display device, may be employed. In addition, display 10 may be configured such that two images different in main wavelength component contained therein are independently displayed and three-dimensional display is provided by having the user wear glasses incorporating two respective color filters different in transmitted wavelength range. Similarly, display 10 may be configured such that two images are displayed with directions of polarization being differed and three-dimensional display is provided by having the user wear glasses incorporating two respective polarizing filters corresponding to the two directions of polarization.

Referring again to FIG. 1, CPU 100 executes a program stored in ROM 102 or the like by developing the program in RAM 104. By executing the program, CPU 100 provides display control processing or accompanying various types of processing as will be described later. It is noted that a program executed by CPU 100 may be distributed on a non-transitory storage medium such as a DVD-ROM (Digital Versatile Disc ROM), a CD-ROM (Compact Disk ROM), a flexible disc, a flash memory, various memory cassettes, and the like. Therefore, information processing system 1 may read a stored program code (instructions) or the like from such a storage medium. In such a case, information processing system 1 should be able to make use of a reading device adapted to a storage medium. Alternatively, in an example where a program as described above is distributed through a network, the distributed program may be installed in information processing system 1 through a not-shown communication interface or the like.

ROM 102 is a device for storing a program to be executed by CPU 100 as described above, various setting parameters and the like in a non-volatile manner. Typically, ROM 102 is implemented by a mask ROM, a semiconductor flash memory or the like.

RAM 104 functions as a work memory for developing a program to be executed by CPU 100 as described above or temporarily storing data necessary for execution of the program. In some cases, RAM 104 may also store data of images to be used for providing three-dimensional display by information processing system 1.

Input portion 106 is a device for accepting a user's operation, and it is typically implemented by a keyboard, a mouse, a touch pen, a trackball, a pen tablet, various types of buttons (switches), or the like. When input portion 106 accepts any user's operation thereon, it transmits a signal indicating corresponding operation contents to CPU 100

First image pick-up portion 110 and second image pick-up portion 120 are devices each for obtaining an image through image pick-up of any object. First image pick-up portion 110 and second image pick-up portion 120 are arranged relative to each other such that images of the same object having a prescribed parallax can be picked up as will be described later (typically the image pick-up portions are arranged at the laterally leftmost and rightmost positions respectively of a housing of a portable game machine for example). Namely, first image pick-up portion 110 and second image pick-up portion 120 correspond to a pair of image pick-up devices respectively arranged with a prescribed parallax. First image pick-up portion 110 and second image pick-up portion 120 are each implemented by a CCD (Charge Coupled Device), a CMOS (Complementary Metal Oxide Semiconductor) image sensor, or the like. It is noted that first image pick-up portion 110 and second image pick-up portion 120 are preferably identical in image pick-up characteristics.

First VRAM 112 and second VRAM 122 are storage devices for storing image data for showing images to be displayed on first LCD 116 and second LCD 126 respectively. Namely, display data obtained through display control processing or the like as will be described later, which is performed by CPU 100, is successively written in first VRAM 112 and second VRAM 122. Then, rendering processing in display 10 is controlled based on the display data written in first VRAM 112 and second VRAM 122.

Display 10 includes an LCD driver 114 in addition to first LCD 116 and second LCD 126 described above. LCD driver 114 is associated with first VRAM 112 and second VRAM 122. LCD driver 114 controls turn-on/turn-off (ON/OFF) of pixels constituting first LCD 116 based on the display data written in first VRAM 112, and controls turn-on/turn-off (ON/OFF) of pixels constituting second LCD 126 based on the display data written in second VRAM 122. It is noted that, while a configuration has been illustrated in which first VRAM 112 and second VRAM 122 are provided in association with first LCD 116 and second LCD 126 respectively, a common VRAM may be provided so that image data to be displayed on first LCD 116 and second LCD 126 are stored in the common VRAM.

In the description above, a configuration where a pair of input images (stereo images) having a prescribed parallax is obtained by using contained first image pick-up portion 110 and second image pick-up portion 120 has been exemplified, however, an image pick-up portion for obtaining an input image does not necessarily have to be contained in information processing system 1. Typically, a pair of input images (stereo images) may be obtained through a network or the like from a device (typically, a server device) or the like different from information processing system 1, or may be read from a medium.

Three-Dimensional Display Processing

Next, three-dimensional display processing in information processing system 1 of the present embodiment will generally be described. In the present embodiment, basically a pair of input images (stereo images) containing a common subject to be displayed (object) and having a certain prescribed parallax is used to provide three-dimensional display. Such a pair of input images is typically obtained by arranging a pair of image pick-up portions at respective prescribed positions relative to each other and picking up respective images of the common object. Alternatively, the art of computer graphics such as polygon generation may be used and two virtual cameras having respective viewpoints different from each other may be used for the common object to dynamically generate a pair of input images.

In the case where such a pair of input images is used, a prescribed stereoscopic depth can be provided to a user. The stereoscopic depth is determined by the magnitude of a parallax between these input images due to different positions of the cameras generating the input images, or by the display positions of the input images. More specifically, an image for the right eye and an image for the left eye can be displayed at a display surface to provide the stereoscopic depth to the user.

Here, the position of superimposition at which the image for the right eye and the image for the left eye are superimposed on the display surface can be set as appropriate to make adjustments in such a manner that determines which of objects (more specifically which region of the object) contained in the pair of input images is to be positioned at the display surface. Therefore, in the present embodiment, image matching processing as described herein later is executed so that a target object among objects contained in a pair of input images is located at a display surface of display 10. In an input image, a small region containing “object to be positioned at the display surface” is also referred to as “focused area”, or a frame surrounding the focused area is also referred to as “focused area frame” (namely an area present in the focused area frame in each image is the focused area).

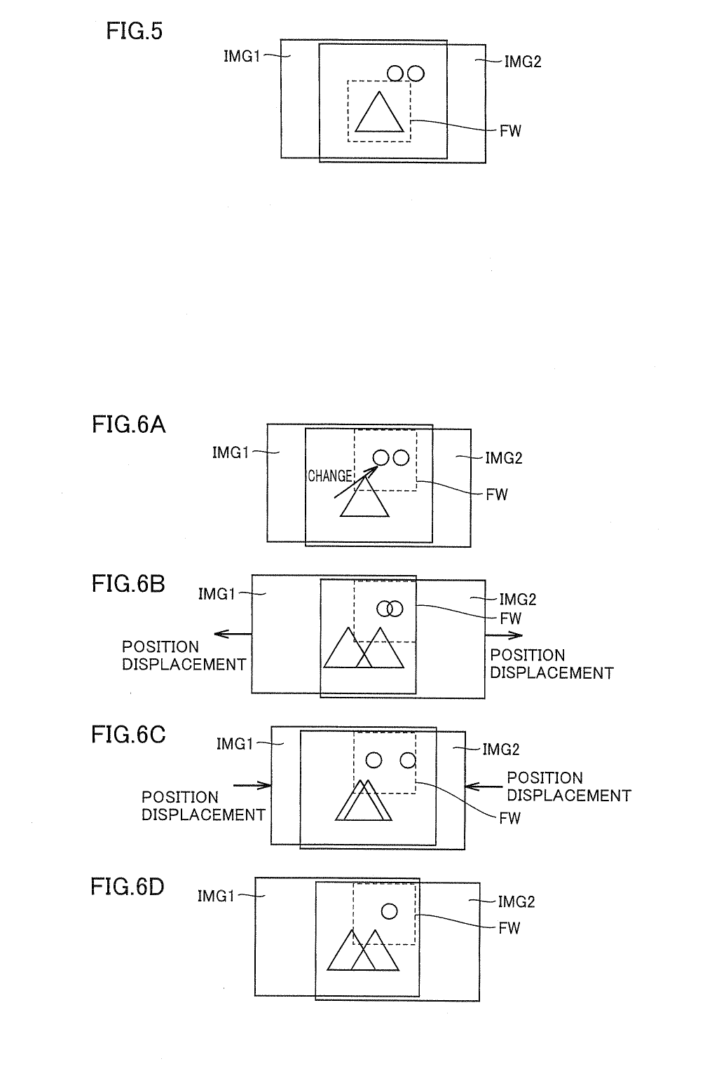

An object contained in the focused area and subjected to processing as described later is perceived by a user as being located at the display surface. The focused area is basically set for each of the two input images. Namely, a focused area in an image for the right eye and a focused area in an image for the left eye may be set independently of each other. In the present embodiment, however, an image for the right eye and an image for the left eye are temporarily arranged so that the images are superimposed on each other, a single focused area frame is set for the superimposed images and then, the image for the right eye within the focused area frame and the image for the left eye within the focused area frame are respective focused areas of the images for the right and left eyes, as described later with reference to FIGS. 5 and 6A to 6D. In this case, the position of the focused area frame is fixed. Then, instead of changing the focused area, the position of the image for the right eye relative to the focused area frame is changed or the position of the image for the left eye relative to the focused area frame is changed so as to change the focused area of each image. More specifically, an image for the right eye, an image for the left eye, and a focused area frame are arranged within a virtual space. The focused area frame is fixed at a position while the image for the right eye and the image for the left eye are arranged so that these images are variable in position. In this way, the relative positional relation of the focused area frame to the image for the right/left eye is changed so that the focused area of the image for the right/left eye can be changed.

Referring to FIG. 3, in information processing system 1 according to the present embodiment, it is assumed that first image pick-up portion 110 and second image pick-up portion 120 are arranged symmetrically to each other, in parallel to a virtual optical axis AXC. Namely, first image pick-up portion 110 and second image pick-up portion 120 are arranged relative to each other so as to have a prescribed parallax in a certain real space. In the case where first image pick-up portion 110 and second image pick-up portion 120 are contained in information processing system 1, optical axis AXC may be defined as identical to a normal line to the surface of the body of information processing system 1.

Then, it is assumed that an object OBJ1 and an object OBJ2 are successively arranged from a side farther from first image pick-up portion 110 and second image pick-up portion 120. By way of example, object OBJ1 is a quadrangular pyramid and object OBJ2 is a sphere.

The virtual space as shown in FIG. 3 may be implemented by a method described herein later. In this case, a pair of virtual cameras is used instead of first image pick-up portion 110 and second image pick-up portion 120.

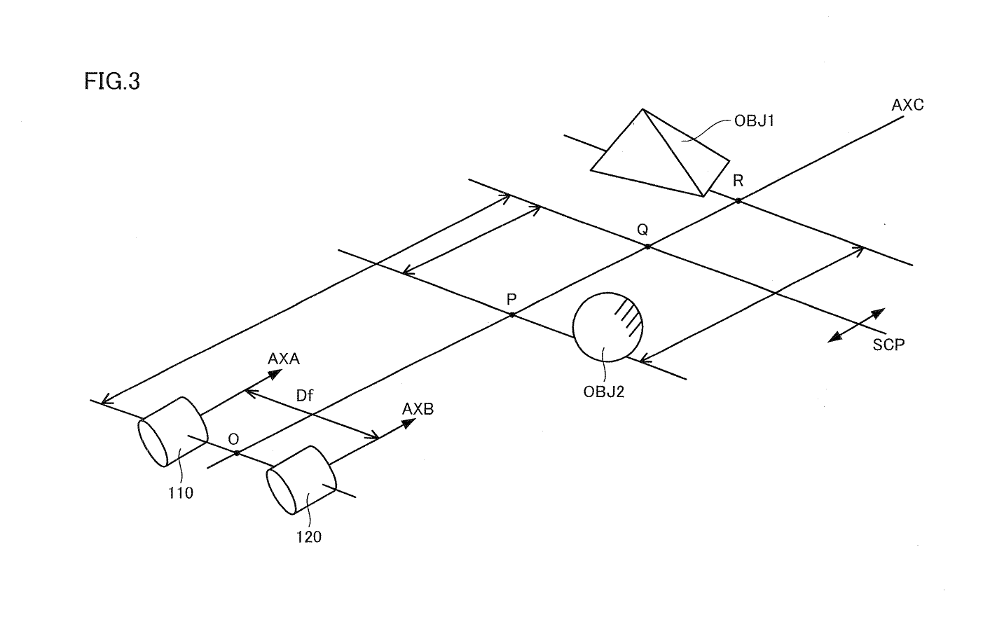

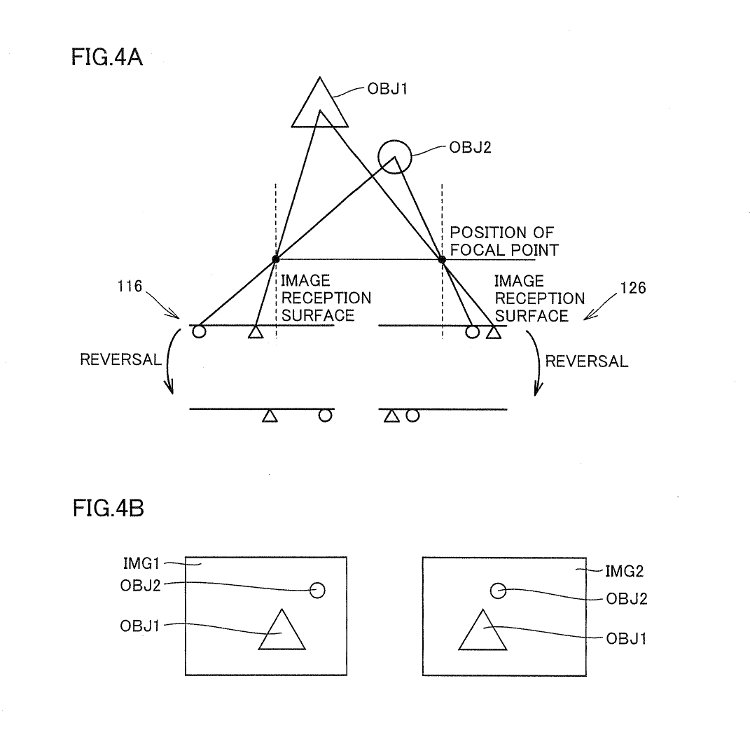

As shown in FIG. 4A, images incident on image reception surfaces of first image pick-up portion 110 and second image pick-up portion 120 respectively depend on fields of view in which the position at which they are arranged is the center. As the images incident on the image reception surfaces are scanned and reversed, images IMG1 and IMG2 as shown in FIG. 4B (hereinafter also referred to as input images) are obtained, respectively. Namely, as input image IMG1 and input image IMG2 have a prescribed parallax therebetween, there is a difference in position between object OBJ1 in input image IMG1 and object OBJ1 in input image IMG2 (this difference is a parallax amount for OBJ1) and there is also a difference in position between object OBJ2 in input image IMG1 and object OBJ2 in input image IMG2 (this difference is a parallax amount for OBJ2). Accordingly, a relative distance between object OBJ1 and object OBJ2 in input image IMG1 and a relative distance between object OBJ1 and object OBJ2 in input image IMG2 are different in magnitude from each other.

Next, a description will be given of a stereoscopic depth perceived by a user watching the display surface of display 10. Referring again to FIG. 3, in the present embodiment, the relative distance between first image pick-up portion 110 and second image pick-up portion 120 is fixed, and therefore, the stereoscopic depth cannot be adjusted by means of the camera positions. The stereoscopic depth that can be provided to a user can still be adjusted as described above by adjusting the position of superimposition of input image IMG1 and input image IMG2 in a lateral direction, namely by changing the display position (namely the stereoscopic depth can be adjusted by means of the display position).

More specifically, the position of superimposition of two images is adjusted in the lateral direction, so that adjustments are made to allow one of the objects commonly contained in input image IMG1 and input image IMG2 (more specifically any area of the object) to be perceived as being located at the position of the display surface of display 10.

In other words, the relative positional relation between the space to be three-dimensionally displayed and the display surface of display 10 is adjusted.

This may be described in another way. Any single point in a real space or virtual space to be three-dimensionally displayed is considered. Then, how close or far the point is seen to or from the display surface is adjusted. When this adjustment is made, the stereoscopic depth cannot be adjusted by means of the camera positions. Therefore, the length of the each object in the depth direction remains the same and only the position of the object in the depth direction changes.

The position of superimposition of two images is adjusted to change a reference position in depth, which is a position in a virtual space based on which a parallax between images on the display is determined for providing three-dimensional display (typically the parallax of objects at the reference position in depth is made zero). Specifically, a reference position in depth SCP as shown in FIG. 3 is changed. An object located at this reference position in depth SCP is perceived by a user as located at the display surface of display 10 (more accurately the position in depth of the object is perceived as located at the display surface). For example, in order to provide three-dimensional display so that object OBJ1 is located at the display surface of display 10, the position of superimposition of IMG1 and IMG2 has to be adjusted so that the parallax amount of OBJ1 is zero, namely the amount of parallax between the image of object OBJ1 in input image IMG1 and the image of object OBJ2 in input image IMG2 is zero.

Namely, an object contained in a displayed region where input images IMG1 and IMG2 obtained by first image pick-up portion 110 and second image pick-up portion 120 are substantially superimposed is three-dimensionally displayed at the display surface of display 10. In other words, a user watching display 10 perceives the object contained in the region where the images are superimposed as being located near the display surface of display 10.

In the state shown in FIG. 3, reference position in depth SCP in the space in which the object to be three-dimensionally displayed is present can be adjusted to adjust the stereoscopic depth visually perceived by a user. Namely, to adjust reference position in depth SCP means to make adjustments and thereby determine which region in the space in which an object to be three-dimensionally displayed is present is to be located on the display surface. Specific means for making adjustments may be a method of adjusting a distance OQ from image pick-up portions 110, 120 to reference position in depth SCP or a method of adjusting a distance PQ relative to a specific object (object OBJ2) in the space.

An example where focused area frame FW is set around object OBJ1 seen in input images IMG1 and IMG2 as shown in FIG. 5 is considered. Here, by adjusting the position of superimposition of input image IMG1 and input image IMG2 such that objects OBJ1 seen in input images IMG1 and IMG2 are substantially superimposed on each other, object OBJ1 is perceived as being near the display surface of display 10 in terms of depth. Namely, as a result that an image corresponding to object OBJ1 seen in input image IMG1 and an image corresponding to object OBJ1 seen in input image IMG2 are displayed at substantially the same position (corresponding point) on the display surface of display 10, the user can three-dimensionally see the input image with object OBJ1 perceived as being near the display surface of display 10 in terms of depth.

Next, with reference to FIGS. 6A to 6D, a description will be given of a change from “the state where a focused area is located around object OBJ1 and object OBJ1 is perceived as being near the display surface as shown in FIG. 5” to the state where the focused area is changed to be located around object OBJ2 and object OBJ2 is perceived as being near the display surface. Such processing can typically be used for a user's operation of scrolling an image for example. Specifically, it is assumed for example that input images IMG1 and IMG2 are respectively images larger than respective display areas (first LCD 116, second LCD 126), that a prescribed area (central area for example) on the screen displayed at this time is set as a focused area, and that an object displayed in the focused area is changed according to scroll and thus an object of interest is changed. This is not limited to scroll. Specifically, a user may set a desired object as an object of interest, among objects included in an image, and a focused area may be set around the object of interest.

In the case where object OBJ2 is to be positioned near the display surface, as shown in FIG. 6A, focused area frame FW is changed so that the frame is positioned around object OBJ2 seen in input images IMG1 and IMG2. At the position of superimposition of input image IMG1 and input image IMG2 shown in FIG. 6A, a position where object OBJ2 seen in input image IMG1 is displayed and a position where object OBJ2 seen in input image IMG2 is displayed do not match with each other. Namely, a parallax is generated between objects OBJ2.

Then, by determining a correspondence (matching score) between input image IMG1 and input image IMG2, the position of superimposition of input image IMG1 and input image IMG2 is adjusted again. More specifically, the position of superimposition of these images is successively varied in such a direction as increasing a lateral relative distance between input image IMG1 and input image IMG2 (see FIG. 6B) and/or in such a direction as decreasing a lateral relative distance between input image IMG1 and input image IMG2 (see FIG. 6C). Here, because the position of the focused area frame is fixed, the successive change of the position of superimposition of these images causes a change of a focused area in input image IMG1/focused area in input image IMG2. Alternatively, input image IMG1 and input image IMG2 may be moved relative to each other in an up/down direction of the face of the drawing, which is irrelevant to adjustment of the parallax of OBJ2.

In this way, the position of superimposition is changed. At each position of superimposition, a matching score between an image within focused area frame FW in input image IMG1 and an image within focused area frame FW in input image IMG2 is successively calculated. This matching score typically refers to an index indicating how similar feature values (color attributes or luminance attributes) of images included in image blocks constituted of a plurality of pixels are to each other based on comparison between the image blocks. Examples of such a method of calculating a matching score include a method of converting a feature value of each pixel constituting each image block into a vector, calculating a correlation value based on an inner product of vectors, and determining this correlation value as the matching score. Alternatively, a method of calculating a sum value (or an average) of absolute values of difference in color between corresponding pixels in the image blocks (for example, a color difference vector, a luminance difference, or the like) and determining a smaller sum value (or an average) as a higher matching score is also available. From a point of view of faster processing, an evaluation method based on a sum value of luminance differences between pixels constituting the image blocks is preferred.

Then, a position of superimposition achieving the highest matching score is determined as a new position of superimposition (see FIG. 6D). It is noted that the determined position of superimposition may be used as a base value which may further be relatively displaced, so that the position of superimposition is adjustable.

In the present embodiment, focused area frame FW common to input image IMG1 and input image IMG2 is set. Then, an area defined by focused area frame FW of input image IMG1 is set as a determination area (a first determination area) in input image IMG1 for determining a correspondence (matching score) with input image IMG2. At the same time, an area defined by focused area frame FW of input image IMG2 is set as a determination area (a second determination area) in input image IMG2 for determining a correspondence (matching score) with input image IMG1.

Thus, the first determination area is set in input image IMG1 and the second determination area is set in input image IMG2. Here, the first determination area set in input image IMG1 and the second determination area set in input image IMG2 are positioned so as to correspond to each other.

Each time contents of an image to be displayed on display 10 change, a position of superimposition of input image IMG1 and input image IMG2 is updated (searched for). It is noted that such change in contents of an image to be displayed on display 10 includes, in addition to the scroll operation as described above, a zoom-in display operation, a zoom-out display operation (both of which is also collectively referred to as a “zoom operation”), and the like. In addition, when contents of input images IMG1 and IMG2 are updated as well, similar search processing is performed.

Two-Dimensional Display Processing

Display 10 of information processing system 1 in the present embodiment can also provide two-dimensional display of an object included in an input image, so that the object is displayed in the form of a two-dimensional image. Specifically, a common image including a target object is displayed as an image for the right eye and an image for the left eye on the display surface of display 10. Namely, for a user watching display 10, images having the same contents are incident respectively on the right eye and the left eye. Therefore, the user can visually perceive the object without stereoscopic depth.

It is noted that, when display 10 is configured to be able to cancel a parallax barrier of display 10, the parallax barrier may be cancelled when two-dimensional display is to be provided. As the parallax barrier is cancelled, light from a common pixel is incident on a field of view of the right eye and that of the left eye of a user facing display 10. The user therefore does not perceive a parallax. At this time, because the light from a pixel for the right eye and the light from a pixel for the left eye are incident on both of the right eye and the left eye, the resolution is substantially doubled.

As described later, when a switch is to be made from three-dimensional display of an object to two-dimensional display of the same object, a practical method for making such a switch is to display an image based on at least one of input image IMG1 and input image IMG2 that are used for providing three-dimensional display. More specifically, one of input images IMG1 and IMG2 used for creating three-dimensional display, or an image into which input images IMG1 and IMG2 are synthesized is used for providing two-dimensional display.

In the case where at least one of input images IMG1 and IMG2 is used to provide two-dimensional display, a relative positional relation between input images IMG1 and IMG2 that is determined independently of the change of the relative positional relation between input images IMG1 and IMG2, which has been set for providing immediately preceding three-dimensional display, may be used.

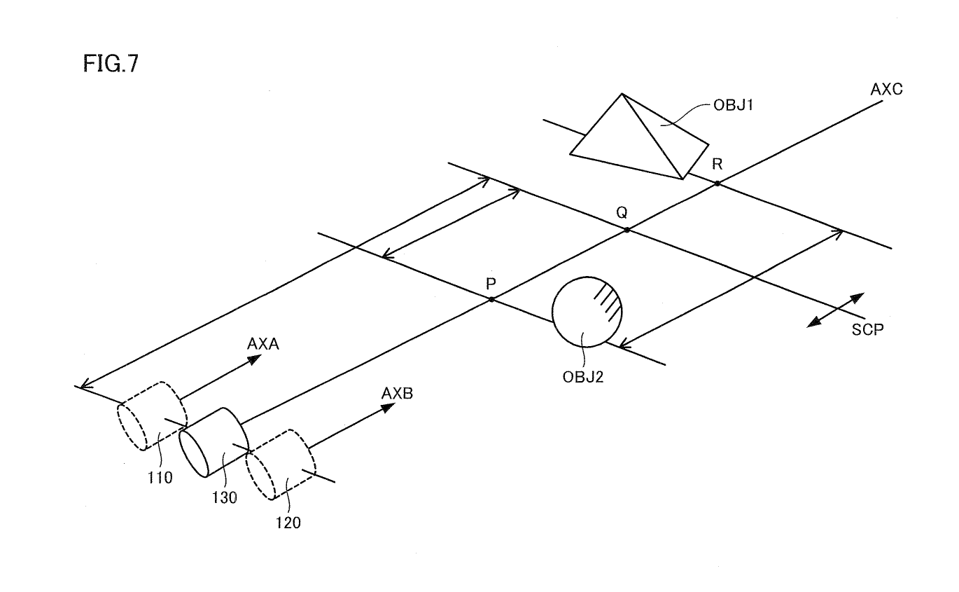

It should be noted that, in the case where an image pick-up portion can be prepared separately from the pair of image pick-up portions used for generating respective images for providing three-dimensional display, an image picked up by the image pick-up portion is used for providing two-dimensional display. Specifically, as shown in FIG. 7, for optical axis AXC centrally located between first image pick-up portion 110 and second image pick-up portion 120, preferably a third image pick-up portion 130 is disposed and an input image picked up by this third image pick-up portion 130 is used for providing two-dimensional display.

The processing as illustrated in FIG. 7 is more appropriate for such a case where input images are dynamically generated as described above. Namely, by means of the art of computer graphics such as polygon generation, virtual cameras can be arranged at any positions respectively. Then, for a common object, a pair of images for providing three-dimensional display and an image for providing two-dimensional display may be generated in parallel, and a switch may be made between the images for generating display depending on the conditions.

Switching Between Three-Dimensional Display and Two-Dimensional Display

Next, a general description will be given of switching between three-dimensional display and two-dimensional display by information processing system 1 in the present embodiment. In the present embodiment, in response to a (typically user's) request, the display mode of display 10 can be switched arbitrarily between three-dimensional display and two-dimensional display. Further, by information processing system 1, an adjustment can be made to a value representing a degree involved with three-dimensional display, namely an adjustment can be made as to which object is to be displayed in such a manner that allows the object to be perceived as located near the display surface of display 10.

In the case where a plurality of images having a prescribed parallax are used to provide three-dimensional display (static mode), the adjustment of the stereoscopic depth by means of the camera position cannot be made as described above. In this case, even if the stereoscopic depth is adjusted by means of the display position, a parallax amount for a certain object(s) still remains. Therefore, when a switch is made from three-dimensional display to two-dimensional display (namely to a state where respective parallax amounts for all objects are zero), a parallax amount for a certain object is suddenly lost.

In view of this, information processing system 1 of the present embodiment controls display 10, when a switch is made to display 10 from the state of providing three-dimensional display of an object to the state of providing two-dimensional display of the same object, so that the object is substantially non-displayed for a prescribed period. Namely, a certain interval (rest period) is provided so that a user does not have continuous perception, in terms of time, of an object displayed in the three-dimensional form and the same object displayed in the two-dimensional form.

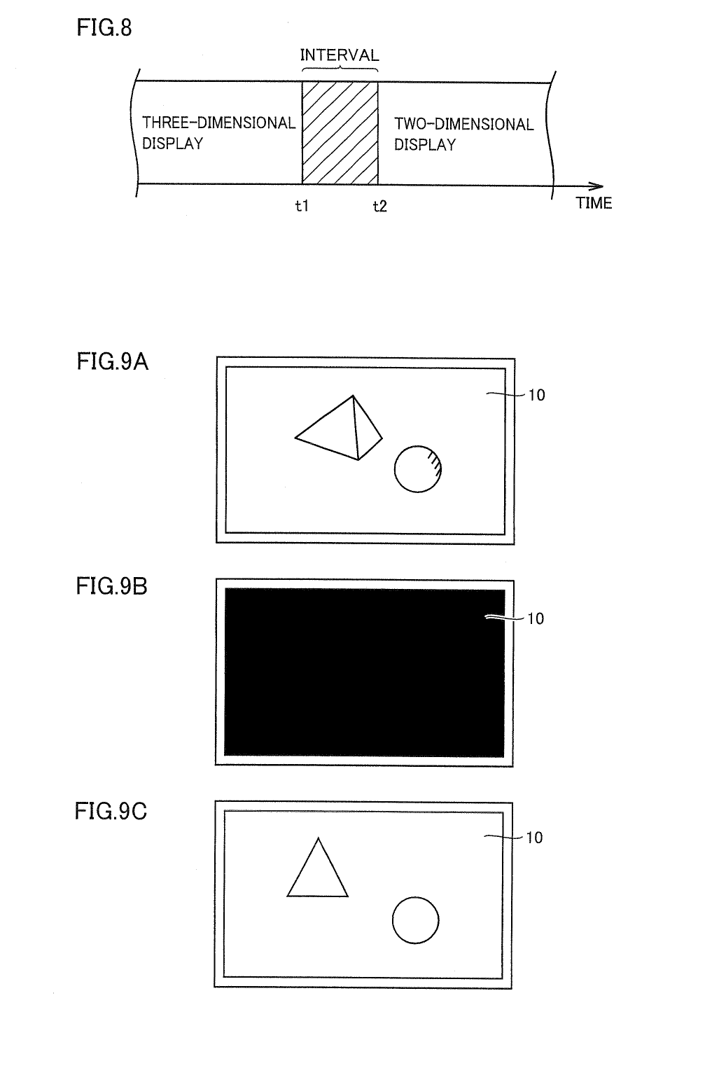

As shown in FIG. 8, for example, it is assumed that three-dimensional display of a certain object is stopped at time t1 and two-dimensional display of the object is started at time t2. Here, the period from time t1 to time t2 is the interval to be set. The length of the interval (length from time t1 to time t2) may be determined appropriately based human physiological characteristics or the like. An example of the interval is preferably set from several tens to several hundreds of msec.

Such an interval is provided for suppressing a sudden switch of the same object from a certain display mode to a different display mode. The display mode of display 10 in this interval may be any as long as human eyes and brain are reset in this interval. By way of example, three display modes will be given below.

(i) Stop the Display

For the above-described interval, display of display 10 may be substantially stopped. Specifically, operation of driver 114 (FIG. 1) for driving first LCD 116 and second LCD 126 (FIG. 1) respectively may be stopped for the period of the interval. Alternatively, the backlight for first LCD 116 and second LCD 126 may be turned off for the period of the interval.

(ii) Display an Independent Insert Image

For the above-described interval, display of an insert image independent of input images IMG1 and IMG2 used for three-dimensional display may be continued on display 10. Specifically, such an insert image is prepared in information processing system 1 (or may be externally downloaded to a memory in a detachable cartridge or a memory in the system) in advance. Images having various contents may be input to and displayed three-dimensionally on display 10. Here, “independent” means irrelevance to the contents of an image to be displayed. A typical example of the insert image is an image which is substantially monochrome (more preferably black image). It will be understood that “white image” and “gray image” may also be used according to the color or the like of display 10 itself or a peripheral portion of display 10.

For example, when display 10 is switched from the state of providing three-dimensional display of objects as shown in FIG. 9A to the state of providing two-dimensional display of the objects as shown in FIG. 9C, an insert image of solid black is displayed on display 10 as shown in FIG. 9B. Display of this insert image causes user's eyes and brain to be reset.

(iii) Display an Effect

For the above-described interval, display 10 may indicate an effect in such a manner that draws a user's interest away from three-dimensional display of an object. Namely, for the period of the interval, display 10 may indicate a presentation independent of input images IMG1 and IMG2. Examples of such display of a presentation may include a presentation in which an object image representing a shutter of a camera fades in, and a presentation in which an object irrelevant to the object to be displayed expands from the center of the screen while rotating.

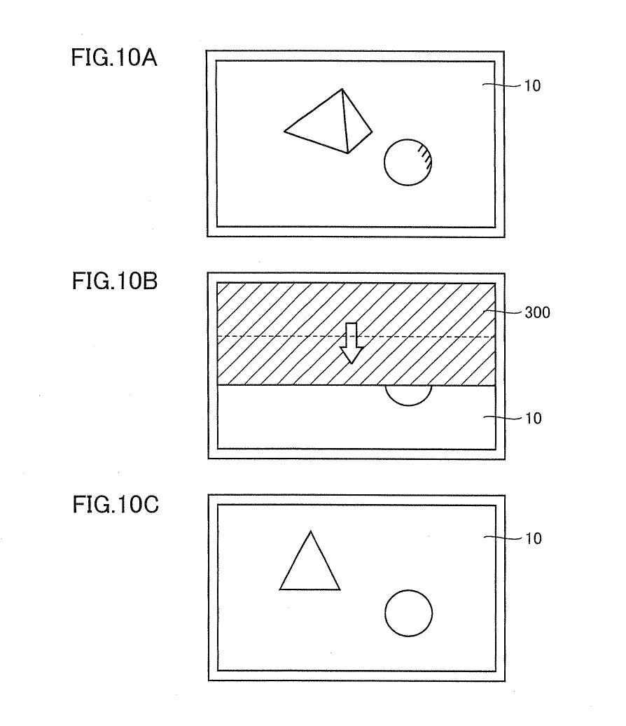

For example, when display 10 switches from the state of providing three-dimensional display of objects as shown in FIG. 10A to the state of providing two-dimensional display of the objects as shown in FIG. 10C, a presentation is created as shown in FIG. 10B in such a manner that an object 300 moves downward from the upper side of the screen. Display of movement of object 300 allows a user to feel as if a shutter of a camera is pressed. Further, an effect sound corresponding to the release sound of the shutter may be generated at the same time. The display of the effect causes user's eyes and brain to be reset from three-dimensional display and naturally accept the following two-dimensional display

Control Structure

A control structure for providing image display processing according to the present embodiment will now be described.

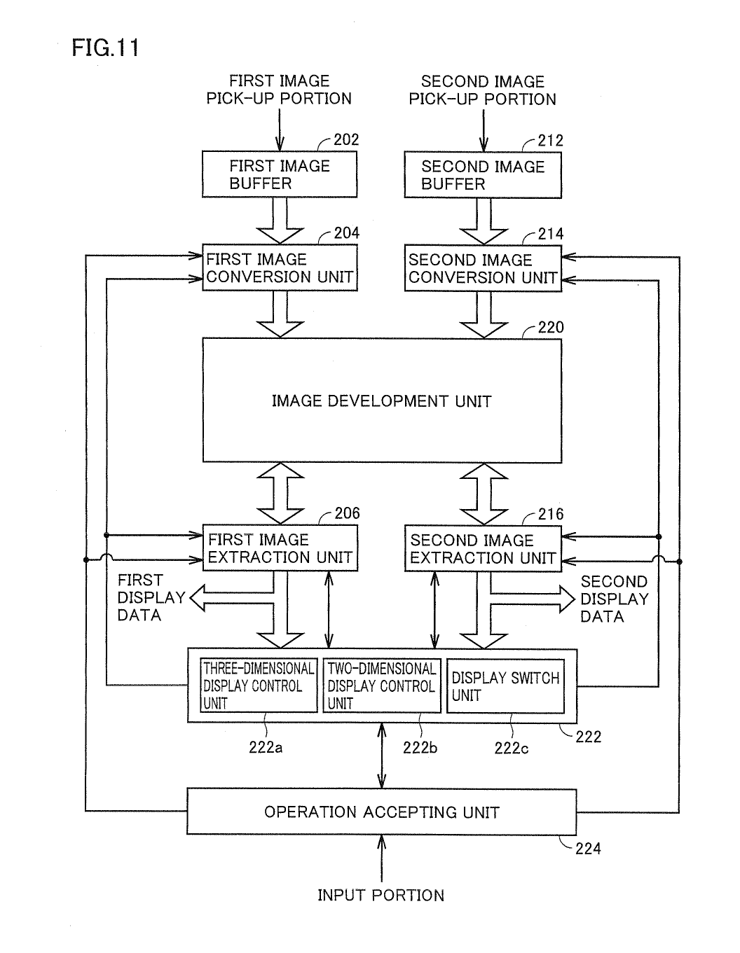

Referring to FIG. 11, information processing system 1 includes, as a control structure thereof, a first image buffer 202, a second image buffer 212, a first image conversion unit 204, a second image conversion unit 214, an image development unit 220, a first image extraction unit 206, a second image extraction unit 216, a control unit 222, and an operation accepting unit 224.

First image conversion unit 204, second image conversion unit 214 and control unit 222 are typically provided by execution of a display control program according to the present embodiment by CPU 100 (FIG. 1). In addition, first image buffer 202, second image buffer 212 and image development unit 220 are provided as specific storage areas within RAM 104 (FIG. 1). Operation accepting unit 224 is provided by cooperation of CPU 100 (FIG. 1) and a specific hardware logic and/or driver software. It is noted that the entirety or a part of functional blocks shown in FIG. 11 can also be implemented by known hardware.

Operation accepting unit 224 is associated with input portion 106 (FIG. 1). In response to a user's operation detected by input portion 106, operation accepting unit 224 provides details of user's input by means of input portion 106, to first image conversion unit 204, second image conversion unit 214, first image extraction unit 206, second image extraction unit 216, and control unit 222. More specifically, when the user indicates a zoom operation, operation accepting unit 224 informs first image conversion unit 204 and second image conversion unit 214 of details of the input by means of input portion 106. Based on the details of the input, first image conversion unit 204 and second image conversion unit 214 change the zoom-in ratio, zoom-out ratio, or the like. When the user indicates a scroll operation, operation accepting unit 224 informs first image extraction unit 206 and second image extraction unit 216 of the fact that the scroll operation is provided. Based on the fact that the scroll operation is provided, first image extraction unit 206 and second image extraction unit 216 determine a scroll amount (an amount of movement) or the like. When the user indicates a position of focused area frame FW, operation accepting unit 224 informs control unit 222 of the fact that the position is indicated, and the control unit determines the position of new focused area frame FW for example, based on the fact that the position is indicated.

Further, operation accepting unit 224 accepts a user's operation concerning a reference depth position (stereoscopic depth) to be visually perceived. In response to the user's operation, the relative displacement amount is adjusted and the position of superimposition of two images is adjusted with respect to the base value. More specifically, operation accepting unit 224 accepts the user's operation concerning the stereoscopic depth, and informs control unit 222 of the user's operation in the form of a user operation parameter value. Based on the user operation parameter value of which control unit 222 is informed, control unit 222 changes the relative displacement amount of the image for the right eye and the image for the left eye. More specifically, as the user operation parameter of which control unit 222 is informed is larger, the relative displacement amount is accordingly made larger. (Instead, the relative displacement amount may be made larger as the user operation parameter is smaller. In any case, for a certain direction of change (one of increase and decrease) of the user operation parameter, the direction of change (increase/decrease) is uniquely determined.) When the user operation parameter of which control unit 222 is informed is a prescribed value, control unit 222 determines to make a switch between three-dimensional display and two-dimensional display. Control unit 222 also determines the position of superimposition based on the determined relative displacement amount.

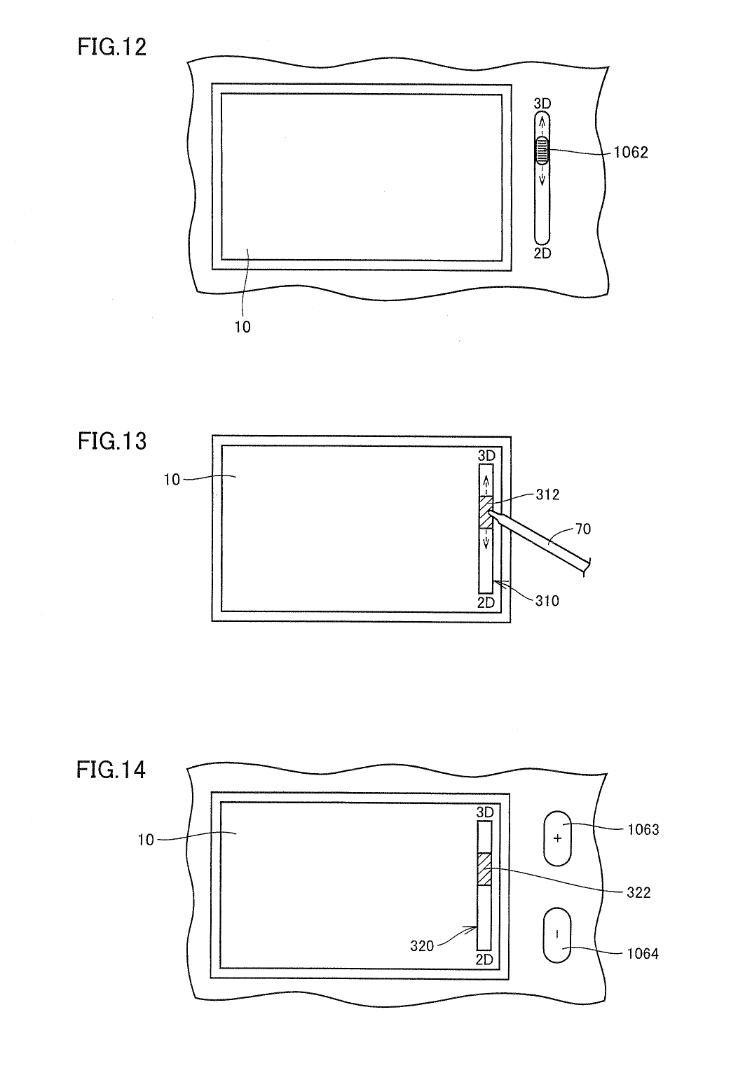

An example of an input portion (user interface) accepting a prescribed user operation parameter that determines the degree of adjustment of the stereoscopic depth may include the forms shown in FIGS. 12 to 14.

FIG. 12 shows an example of the input portion in the present embodiment, namely a mechanism (slider 1062) that is slidable along a prescribed uniaxial direction. This slider 1062 is provided on a side of information processing system 1 or near display 10, for example. As shown in FIG. 12, the letters “3D” representing three-dimensional display are indicated at the upside as seen on this drawing, and the letters “2D” representing two-dimensional display are indicated at the downside as seen on the drawing. As a user operates slider 1062 in a range between upside and downside as seen on the drawing, the relative displacement amount is changed. Accordingly the position of superimposition of the image for the right eye and the image for the left eye is changed, which successively changes the reference depth position (stereoscopic depth) of an object displayed in the form of a three-dimensional object by display 10. Namely, in accordance with the position of slider 1062, operation accepting unit 224 (FIG. 11) informs control unit 222 (FIG. 11) of a prescribed user operation parameter value associated with the degree of adjustment of the stereoscopic depth (a value determined in accordance with the position of the slider: slider value). Then, control unit 222 sets the relative displacement amount in accordance with the user operation parameter value.

As a user moves slider 1062 to the downside end as seen on the drawing, display presented by display 10 switches from three-dimensional display to two-dimensional display. Namely, operation accepting unit 224 (FIG. 11) accepts the fact that slider 1062 has reached the lowermost position (the user operation parameter has reached a critical value), and informs control unit 222 of this fact. Then, control unit 222 makes a switch between three-dimensional display and two-dimensional display.

According to the slider position for example, operation accepting unit 224 outputs a user operation parameter value in the form of a value of Omin to Omax. Control unit 222 calculates a relative displacement amount of Dmin to Dmax for the operation parameter value of Omin to Omax. In the present embodiment, the relative displacement amount is Dmax for the user operation parameter Omin, and the relative displacement amount is Dmin for the user operation parameter Omax (namely the relative displacement amount is smaller as the user operation parameter is larger). Then, in the present embodiment, there is a relation that a value larger than Omin and smaller than Omax corresponds to a value larger than Dmin and smaller than Dmax and D is smaller as O is larger.

In the present embodiment, the relative displacement amount has a positive value “in the case where the image for the right eye is moved rightward and the image for the left eye is moved leftward with respect to the base value”, and has a negative value “in the case where the image for the right eye is moved leftward and the image for the left eye is moved rightward”.

When the user operation parameter value is a prescribed value A, control unit 222 sets the relative displacement amount to zero and sets the position of superimposition to the base value. This prescribed value A (the user operation parameter value when the position of superimposition is set to the base value) is preferably a value close to Omax. When prescribed value A is Omax, Dmin is zero. When prescribed value A is a value which is somewhat smaller than Omax (for example, a value smaller than Omax and larger than (Omin+Omax)/4), Dmin is a negative value.

When the user operation parameter value is a prescribed value B, control unit 222 makes a switch to two-dimensional display. This prescribed value B (the user operation parameter value when a switch is made to two-dimensional display) is preferably Omin. Namely, in this case, as the user operation parameter value is decreased, adjustment of the stereoscopic depth by means of the display position is made, so that the stereoscopic depth is changed in such a manner that allows each object to be perceived as gradually moving in the direction of depth and finally switched to the two-dimensional display.

Such a slider 1062 can be employed to enable a user to seamlessly adjust the stereoscopic depth provided to the user and seamlessly make a switch between three-dimensional display and two-dimensional display, through one action. The user operation parameter used for changing the relative displacement amount is preferably only increased or decreased from the present value of the user operation parameter.

FIG. 13 shows another example of the input portion in the present embodiment, namely a user interface in the case where display 10 is a touch panel. For this user interface as well, there are displayed an image object 310 similar to the slider shown in FIG. 12 as described above and extending along a prescribed uniaxial direction, and an image object 312 displayed in the form of moving relative to image object 310. Image object 312 is moved in response to user's touch operation of touching the front side of display 10 with a touch pen (stylus pen) 70 or the like. An instruction is then generated according to the position of image object 312.

FIG. 14 shows still another example of the input portion in the present embodiment, namely a user interface using display 10 and operation buttons. For this user interface as well, there are displayed an image object 320 similar to the slider shown in FIG. 12 as described above and extending along a prescribed uniaxial direction, and an image object 322 displayed in the form of moving relative to image object 320. When a user presses an operation button (+ button 1063 and − button 1064) provided on information processing system 1, image object 322 moves. Namely, the axial position of the image object represented by a parameter is increased or decreased. Further, an instruction is generated according to the position (parameter value) of image object 322. In other embodiments, the numerical value of the parameter itself may be displayed on the display screen and the numerical value may be increased or decreased by means of an operation button or the like.

Referring again to FIG. 11, control unit 222 generally controls image display provided by display 10. More specifically, control unit 222 includes a three-dimensional display control unit 222a controlling display 10 so that input images IMG1 and IMG2 are used to three-dimensionally display an object included in the images, a two-dimensional display control unit 222b controlling display 10 so that an object included in input image IMG1 and/or input image IMG2 is two-dimensionally displayed in the form of a two-dimensional image, and a display switch unit 222c switching display 10 between three-dimensional display and two-dimensional display.

One of three-dimensional display control unit 222a and two-dimensional display control unit 222b is activated in response to an instruction from display switch unit 222c. Receiving from operation accepting unit 224 a request to switch from three-dimensional display to two-dimensional display or a request to switch from two-dimensional display to three-dimensional display, display switch unit 222c issues an instruction for selecting one of three-dimensional display control unit 222a and two-dimensional display control unit 222b to be activated. When a switch is made from two-dimensional display to three-dimensional display, display switch unit 222c provides an interval as described above.

In the following, a description will be given first of processing and functions for providing three-dimensional display by display 10, and then a description will be given of processing and functions for providing two-dimensional display.

1. Three-Dimensional Display

First image buffer 202 is associated with first image pick-up portion 110 (FIG. 1) and first image conversion unit 204 and it temporarily stores a raw image picked up by first image pick-up portion 110 (for the purpose of distinction, also referred to as a “first picked-up image”). In addition, first image buffer 202 accepts access from first image conversion unit 204.

Similarly, second image buffer 212 is associated with second image pick-up portion 120 (FIG. 1) and second image conversion unit 214 and it temporarily stores a raw image picked up by second image pick-up portion 120 (for the purpose of distinction, also referred to as a “second picked-up image”). In addition, second image buffer 212 accepts access from second image conversion unit 214

In the case where a pair of images having a prescribed parallax in advance is stored in RAM 104 (FIG. 1) or the like in advance, these images are read from RAM 104 and provided respectively to first image buffer 202 and second image buffer 212.

As seen from above, first image buffer 202 and second image buffer 212 function as image input means for accepting a pair of images having a prescribed parallax.

First image conversion unit 204 and second image conversion unit 214 convert a pair of images (typically the first picked-up image and the second picked-up image) stored respectively in first image buffer 202 and second image buffer 212 into input images having a prescribed size, respectively. First image conversion unit 204 and second image conversion unit 214 write respective input images generated as a result of conversion into image development unit 220.

Image development unit 220 is a storage area in which data of the input images generated by first image conversion unit 204 and second image conversion unit 214 is developed. Image development unit 220 determines, for each of input images IMG1 and IMG2, which region in the whole image is to be displayed, and performs processing for determining the position of superimposition of the two images. For this processing, image development unit 220 arranges each input image and a focused area frame in a virtual space (virtual arrangement). More specifically, image development unit 220 virtually arranges input images IMG1 and IMG2 superimposed on each other, and further superimposes a focused area frame on the input images. Three-dimensional display control unit 222a functions, for input images IMG1 and IMG2 having a prescribed parallax, as relative positional relation setting means for setting the position of superimposition of these input images. Then, following an instruction from three-dimensional display control unit 222a, image development unit 220 arranges input images IMG1 and IMG2 at a certain position of superimposition.

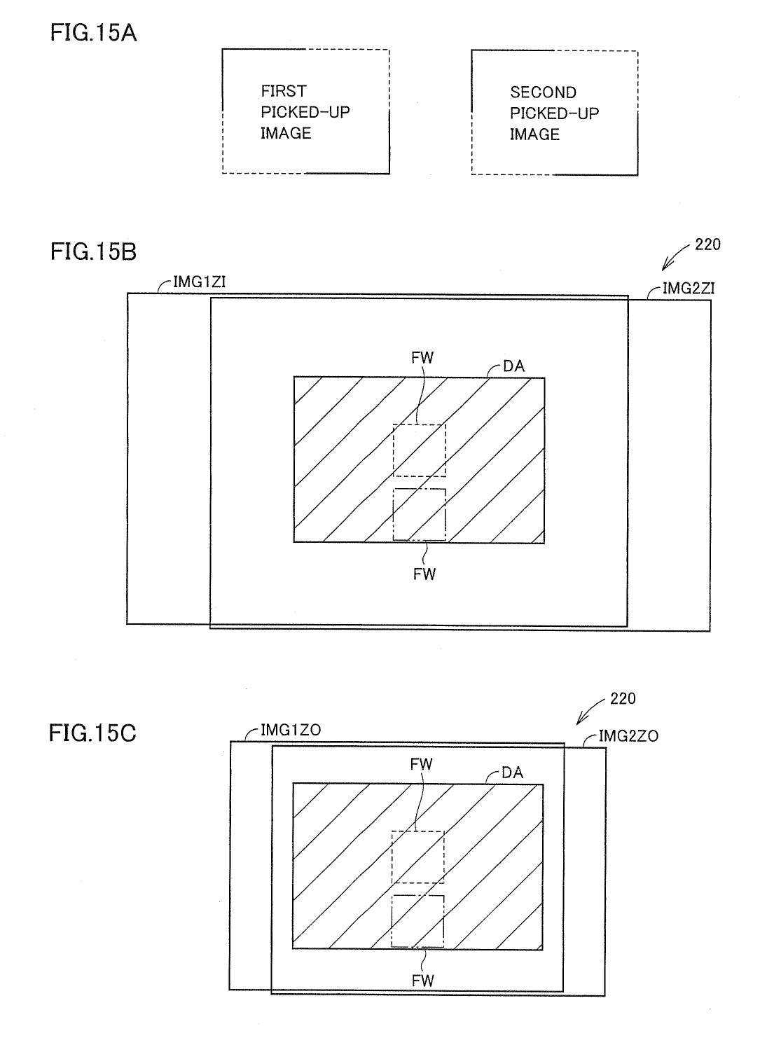

Referring to FIGS. 15A to 15C, contents of processing provided by first image conversion unit 204, second image conversion unit 214 and image development unit 220 will be described.

As shown in FIG. 15A, it is assumed that the first picked-up image is obtained as a result of image pick-up by first image pick-up portion 110 and the second picked-up image is obtained as a result of image pick-up by second image pick-up portion 120. First image conversion unit 204 and second image conversion unit 214 perform conversion processing of these first picked-up image and second picked-up image, to thereby generate input image IMG1 and input image IMG2, respectively. Then, the generated image data is developed in a virtual space by image development unit 220 so that IMG1 and IMG2 overlap as shown in FIGS. 15B and 15C. Here, the data (a group of pixels) developed by image development unit 220 is assumed to correspond to pixels constituting display 10 (one display unit of first LCD 116 and second LCD 126) on one-to-one basis. Therefore, a common display target area frame DA corresponding to the resolution of display 10 (for example, 512 dots×384 dots or the like) is (virtually) defined by image development unit 220. It is noted that a position of display target area frame DA can be changed to any position in accordance with a user's operation (typically, a scroll operation), initial setting, or the like. More specifically, in FIGS. 15A to 15C, when an upward, downward, leftward, or rightward scroll operation is performed for example, display target area frame DA accordingly moves upward, downward, leftward, or rightward. As a result of setting of display target area frame DA common to input image IMG1 and input image IMG2, the area of input image IMG1 determined by display target area frame DA is set as an area (first display target area) of input image IMG1 displayed on display 10 (first LCD 116), and at the same time, the area of input image IMG2 determined by display target area frame DA is set as an area (second display target area) of input image IMG2 displayed on display 10 (second LCD 126).

As the size of display target area frame DA in image development unit 220 is constant, a zoom operation can be performed by changing a size of an input image to be developed in a virtual space by image development unit 220. Namely, when zoom-in display (zoom-in) is indicated, as shown in FIG. 15B, the first picked-up image and the second picked-up image are converted to input images IMG1ZI and IMG2ZI having a relatively large pixel size respectively and data thereof is developed in the virtual space. On the other hand, when zoom-out display (zoom-out) is indicated, as shown in FIG. 15C, the first picked-up image and the second picked-up image are converted to input images IMG1ZO and IMG2ZO having a relatively small pixel size respectively and data thereof is developed in the virtual space.

By thus changing as appropriate a size of input images generated by first image conversion unit 204 and second image conversion unit 214, a size relative to display target area frame DA can be varied, to thereby realize a zoom operation.

By changing a position or a size of input image IMG1 and/or input image IMG2 with respect to display target area frame DA as described above, the area of input image IMG1 displayed on display 10 (the first display target area) and/or the area of input image IMG2 displayed on display 10 (the second display target area) are/is updated.

From another point of view, relative to display target area frame DA, the position at which input image IMG1 and/or input image IMG2 are/is arranged may be adjusted, so that the position of superimposition of input image IMG1 and input image IMG2 can also be varied. Further, when a position or a size of the area of input image IMG1 displayed on display 10 (the first display target area) and a position or a size of the area of input image IMG2 displayed on display 10 (the second display target area) are updated by changing a position or a size of input images IMG1 and IMG2 with respect to display target area frame DA, a position or a size of an area present within focused area frame FW which is a determination area (target determination area for image matching processing) for input images IMG1 and IMG2 is also changed accordingly.

It is noted that the relative positional relation between focused area frame FW corresponding to a determination area and display target area frame DA is preferably maintained constant. For example, focused area frame FW can be set to be located in a central portion or a lower central portion of display target area frame DA. This is because the user often pays attention to a range in a central portion or a lower central portion of an image displayed on display 10. It is noted that any of positions of focused area frame FW and display target area frame DA in image development unit 220 may preferentially be determined, so long as relative positional relation therebetween is maintained. Namely, when a position of focused area frame FW is changed in response to a user's operation, a position of display target area frame DA may be determined in accordance with the resultant position of focused area frame FW. In contrast, when a position of display target area frame DA is changed in response to a user's operation, a position of focused area frame FW may be determined in accordance with the resultant position of display target area frame DA.

For facilitating understanding, though FIGS. 15A to 15C show conceptual views in which input images are virtually arranged such that an overlapping range is created therebetween, this virtual arrangement does not necessarily match with actual data arrangement in image development unit 220.

Referring again to FIG. 11, first image extraction unit 206 and second image extraction unit 216 extract image information (including a color attribute, a luminance attribute, and the like) on a prescribed area from input image IMG1 and input image IMG2 developed in image development unit 220 respectively, and output the information to three-dimensional display control unit 222a.

In addition, first image extraction unit 206 and second image extraction unit 216 extract first display data and second display data for controlling display contents on first LCD 116 and second LCD 126 of display 10 from image development unit 220, based on the position of superimposition calculated by three-dimensional display control unit 222a. It is noted that extracted first display data and second display data are written in first VRAM 112 and second VRAM 122, respectively. Namely, for display target area frame DA set for input images IMG1 and IMG2 each according to the position of superimposition, three-dimensional display control unit 222a functions as image output means for outputting, to display 10, a first partial image (first display data) included in display target area frame DA in input image IMG1, and a second partial image (second display data) included in display target area DA in input image IMG2.

Three-dimensional display control unit 222a evaluates a correspondence (matching score) between input image IMG1 and input image IMG2 extracted by first image extraction unit 206 and second image extraction unit 216 respectively, based on image information of input image IMG1 and input image IMG2. Typically, three-dimensional display control unit 222a calculates a matching score (a correlation score) between the input images for each prescribed block size (typically, a range of focused area frame FW) and specifies the position of superimposition (base value) where the calculated matching score is highest.

Namely, three-dimensional display control unit 222a determines a correspondence (matching score) between input image IMG1 and input image IMG2 having a prescribed parallax, and thereby appropriately changes the position of superimposition of input image IMG1 and input image IMG2. Accordingly, the reference depth position (stereoscopic depth) perceived by a user is successively adjusted.

2. Two-Dimensional Display

When two-dimensional display is to be provided by display 10, basically the first display data and the second display data that are the same display data (without parallax) are output. In principle, therefore, image development unit 220 may develop a single kind of input image. Thus, in a typical example in which the first picked-up image is used to provide two-dimensional display, only first image buffer 202 and first image conversion unit 204 are activated while second image buffer 212 and second image conversion unit 214 are inactivated, following an instruction from two-dimensional display control unit 222b.

Further, following an instruction from two-dimensional display control unit 222b, first image extraction unit 206 and second image extraction unit 216 output an image in the same area, which is included in the input image developed by image development unit 220, as first display data and second display data, respectively. In the typical example in which the first picked-up image is used to provide two-dimensional display, the first partial image data included in display target area frame DA of input image IMG1 is output as the first display data and the same data is output as the second display data.

General Description of Image Matching Processing

As described above, in determining or updating the position of superimposition of input image IMG1 and input image IMG2, a matching score between the images should successively be calculated. In such an example that the entire input image is subjected to search or resolution (the number of pixels) of an input image is higher, processing load is higher and a longer period of time is also required for processing. Consequently, responsiveness to the user and operability tend to degrade.

Then, in information processing system 1 according to the present embodiment, two types of processing as shown below are mainly adopted to reduce processing load and to enhance responsiveness and operability.

In first processing, a correspondence (matching score) between input image IMG1 and input image IMG2 is determined in advance, so as to determine a base value of the position of superimposition of input image IMG1 and input image IMG2. Namely, with regard to input image IMG1 and input image IMG2 having a prescribed parallax, an image included in an at least partial area of input image IMG1 and an image included in an at least partial area of input image IMG2 are compared with each other while being changed as appropriate. Here, the area used for comparison is varied under the condition that the position of superimposition of input image IMG1 and input image IMG2 is within a first range. Then, based on a result of this comparison, a position of superimposition where the correspondence (matching score) between input image IMG1 and input image IMG2 is highest among positions of superimposition within the first range is determined as the base value (base position of superimposition). In this processing for determining the base position of superimposition, basically, a correspondence (matching score) between the input images is determined in a state where no information is provided, and a relatively wide range (the first range) is subjected to search.

Further, when a scroll operation or a zoom operation is performed after the base position for superimposition is thus determined, input image IMG1 and input image IMG2 are virtually arranged at each of a plurality of positions of superimposition present in a prescribed range relative to the determined base position of superimposition, and a corresponding determination area is set for each overlapping range generated in each case.

Furthermore, a correspondence (matching score) between input image IMG1 and input image IMG2 is determined for each set determination area. As the position of superimposition has roughly been known after the base position of superimposition was determined, an area subjected to search can relatively be made smaller. Then, based on the position of superimposition determined by the search processing described above, the position of superimposition of input image IMG1 and input image IMG2 on display 10 is determined. Namely, based on a result of comparison between the image included in an at least partial area of input image IMG1 and the image included in an at least partial area of input image IMG2 while the position of superimposition of each area is varied within a second range narrower than the first range above, that is, a prescribed range relative to the base position of superimposition, the position of superimposition where the correspondence (matching score) between the first display target area and the second display target area is highest among the positions of superimposition within the second range is finally used for providing three-dimensional display.

Thus, in information processing system 1 according to the present embodiment, in principle, processing for determining the correspondence (matching score) between input image IMG1 and input image IMG2 over a relatively wide range is limited to only the processing performed first. If a scroll operation or a zoom operation is subsequently requested, the correspondence (matching score) is determined only within a narrower range, relative to the base position of superimposition having been obtained first. Thus, since a range for determining a correspondence (matching score) between images can further be limited, processing load can be reduced.

In second processing, accuracy in search processing for determining a correspondence (matching score) between images is switched in a plurality of steps from a rough step to a finer step, to thereby reduce processing load. Namely, initially, rough search lower in accuracy is performed. Then, fine search higher in accuracy is performed using a position of superimposition obtained by the rough search as a reference, thus determining an accurate position of superimposition.

More specifically, initially, input image IMG1 and input image IMG2 are virtually arranged at each of a plurality of positions of superimposition as varied by a prescribed first variation, and a matching score between the input images is calculated for each variation for adjustment. Then, the position of superimposition where the matching score is highest among the calculated matching scores is specified as a first position of superimposition.

Then, using the previously specified first position of superimposition as the reference, input image IMG1 and input image IMG2 are virtually arranged at each of a plurality of positions of superimposition as varied by a second variation smaller than the first variation described above, and a matching score between the input images at each position is calculated. Then, the position of superimposition where the matching score is highest among the calculated matching scores is specified as a second position of superimposition.

It is noted that search processing may be performed in two or more steps, depending on a size of an input image, processing capability of a device, or the like. In the present embodiment, a configuration where search processing is performed in three steps as will be described later is exemplified. In addition, this second processing is applicable to any of (1) determination of a base position of superimposition included in the first processing described above and (2) subsequent determination of a position of superimposition.

Moreover, it is not necessary to perform both of the first and second processing described above, and only any one of them may be performed.

As described above, in information processing system 1 according to the present embodiment, three-dimensional display is provided based on a result of processing for image matching between input image IMG1 and input image IMG2. Therefore, basically, a still image is used as input image IMG1 and input image IMG2. The system, however, is also applicable to a motion picture if the system has a capability of processing every frame included in the motion picture.

Details of Image Matching Processing

A description will now be given of further details of image matching processing described above. By way of example, a description will be given of details of processing for providing three-dimensional display of an object, which is included in arbitrarily set focused area frame FW as shown in above-described FIGS. 6A to 6D, in such a manner that the object appears to be located at the display surface of display 10. Namely, in this image matching processing, the position of superimposition of two images is determined. Here, the determination of the position of superimposition of two images is specifically the determination of to what degree input image IMG1 and input image IMG2 should be displaced from each other for display on display 10. Therefore, this may also be referred to as determination of “display displacement amount”.

(1) Processing for Determining Base Position of Superimposition

As described above, initially, a base position of superimposition of input image IMG1 and input image IMG2 is determined. Details of the processing for determining the base position of superimposition will be described below.

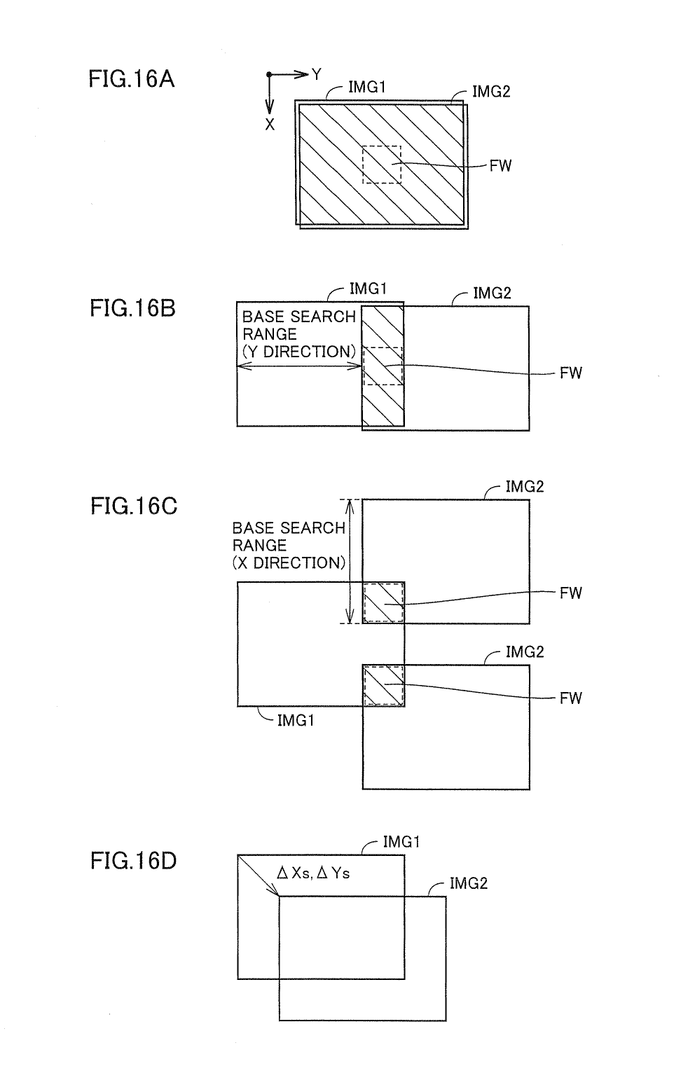

Referring to FIGS. 16A to 16D, a base position of superimposition of input image IMG1 and input image IMG2 is determined by determining a correspondence (matching score) therebetween. More specifically, a position of superimposition of input image IMG1 and input image IMG2 is successively changed while a matching score between the input images at each position of superimposition is successively calculated. In other words, a position of input image IMG2 with respect to input image IMG1 (or a position of input image IMG1 with respect to input image IMG2) is displaced step by step, and a search is made for a position where respective images of an object seen within an overlapping range of the images match each other to the highest degree. Therefore, in determining a base position of superimposition, substantially the entire surface where an overlapping range between input image IMG1 and input image IMG2 is created is subjected to search processing.

Namely, for an at least partial area of input image IMG1 (an area corresponding to focused area frame FW) and/or an at least partial area of input image IMG2 (an area corresponding to focused area frame FW), the position of superimposition of the input images is varied and a comparison is made therebetween to thereby determine a base position of superimposition. At this time, an image included in an at least partial area of the area of input image IMG1 displayed on display 10 (first display target area) and/or an image included in an at least partial area of the area of input image IMG2 displayed on display 10 (second display target area) are (is) used as image(s) for comparison for determining the matching score, and accordingly “display displacement amount” representing a position of superimposition is determined.

In this processing for determining a base position of superimposition, a matching score of an image within focused area frame FW described above does not necessarily have to be evaluated, and evaluation can be made based on a matching score within the entire area in an overlapping range of these input images. The finally determined “display displacement amount”, however, intends to provide three-dimensional display of an object included in focused area frame FW, to which the user is paying attention, in a desired manner (so that the object is perceived as being near the display surface, for example). From such a point of view, a matching score of an image within focused area frame FW is preferably evaluated also in determining a base position of superimposition. In the description below, processing for evaluating a matching score of an image within focused area frame FW set in an overlapping range of the input images will be exemplified.

A base position of superimposition is determined from alternatives of the position of superimposition. For respective alternatives of the position of superimposition, respective matching scores between the images are determined. Among the alternatives of the position of superimposition, a position of superimposition with the highest matching score is the base position of superimposition. A range in which the alternatives are searched for is referred to as search range (hereinafter also referred to as “base search range”, for the purpose of distinction from a search range in processing for determining a display displacement amount as described later (position of superimposition to be actually used for three-dimensional display)). This search range includes, for the lateral direction, from “position of superimposition A at which the rightmost end of IMG1 is located at the left of the leftmost end of IMG2”, from which IMG1 is gradually and relatively moved rightward, to “position of superimposition B at which the leftmost end of IMG1 is located at the right of the rightmost end of IMG2”. It should be noted that, in order to determine the matching score, a region in which IMG1 and IMG2 overlap each other is necessary, and therefore, only in a region necessary for determining the matching score, actually IMG1 and IMG2 overlap each other even at position of superimposition A or position of superimposition B. Namely, as described above, for evaluating a matching score between images within focused area frame FW, IMG1 and IMG2 have to overlap each other at least by the size of the inside of focused area frame FW. In other words, the base search range includes all positions of superimposition, from the position of superimposition where the distance between input image IMG1 and input image IMG2 is substantially zero (see FIG. 16A), to the position of superimposition where an overlapping range can maintain the size of focused area frame FW corresponding to the determination area (see FIGS. 16B and 16C).

In the processing for determining the base position of superimposition, search (scanning) is preferably carried out in both of an X direction (up/down direction in three-dimensional display) and a Y direction (left/right direction, namely lateral direction, in three-dimensional display). It is noted that search may be carried out in the Y direction only, if first image pick-up portion 110 and second image pick-up portion 120 are fixed at positions flush with each other.

FIG. 16B illustrates processing in which input image IMG2 is moved only toward a positive side (+ side) in the Y direction in accordance with a relative position of arrangement of first image pick-up portion 110 and second image pick-up portion 120, Instead, input image IMG2 may also be moved toward a negative side (− side) in the Y direction.

For example, assuming that the highest matching score is calculated at such a position of superimposition as shown in FIG. 16D, a position of superimposition of input image IMG1 and input image IMG2 shown in FIG. 16D, that is, the position of superimposition represented by a vector (ΔXs, ΔYs) is the base position of superimposition. This base position of superimposition corresponds to a position deviation corresponding to a parallax in the determination area set in the input images. Therefore, even if focused area frame FW is set at a position different from the determination area used for determining the base position of superimposition, deviation from the base position of superimposition is considered as relatively small. Therefore, by performing search processing based on such a base position of superimposition within a relatively smaller search range, image matching processing can be performed faster. It is noted that the vector (ΔXs, ΔYs) of the base position of superimposition is typically defined by the number of pixels.

Assuming any coordinate on input images IMG1 and IMG2 as (X, Y) {here, Xmin≦X≦Xmax; Ymin≦Y≦Ymax}, a pixel at a coordinate (X, Y) on input image IMG1 corresponds to a pixel at a coordinate (X−ΔXs, Y−ΔYs) on input image IMG2.

(2) Search Processing in a Plurality of Steps

In the search processing for determining a base position of superimposition as described above, a conventional method requires that a position of superimposition of input images is successively evaluated by displacing the position of superimposition for each pixel. In the search processing according to the present embodiment, however, a base position of superimposition is searched for faster by switching search accuracy in a plurality of steps. The search processing in a plurality of steps according to the present embodiment will be described hereinafter.

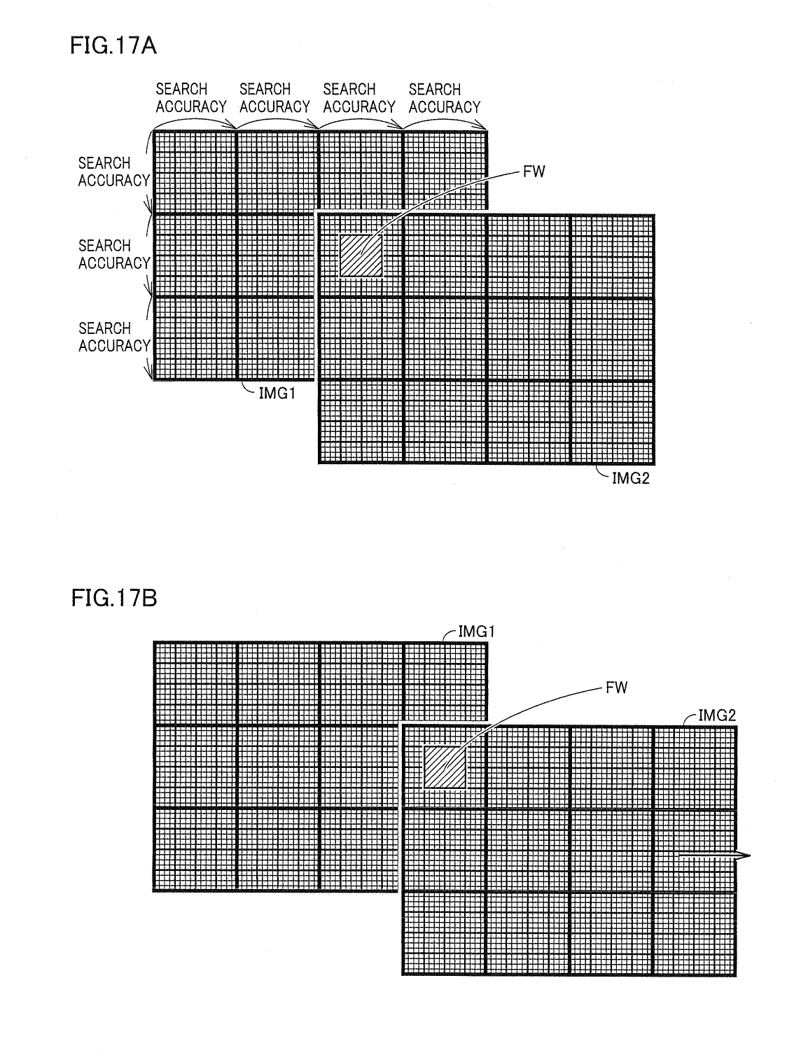

A configuration for performing search processing with search accuracy being switched in three steps will be exemplified in the description below. The search accuracy switching steps are not particularly restricted and they can be selected as appropriate in accordance with a pixel size or the like of an input image. For facilitating understanding, FIGS. 17A, 17B, 18A, 18B, 19A, and 19B show input images IMG1 and IMG2 of 64 pixels×48 pixels, however, input images IMG1 and IMG2 are not limited to this pixel size.

In the present embodiment, by way of example, search accuracy is set to 16 pixels in the search processing in the first step, search accuracy is set to 4 pixels in the search processing in the second step, and search accuracy is set to 1 pixel in the search processing in the final third step.

More specifically, as shown in FIG. 17A, in the search processing in the first step, a matching score is evaluated at each of twelve positions of superimposition in total (three in the X direction×four in the Y direction) displaced by 16 pixels in the X direction and 16 pixels in the Y direction, from the position of superimposition where the distance between input image IMG1 and input image IMG2 is substantially zero. Namely, after calculation of a matching score at a position of superimposition shown in FIG. 17A is completed, a matching score at a position of superimposition displaced by 16 pixels in the Y direction is subsequently calculated as shown in FIG. 17B. At the remaining nine positions of superimposition (not shown) as well, respective matching scores are calculated. Then, the position of superimposition achieving the highest matching score among the matching scores calculated in correspondence with these positions of superimposition is specified. After this position of superimposition is specified, the search processing in the second step is performed. It is noted that the matching score is calculated between an image within input image IMG1 corresponding to focused area frame FW and an image within input image IMG2 corresponding to focused area frame FW. Although the position at which focused area frame FW is set appears to be different between FIGS. 17A and 17B, actually the position of focused area frame FW is fixed. IMG1 and IMG2 are moved with respect to FW to reach the state shown in FIG. 17A or 17B.

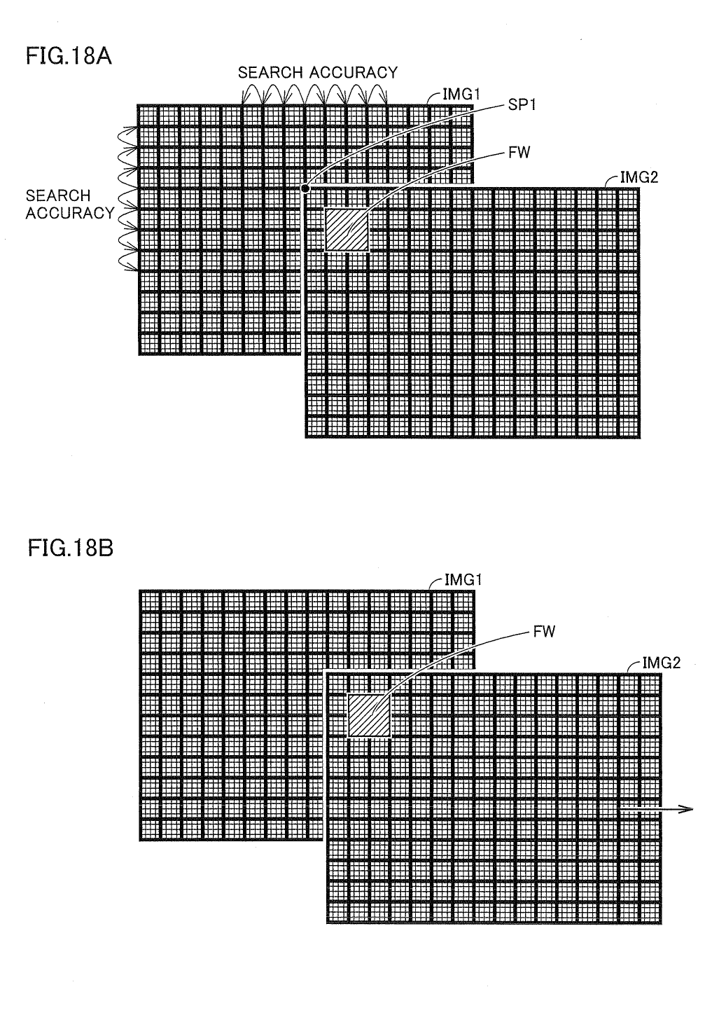

As shown in FIG. 18A, the position of superimposition achieving the highest matching score in the search processing in the first step is defined as a first matching position SP1. Then, in the search processing in the second step, matching scores are evaluated at 64 positions of superimposition in total (eight in the X direction×eight in the Y direction) displaced by 4 pixels in the X direction and 4 pixels in the Y direction, with this first matching position SP1 serving as the reference. Namely, after calculation of a matching score at a position of superimposition shown in FIG. 18A is completed, a matching score at a position of superimposition displaced by 4 pixels is subsequently calculated as shown in FIG. 18B. At the remaining 62 positions of superimposition (not shown) as well, respective matching scores are calculated.

Though FIG. 18A shows an example where four positions of superimposition forward in the X direction and three positions of superimposition rearward in the X direction and four positions of superimposition forward in the Y direction and three positions of superimposition rearward in the Y direction, relative to first matching position SP1, are set as positions of superimposition for evaluating matching scores, any setting method may be adopted so long as a position of superimposition is set relative to first matching position SP1.

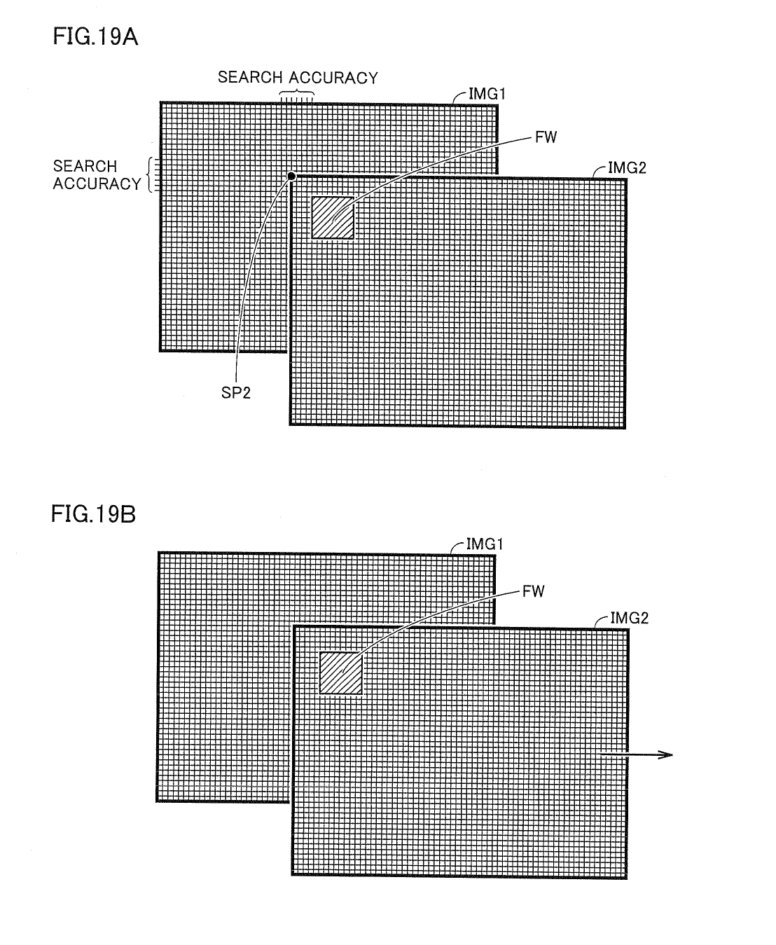

Similarly, as shown in FIG. 19A, the position of superimposition achieving the highest matching score in the search processing in the second step is defined as a second matching position SP2. Then, in the search processing in the third step, matching scores are evaluated at 64 positions of superimposition in total (eight in the X direction×eight in the Y direction) displaced by 1 pixel in the X direction and 1 pixel in the Y direction, with this second matching position SP2 serving as the reference. Namely, after calculation of a matching score at a position of superimposition shown in FIG. 19A is completed, a matching score at a position of superimposition displaced by 1 pixel is subsequently calculated as shown in FIG. 19B. At the remaining 62 positions of superimposition (not shown) as well, respective matching scores are calculated.

Though FIG. 19A shows an example where four positions of superimposition forward in the X direction and three positions of superimposition rearward in the X direction and four positions of superimposition forward in the Y direction and three positions of superimposition rearward in the Y direction, relative to second matching position SP2 as a center, are set as positions of superimposition for evaluating matching scores, any setting method may be adopted so long as a position of superimposition is set relative to second matching position SP2.

By thus adopting a method of increasing search accuracy in a stepwise fashion, the total number of times of calculation of a matching score can be decreased. For example, in the examples shown in FIGS. 17A, 17B, 18A, 18B, 19A, and 19B, if search is carried out in a unit of 1 pixel×1 pixel as in the search processing in the third step, it is necessary to perform processing for calculating matching scores 3072 times in total (64×48). In contrast, in the search processing according to the present embodiment, it is only necessary to perform processing for calculating matching scores 140 times in total (12 times in the first step, 64 times in the second step, and 64 times in the third step).

(3) Processing for Determining Display Displacement Amount

When the base position of superimposition of input image IMG1 and input image IMG2 is determined in advance as described above, in a prescribed search range including this base position of superimposition (for the purpose of distinction from the base search range described above, hereinafter also referred to as a “individual search range”), a matching score between images within focused area frame FW, which is the determination area set for an overlapping range of input image IMG1 and input image IMG2, is successively calculated, and a display displacement amount (position of superimposition actually used for three-dimensional display) is determined in correspondence with the position of superimposition achieving the highest matching score. Details of the processing for determining a display displacement amount according to the present embodiment will be described hereinafter.

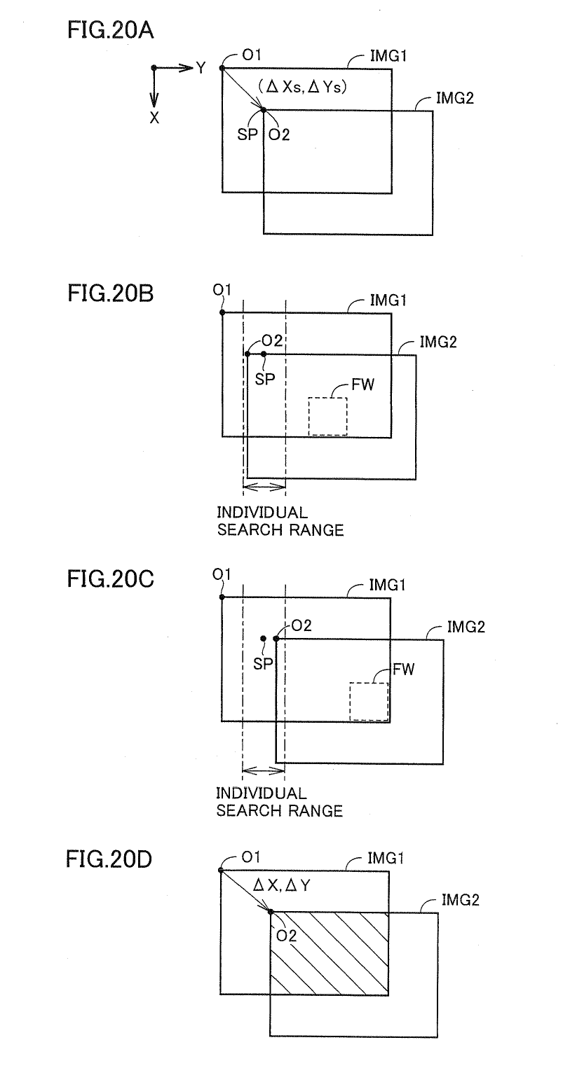

FIGS. 20A to 20D are diagrams for illustrating processing for determining a display displacement amount according to the first embodiment of the present invention. Initially, as shown in FIG. 20A, it is assumed that a vector (ΔXs, AYs) is determined in advance as the base position of superimposition.

The individual search range is determined based on the base position of superimposition. For example, assuming that an upper left vertex of input image IMG1 is denoted as O1 and an upper left vertex of input image IMG2 is denoted as O2, vertex O2 of input image IMG2 at the time when input image IMG1 and input image IMG2 are virtually arranged in correspondence with the base position of superimposition is defined as a matching position SP. Then, by using this matching position SP, an individual search range covering a prescribed range as shown in FIGS. 20B and 20C can be defined. Namely, by moving vertex O2 of input image IMG2 from a left end to a right end of this individual search range, a matching score between images within focused area frame FW at each position of superimposition is calculated.

Then, the display displacement amount is determined in correspondence with the position of superimposition achieving the highest matching score among the calculated matching scores. This individual search range is set to be narrower than the base search range described above. By way of a typical example, the individual search range can be defined as a prescribed ratio to a length in the Y direction of input image IMG1, IMG2, and it is set, for example, to approximately 20 to 50% and preferably to approximately 25%. Here, the individual search range is defined as a ratio in order to flexibly adapt to change in a pixel size of input images IMG1 and IMG2 in accordance with the user's zoom operation.

In principle, in the processing for determining a display displacement amount, search only in the Y direction (a direction in which a parallax is created between the first and second image pick-up portions) is carried out. This is because a parallax is not caused in the X direction in principle and a relative difference in the X direction is corrected by a prescribed base position of superimposition. Naturally, search may be carried out also in the X direction in addition to the Y direction.

Though FIGS. 20B and 20C show examples where focused area frame FW is set by using input image IMG2 as the reference (that is, in a central portion of input image IMG2), focused area frame FW may be set by using input image IMG1 as the reference, or focused area frame FW may be set by using an overlapping range of input image IMG1 and input image IMG2 as the reference.

Assuming that the highest matching score is calculated at a position of superimposition as shown in FIG. 20D as a result of such search processing, the position of superimposition of image IMG1 and input image IMG2, that is, vector (ΔX, ΔY), represents the display displacement amount. This display displacement amount is used for controlling which image data is to be displayed, regarding pixels in first LCD 116 and second LCD 126 corresponding to slit 14 (FIG. 2) in parallax barrier 12. Namely, display data at a coordinate (X, Y) on input image IMG1 and display data at a coordinate (X−ΔX, Y−ΔY) on input image IMG2 are provided to a pair of pixels corresponding to common slit 14 (FIG. 2).

Namely, with regard to an at least partial area of input image IMG1 (the area corresponding to focused area frame FW) and an at least partial area of input image IMG2 (the area corresponding to focused area frame FW), a matching score between the images is calculated a plurality of times while a position of superimposition of them is varied. Then, the area of input image IMG1 displayed on display 10 (first display target area) and/or the area of input image IMG2 displayed on display 10 (second display target area) are (is) determined in correspondence with the position of superimposition achieving the highest matching score among the calculated matching scores. Then, position(s) of the area of input image IMG1 displayed on display 10 (first display target area) and/or the area of input image IMG2 displayed on display 10 (second display target area) are (is) updated based on the display displacement amount corresponding to the determined position of superimposition, and three-dimensional display on display 10 is provided by using a partial image of input image IMG1 and a partial image of input image IMG2 included in the respective areas at the resultant positions.

In addition, the entirety or a part of image data included in an overlapping range of input image IMG1 and input image IMG2 shown in FIG. 20D is provided to display 10. If an effective display size (the number of pixels) of display 10 is greater than the overlapping range of the input images and/or if an overlapping range sufficient for satisfying an aspect ratio of display 10 cannot be set, a portion where no display data is present may be compensated for by providing, for example, monochrome display with black or white.

The search processing in a plurality of steps described above is also applicable to processing for determining a display displacement amount. Details of the search processing in a plurality of steps are described above, and the description will not be repeated.

Display contents immediately after switch from 3D to 2D

As described above, a switch is made from a state of three-dimensional display using two input images having a prescribed parallax to a state of two-dimensional display using one input image. In this case, contents of the image shown by display 10 (the position of the same object for example) remarkably change. In view of this, it is preferable to generate two-dimensional display using an image obtained in display target area frame DA in the state where input image IMG1 and input image IMG2 are virtually arranged at the above-described base position of superimposition.

Namely, immediately after display 10 is switched from three-dimensional display to two-dimensional display, display switch unit 222c (FIG. 11) causes display 10 to display a first partial image (first display data) and/or a second partial image (second display data) obtained in display target area frame DA when the position of superimposition of input image IMG1 and input image IMG2 is substantially matched with the base position of superimposition having been determined based on the correspondence (matching score) between input image IMG1 and input image IMG2.

In other words, input image IMG1 and input image IMG2 are arranged so that these images have the positional relation as shown in above-described FIG. 16D, and an image included in display target area frame DA set in an overlapping range of these input images is used for two-dimensional display.

Processing Procedure

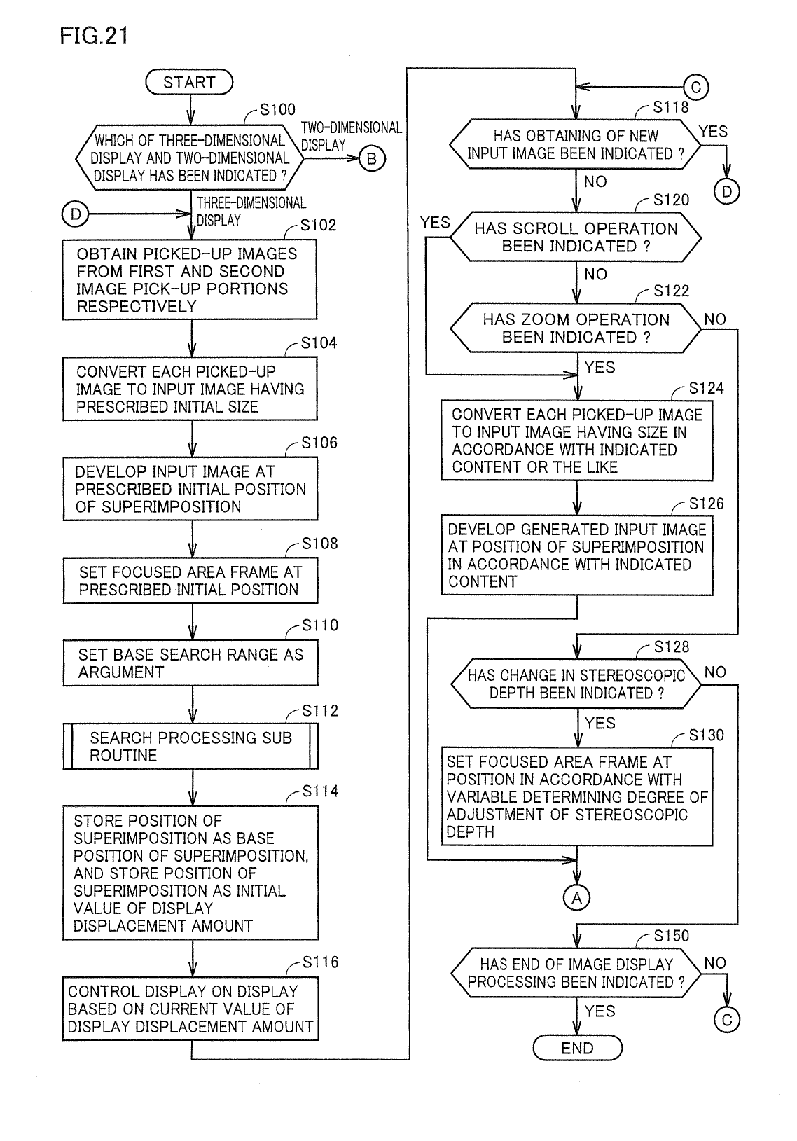

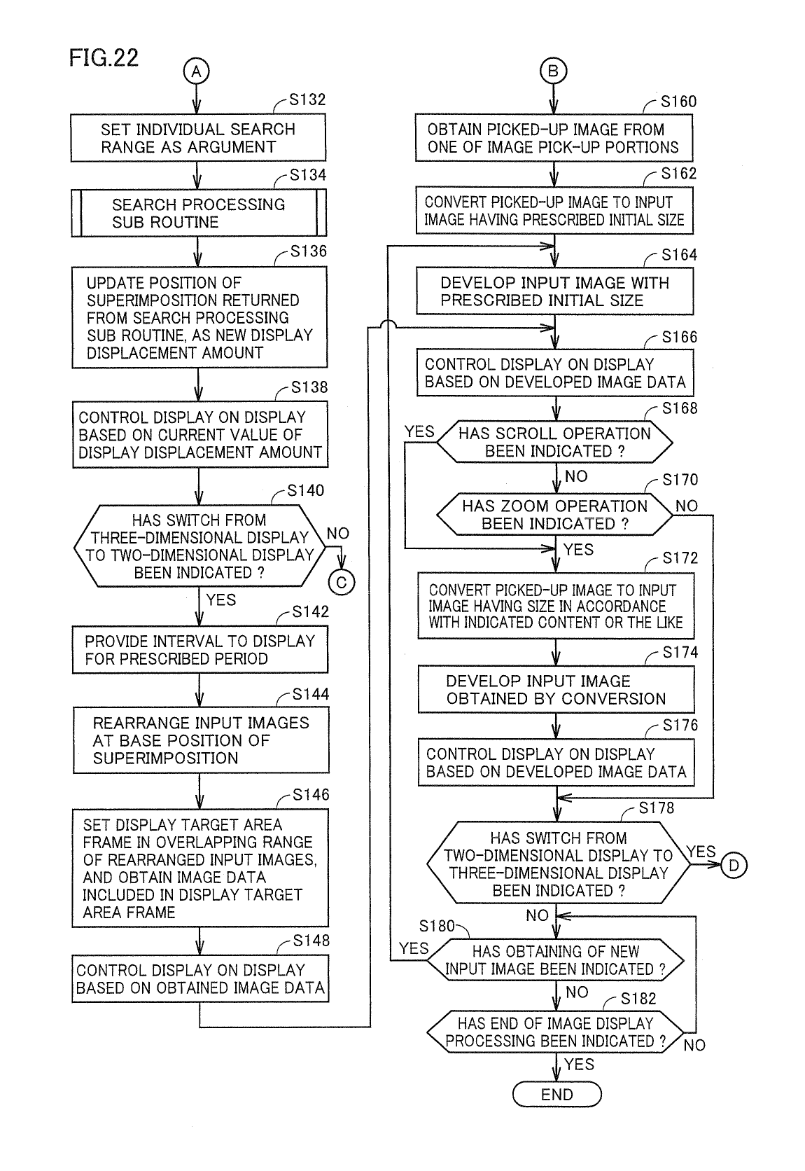

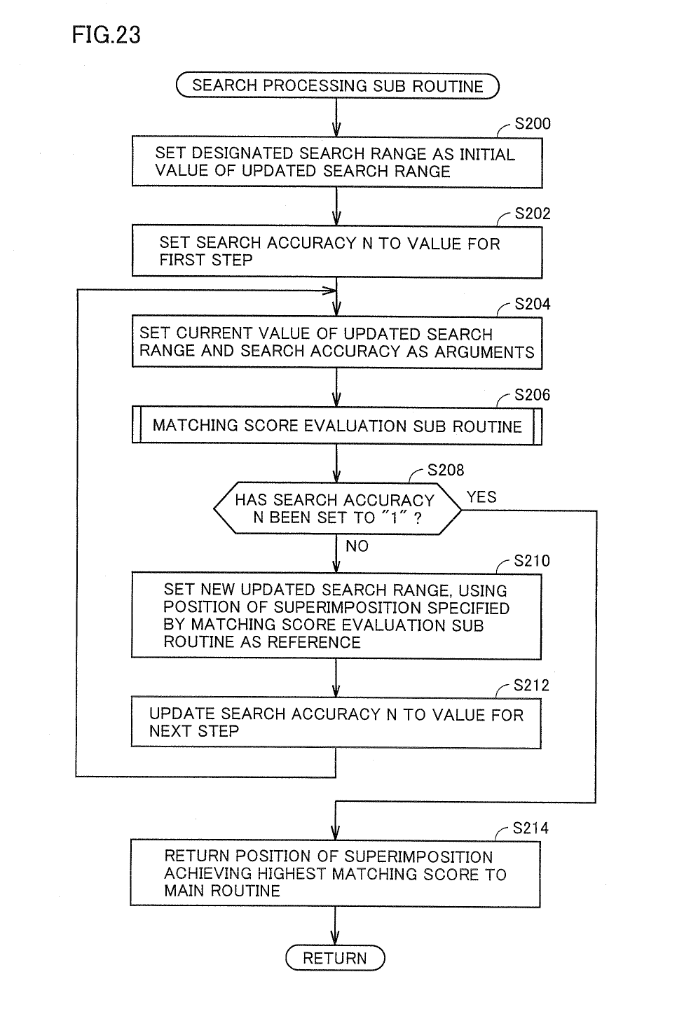

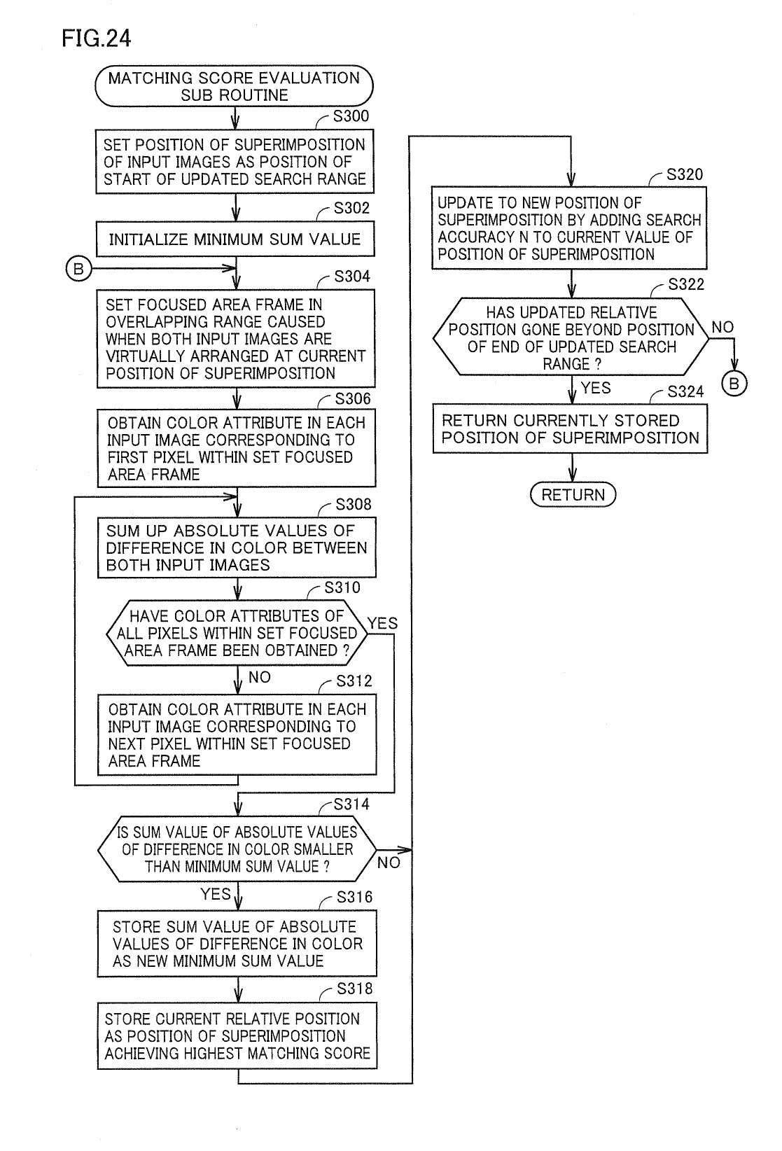

FIGS. 21 and 22 are a flowchart showing an entire processing procedure of image display control in information processing system 1 according to the first embodiment of the present invention. FIG. 23 is a flowchart showing processing in a search processing sub routine shown in FIG. 21. FIG. 24 is a flowchart showing processing in a matching score evaluation sub routine shown in FIG. 23. Each step shown in FIGS. 21 to 24 is typically provided by execution of a program by CPU 100 of information processing system 1.

Main Routine:

Referring to FIGS. 21 and 22, when start of image display processing has been indicated, CPU 100 determines in step S100 which of three-dimensional display and two-dimensional display has been indicated. Specifically, CPU 100 determines whether a slider (FIGS. 12 to 14) that is a typical example of input portion 106 (FIG. 1) is located at the position for three-dimensional display. When three-dimensional display has been indicated (“three-dimensional display” in step S100), the process proceeds to step S102. In contrast, when two-dimensional display has been indicated, namely the slider is located at the position where the stereoscopic depth is made zero (“two-dimensional display” in step S100), the process proceeds to step S160.

In step S102, CPU 100 obtains picked-up images from first image pick-up portion 110 and second image pick-up portion 120 respectively. Namely, CPU 100 causes first image pick-up portion 110 and second image pick-up portion 120 to pick up an image and causes RAM 104 (corresponding to first image buffer 202 and second image buffer 212 in FIG. 11) to store image data obtained thereby. In subsequent step S104, CPU 100 converts the respective picked-up images to input images IMG1 and IMG2 each having a prescribed initial size. In further subsequent step S106, CPU 100 develops input images IMG1 and IMG2 in RAM 104 (corresponding to image development unit 220 in FIG. 11) at a prescribed initial position of superimposition. In further subsequent step S108, CPU 100 sets focused area frame FW, which is the determination area, at a prescribed initial position.

Thereafter, CPU 100 performs the processing for determining a base position of superimposition shown in steps S110 to S114. Namely, in step S110, CPU 100 sets a base search range as an argument. In subsequent step S112, search processing is performed based on the base search range set in step S110. Namely, the base search range set in step S110 is passed as the argument to a search processing sub routine shown in FIG. 23. As a result of this search processing sub routine, information on the position of superimposition achieving the highest matching score is returned to a main routine. In further subsequent step S114, CPU 100 causes the position of superimposition returned from the search processing sub routine to be stored as the base position of superimposition and causes the position of superimposition to be stored as an initial value of the display displacement amount. Thereafter, the process proceeds to step S116.

In step S116, CPU 100 controls display on display 10 based on a current value of the display displacement amount. Namely, CPU 100 displaces the image data of input images IMG1 and IMG2 developed in RAM 104 by a coordinate in accordance with the current value of the display displacement amount and writes the image data in first VRAM 112 and second VRAM 122, respectively. Then, the process proceeds to step S118.

In step S118, CPU 100 determines whether obtaining of a new input image has been indicated or not. When obtaining of a new input image has been indicated (YES in step S118), the processing is repeated from step S102. Namely, the base position of superimposition is determined or updated in response to input of a new input image (picked-up image). Otherwise (NO in step S118), the process proceeds to step S120. Input of this new input image means update of at least one of input image IMG1 and input image IMG2.

Here, a user's indication of determination or update of the base position of superimposition may directly be received. In this case, CPU 100 starts processing from step S110 in response to the user's operation and thus the base position of superimposition is determined or updated.

In step S120, CPU 100 determines whether a scroll operation has been indicated or not. When the scroll operation has been indicated (YES in step S120), the process proceeds to step S124. Otherwise (NO in step S120), the process proceeds to step S122.

In step S122, CPU 100 determines whether a zoom operation has been indicated or not. When the zoom operation has been indicated (YES in step S122), the process proceeds to step S124. Otherwise (NO in step S122), the process proceeds to step S128.

In step S124, CPU 100 converts the picked-up images stored in RAM 104 into input images IMG1 and IMG2 having a size in accordance with contents (a zoom-in/zoom-out ratio or a scroll amount) or the like indicated in step S120 or S122. Here, in a case where the base position of superimposition is defined by a pixel unit or the like, in accordance with a ratio of size change of the input image, a value of the base position of superimposition is also updated at the same ratio.

In subsequent step S126, CPU 100 develops newly generated input images IMG1 and IMG2 in RAM 104 at a position of superimposition in accordance with the contents (a zoom-in/zoom-out ratio or a scroll amount) indicated in step S120 or S122. Then, the process proceeds to step S132.

Meanwhile, in step S128, CPU 100 determines whether change of the stereoscopic depth to be generated by display 10 has been indicated or not. Specifically, CPU 100 determines whether the position of the slider (FIGS. 12 to 14) which is a typical example of input portion 106 (FIG. 1) has been changed. When change of the stereoscopic depth through change of the display position (adjustment of stereoscopic depth by display position) has been indicated (YES in step S128), the process proceeds to step S130. In contrast, when change of the stereoscopic depth (adjustment of stereoscopic depth by display position) has not been indicated (NO in step S128), the process proceeds to step S150.

In step S130, CPU 100 sets focused area frame FW at a position in accordance with a variable that determines the degree of adjustment of the stereoscopic depth by the display position as indicated in step S128 (the variable is typically a value corresponding to an amount of displacement of the slider). Namely, in order that the contents included in this focused area frame FW may be three-dimensionally displayed at the position of the display surface of display 10, the above-described image matching processing is performed. Therefore, following the degree of adjustment to be made to the stereoscopic depth as indicated by a user, this focused area frame FW is appropriately disposed to enable the stereoscopic depth to be changed in response to the user's operation (the stereoscopic depth can be adjusted by the display position). Then, the process proceeds to step S132.

In steps S132 to S138, CPU 100 performs the processing for determining a display displacement amount. Namely, in step S132, CPU 100 sets an individual search range as the argument. More specifically, CPU 100 determines as the individual search range, a range corresponding to a length obtained by multiplying a length of a corresponding side of input image IMG1, IMG2 by a prescribed ratio, in a prescribed direction (in the example shown in FIGS. 20A to 20D, the Y direction) with the base position of superimposition serving as the center. The individual search range narrower than the base search range is thus set as the search range.

In subsequent step S134, the search processing is performed based on the individual search range set in step S132. Namely, using the individual search range set in step S132 as the argument, the search processing sub routine shown in FIG. 23 is performed. Information on the position of superimposition achieving the highest matching score as a result of this search processing sub routine is returned to the main routine. In further subsequent step S136, CPU 100 updates the position of superimposition returned from the search processing sub routine as a new display displacement amount. In further subsequent step S138, CPU 100 controls display on display 10 based on the current value of the display displacement amount. Namely, CPU 100 displaces image data of input images IMG1 and IMG2 developed by RAM 104 by a coordinate according to the current value of the display displacement amount, and writes the resultant image data in first VRAM 112 and second VRAM 122, respectively. Then, the process proceeds to step 140.

In step S140, CPU 100 determines whether switch from three-dimensional display to two-dimensional display has been indicated or not. Specifically, CPU 100 determines whether the slider (FIGS. 12 to 14) which is a typical example of input portion 106 (FIG. 1) has been moved to the position of two-dimensional display (2D). When switch from three-dimensional display to two-dimensional display has been indicated (YES in step S140), the process proceeds to step S142. In contrast, when switch from three-dimensional display to two-dimensional display has not been indicated (NO in step S140), the processing is repeated from step S118.

In steps S142 to S148, CPU 100 performs processing for making a switch from three-dimensional display to two-dimensional display. Namely, in step S142, CPU 100 provides an interval to display 10 for a prescribed period. Specifically, CPU 100 causes (i) substantial stoppage of display on display 10, (ii) display of an independent insert image, (iii) display of a predetermined effect, or the like. In subsequent step S144, CPU 100 re-arranges input images IMG1 and IMG2 at the base position of superimposition in RAM 104 (corresponding to image development unit 220 in FIG. 11). In further subsequent step S146, CPU 100 sets a display target area frame in an overlapping range of input images IMG1 and IMG2 re-arranged in step S144, and obtains image data included in this display target area frame. In further subsequent step S148, CPU 100 controls display on display 10, based on the image data obtained in step S146. Namely, CPU 100 writes the common image data obtained in step S146 in each of first VRAM 112 and second VRAM 122. Then, the process proceeds to step S166.

As described above, contents of three-dimensional display on display 10 are updated in step S138, and then the processing for making a switch from three-dimensional display to two-dimensional display in steps S142 to S148 is performed. Namely, when a reference depth position (stereoscopic depth) to be visually perceived by a user satisfies a prescribed condition, the processing for making a switch from three-dimensional display to two-dimensional display is performed.

Further, immediately after three-dimensional display is switched to two-dimensional display through the processing shown in steps S146 and S148, display 10 presents a first partial image (first display data) or second partial image (second display data) obtained when the position of superimposition of input image IMG1 and input image IMG2 is caused to substantially match the base position of superimposition which is determined based on the correspondence between input image IMG1 and input image IMG2. It is noted that the first partial image and the second partial image may be synthesized into one image and the resultant image produced by the synthesis may be displayed on display 10.

Meanwhile, in step S150, CPU 100 determines whether end of the image display processing has been indicated or not. When end of the image display processing has been indicated (YES in step S150), the process ends. Otherwise (NO in step S150), the processing is repeated from step S118.

In contrast, when two-dimensional display is indicated (“two-dimensional display” in step S100), the process proceeds to step S160 in which CPU 100 obtains a picked-up image from one of first image pick-up portion 110 and second image pick-up portion 120. Namely, CPU 100 causes one of first image pick-up portion 110 and second image pick-up portion 120 to pick up an image, and stores image data obtained therefrom in RAM 104. In subsequent step S162, CPU 100 converts the obtained picked-up image into input image IMG1 having a prescribed initial size. In further subsequent step S164, CPU 100 develops input image IMG1 with a prescribed initial size in RAM 104 (corresponding to image development unit 220 in FIG. 11). In further subsequent step S166, CPU 100 controls display on display 10, based on the image data developed in step S164. Namely, CPU 100 extracts a part or the whole of input image IMG1 developed in RAM 104 as common display data, and writes the display data in each of first VRAM 112 and second VRAM 122. Then, the process proceeds to step S168.

In step S168, CPU 100 determines whether a scroll operation has been indicated or not. When the scroll operation has been indicated (YES in step S168), the process proceeds to step S172. Otherwise (NO in step S168), the process proceeds to step S170.

In step S170, CPU 100 determines whether a zoom operation has been indicated or not. When the zoom operation has been indicated (YES in step S170), the process proceeds to step S172. Otherwise (NO in step S170), the process proceeds to step S178.

In step S172, CPU 100 converts the picked-up image stored in RAM 104 into input image IMG1 having a size in accordance with the details given in step S170 or S172 (a zoom-in/zoom-out ratio or scroll amount) or the like. In subsequent step S174, CPU 100 develops, in RAM 104, input image IMG1 generated by the conversion. In further subsequent step S176, CPU 100 controls display on display 10 based on the image data developed in step S174. Namely, CPU 100 extracts, as common display data, a part or the whole of input image IMG1 developed in RAM 104, and writes the data in each of first VRAM 112 and second VRAM 122. Then, the process proceeds to step S178.

In step S178, CPU 100 determines whether switch from two-dimensional display to three-dimensional display has been indicated or not. Specifically, CPU 100 determines whether the slider (FIGS. 12 to 14) which is a typical example of input portion 106 (FIG. 1) has been moved to the position for three-dimensional display. When switch from the two-dimensional display to the three-dimensional display has been indicated (YES in step S178), the processing is repeated from step S102. In contrast, when switch from two-dimensional display to three-dimensional display has not been indicated (NO in step S178), the process proceeds to step S180.

In step S180, CPU 100 determines whether obtaining of a new input image has been indicated or not. When obtaining of a new input image has been indicated (YES in step S180), the processing is repeated from step S164. Input of this new input image means that the input image is updated. Otherwise (NO in step S180), the process proceeds to step S182.

In step S182, CPU 100 determines whether end of the image display processing has been indicated or not. When end of the image display processing has been indicated (YES in step S182), the process ends. Otherwise (NO in step S182), the processing is repeated from step S180.

Search Processing Sub Routine:

Referring to FIG. 23, initially, in step S200, CPU 100 sets the search range (the base search range or the individual search range) set as the argument, as an initial value of an updated search range. This updated search range represents a variant for narrowing a substantial search range in performing search processing in a plurality of steps as shown in FIGS. 17A, 17B, 18A, 18B, 19A, and 19B. In subsequent step S202, CPU 100 sets search accuracy N to a value in the first step (in the example described above, 16 pixels). Then, the process proceeds to step S204.

In step S204, CPU 100 sets a current value of the updated search range and the search accuracy as the arguments. In subsequent step S206, CPU 100 performs a matching score evaluation sub routine shown in FIG. 24, based on the updated search range and the search accuracy set in step S204. In this matching score evaluation sub routine, a matching score at each position of superimposition included in the updated search range is evaluated, and the position of superimposition achieving the highest matching score in the updated search range is specified. Information on the position of superimposition achieving the highest matching score in the updated search range as a result of this matching score evaluation sub routine is returned.

In subsequent step S208, CPU 100 determines whether search accuracy N is set to “1” or not. Namely, CPU 100 determines whether the current value of search accuracy N is set to a value in the final step or not. When search accuracy N is set to “1” (YES in step S208), the process proceeds to step S214. Otherwise (NO in step S208), the process proceeds to step S210.

In step S210, CPU 100 sets, using the position of superimposition specified in the matching score evaluation sub routine performed in immediately preceding step S208 as the reference, a range of the position of superimposition±N (or a range of {relative displacement amount−(N−1)) to (relative displacement amount+N}) as a new updated search range. Namely, CPU 100 updates the updated search range in accordance with a result of the performed matching score evaluation sub routine. In subsequent step S212, search accuracy N is updated to a value in the next step. In the example described above, new search accuracy N is calculated by dividing the current value of search accuracy N by “4”. Then, the processing is repeated from step S204.

Meanwhile, in step S214, the position of superimposition achieving the highest matching score, which has been specified in the immediately preceding matching score evaluation sub routine, is returned to the main routine. Then, the processing in the sub routine ends.

Matching Score Evaluation Sub Routine:

Referring to FIG. 24, initially, in step S300, CPU 100 sets a position of superimposition of input image IMG1 and input image IMG2 as a position of start of the updated search range. Namely, CPU 100 virtually arranges input image IMG1 and input image IMG2 at a first position of superimposition present in the updated search range. In subsequent step S302, CPU 100 initializes a minimum sum value. This minimum sum value is a criterion value used for specifying a position of superimposition achieving the highest matching score which will be described later. In the processing which will be described later, a matching score is evaluated based on a sum value as to difference in color between corresponding pixels. Therefore, a smaller sum value means a higher matching score. Thus, in consideration of a dynamic range or the like of a color attribute, a value exceeding a maximum value that can be calculated is set as an initial value of the minimum sum value. Then, the process proceeds to step S304.

In step S304, focused area frame FW is set in an overlapping range created when input image IMG1 and input image IMG2 are virtually arranged at the current value of the position of superimposition. Then, the process proceeds to step S306.

In step S306, CPU 100 obtains a color attribute in each of input image IMG1 and input image IMG2, corresponding to the first pixel within set focused area frame FW. In subsequent step S308, CPU 100 sums up absolute values of difference in color between the input images, based on the obtained color attributes. In further subsequent step S310, CPU 100 determines whether the color attributes of all pixels within set focused area frame FW have been obtained or not. When the color attributes of all pixels within focused area frame FW have been obtained (YES in step S310), the process proceeds to step S314. Otherwise (NO in step S310), the process proceeds to step S312.

In step S312, CPU 100 obtains a color attribute of each of input image IMG1 and input image IMG2 corresponding to the next pixel within set focused area frame FW. Then, the processing is repeated from step S308.

Meanwhile, in step S314, CPU 100 determines whether a sum value of the absolute values of the difference in color is smaller than the minimum sum value (the current value) or not. Namely, CPU 100 determines whether the matching score at the current value of the position of superimposition is higher than the previously evaluated other positions of superimposition or not. When the sum value of the absolute values of the difference in color is smaller than the minimum sum value (YES in step S314), the process proceeds to step S316. Otherwise (NO in step S314), the process proceeds to step S320.

In step S316, CPU 100 causes the sum value of the absolute values of the difference in color calculated immediately before to be stored as a new minimum sum value. In subsequent step S318, CPU 100 causes the current value of the position of superimposition to be stored as the position of superimposition achieving the highest matching score. Then, the process proceeds to step S320.

In step S320, CPU 100 updates the current value of the position of superimposition to a new position of superimposition by adding search accuracy N to the current value of the position of superimposition. Namely, CPU 100 virtually arranges input image IMG1 and input image IMG2 at a position of superimposition separated from the current value of the position of superimposition by search accuracy (N pixel(s)). As the position of superimposition should be changed in both of the X direction and the Y direction in the base search range, the position of superimposition is updated in a prescribed scanning order in this case.

In subsequent step S322, CPU 100 determines whether the updated position of superimposition has gone beyond a position of end of the updated search range or not. Namely, CPU 100 determines whether search processing over the designated updated search range has been completed or not. When the updated position of superimposition has gone beyond the position of end of the updated search range (YES in step S322), the process proceeds to step S324. Otherwise (NO in step S322), the processing is repeated from step S304.

In step S324, CPU 100 returns the currently stored position of superimposition (that is, the position of superimposition finally achieving the highest matching score in the sub routine) to the search processing sub routine. Then, the processing in the sub routine ends.

### Modification of First Embodiment

The above-described first embodiment provides an example of processing performed, in response to a user's instruction to change the stereoscopic depth by change of the display position (adjustment of stereoscopic depth by display position), so that the position where focused area frame FW is set is also changed following this instruction. Alternatively, a user may set focused area frame FW at an arbitrary area. In this case, when switch from three-dimensional display to two-dimensional display is requested, preferably two-dimensional display is generated after the stereoscopic depth is adjusted by the display position so that the contents included in focused area frame FW seem to be located near the display surface of display 10, for the reason as follows. Since a user may be regarded as giving attention to an object in focused area frame FW having been set, the display position of the object receiving attention is maintained as much as possible even when this object is two-dimensionally displayed, namely the contents displayed on the display screen are maintained as much as possible, to enable more natural switch from three-dimensional display to two-dimensional display.

The configuration or the like of an information processing system according to the present modification is similar to that of information processing system 1 according to the above-described first embodiment, and the detailed description thereof will not be repeated. In the following, mainly differences from the above-described first embodiment will be described, concerning processing executed by the information processing system in the present embodiment.

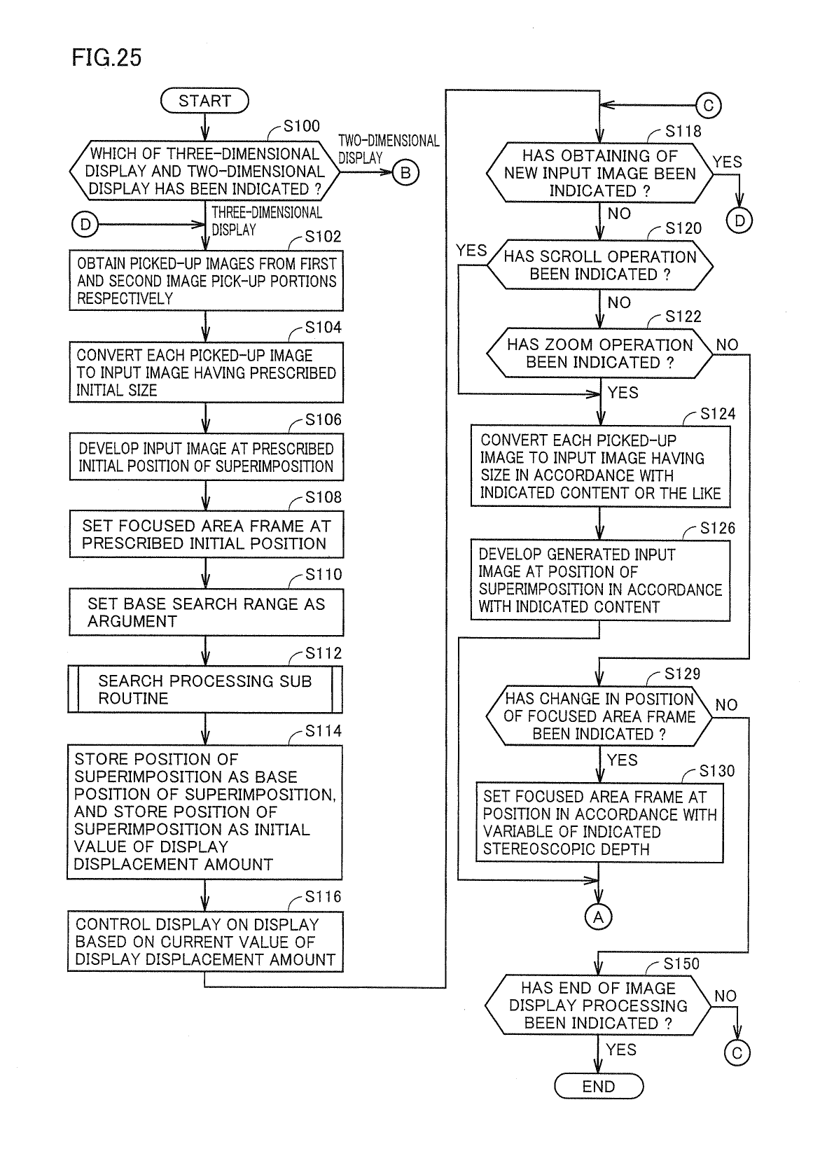

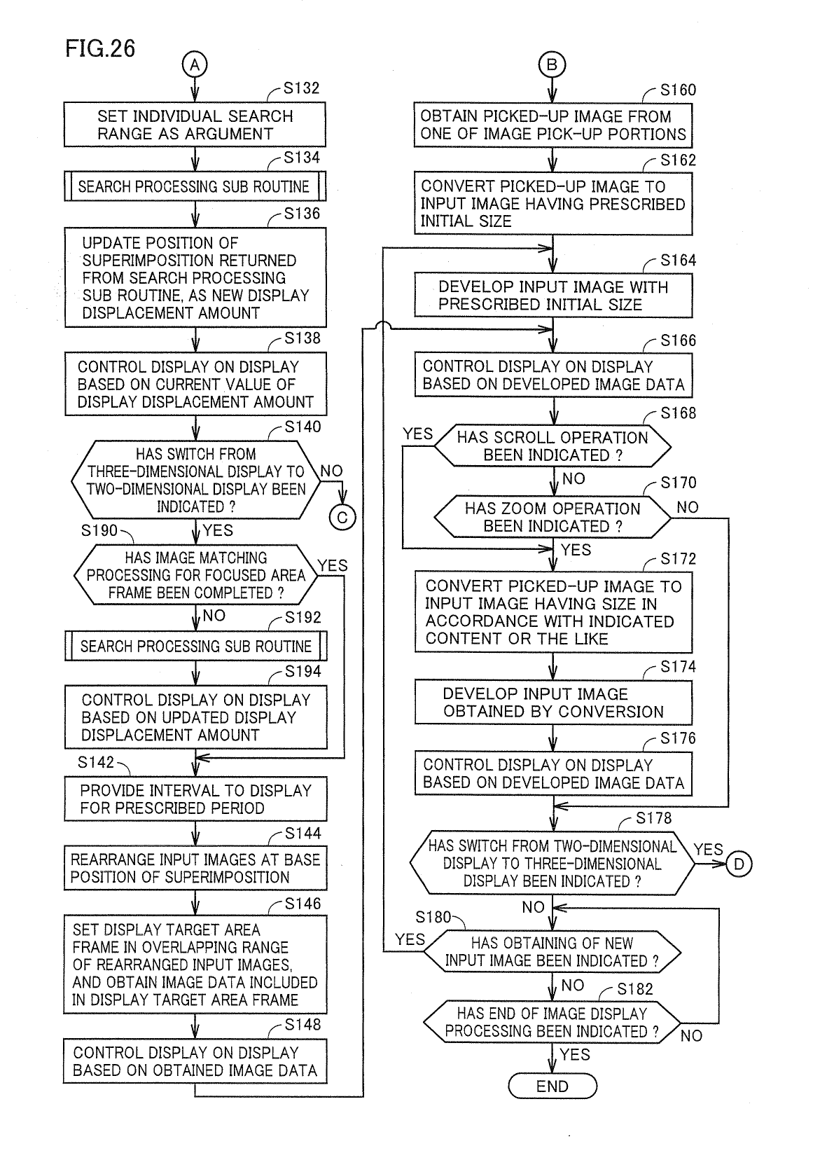

FIGS. 25 and 26 are a flowchart showing an entire processing procedure of image display control by the information processing system according to a first modification of the first embodiment of the present invention. Each step shown in FIGS. 25 and 26 is typically provided by execution of a program by CPU 100 of information processing system 1.

The flowchart shown in FIGS. 25 and 26 differs from the flowchart shown in FIGS. 21 and 22 in that processing in step S129 is performed instead of the processing in step S128 and that processing in steps S190 to S194 is performed between step S140 and step S142.

Specifically, when no zoom operation has been indicated in step S122 (NO in step S122), CPU 100 determines whether change of the position of focused area frame FW has been indicated or not (step S129). When change of the position of focused area frame FW has been indicated (YES in step S129), the process proceeds to step S130. Otherwise (NO in step S129), the process proceeds to step S150.

The change of the position of focused area frame FW is preferably indicated, for user friendliness sake, in such a manner that an operation of touching an image displayed on the display surface of display 10 for example is accepted. It is noted that, since the display surface of display 10 is provided with a parallax barrier 12, such a touch panel device is preferably optical or ultrasonic device.

In step S140, when switch from three-dimensional display to two-dimensional display has been indicated (YES in step S140), CPU 100 determines whether image matching processing for focused area frame FW has been completed (step S190). When image matching processing for focused area frame FW has not been completed (NO in step S190), the process proceeds to step S192. Otherwise (YES in step S190), the process proceeds to step S142.

In step S192, CPU 100 performs search processing. Namely, the individual search range having been set is used as an argument and the search processing sub routine shown in FIG. 23 is performed. Information about the position of superimposition achieving the highest matching score that is obtained from the result of this search processing sub routine is returned to the main routine. In further subsequent step S194, CPU 100 updates the position of superimposition returned from the search processing sub routine as a new display displacement amount. Then, based on the updated display displacement amount, CPU 100 controls display on display 10. Namely, CPU 100 displaces image data of input images IMG1 and IMG2 developed by RAM 104 by a coordinate corresponding to the current value of the display displacement amount, and writes the resultant data in each of first VRAM 112 and second VRAM 122. Then, the process proceeds to step S142.

Specifically, when the position of focused area frame FW is changed, for example, when a user sets focused area frame FW at an arbitrary area, the contents included in focused area frame FW, which may in some cases seem to be located away from the display surface of display 10, are adjusted so that the contents seem to be located near the display surface of display 10, and then switch is made from three-dimensional display to two-dimensional display. Namely, only when the visually perceived reference depth position (stereoscopic depth) satisfies a prescribed condition, switch from three-dimensional display to two-dimensional display is permitted. Such processing as described above can be employed to provide a perceived natural switch from three-dimensional display to two-dimensional display.

Details of other steps have been described above, and the detailed description will not be repeated.

### Second Embodiment

The above-described first embodiment and the modification thereof chiefly provide an example of the configuration to provide three-dimensional display using a pair of input images (stereo images) having a prescribed certain parallax. Meanwhile, the art of computer graphics such as polygon generation can be used to dynamically generate image data with a virtual camera disposed at an arbitrary position. In other words, a pair of input images having a parallax which is successively changed can be generated. Therefore, the stereoscopic depth can be successively changed through adjustment of the stereoscopic depth by the camera position.

In connection with a second embodiment of the present invention, a description will be given of an information processing system capable of providing three-dimensional display using a pair of input images having a certain parallax (static mode), as described above in connection with the first embodiment, and also capable of providing three-dimensional display using a pair of input images having a successively variable parallax (dynamic mode). Namely, the information processing system in the second embodiment can manage both modes of three-dimensional display, and makes a switch to one of the modes in response to user's operation or automatically. The following description is mainly directed to an operation in the dynamic mode.

Device Configuration

The internal configuration of an information processing system 2 according to the second embodiment of the present invention is similar to that of information processing system 1 according to the first embodiment illustrated in above-described FIG. 1, and the detailed description thereof will not be repeated.

Control Structure

A control structure for providing image display processing according to the present embodiment will now be described.

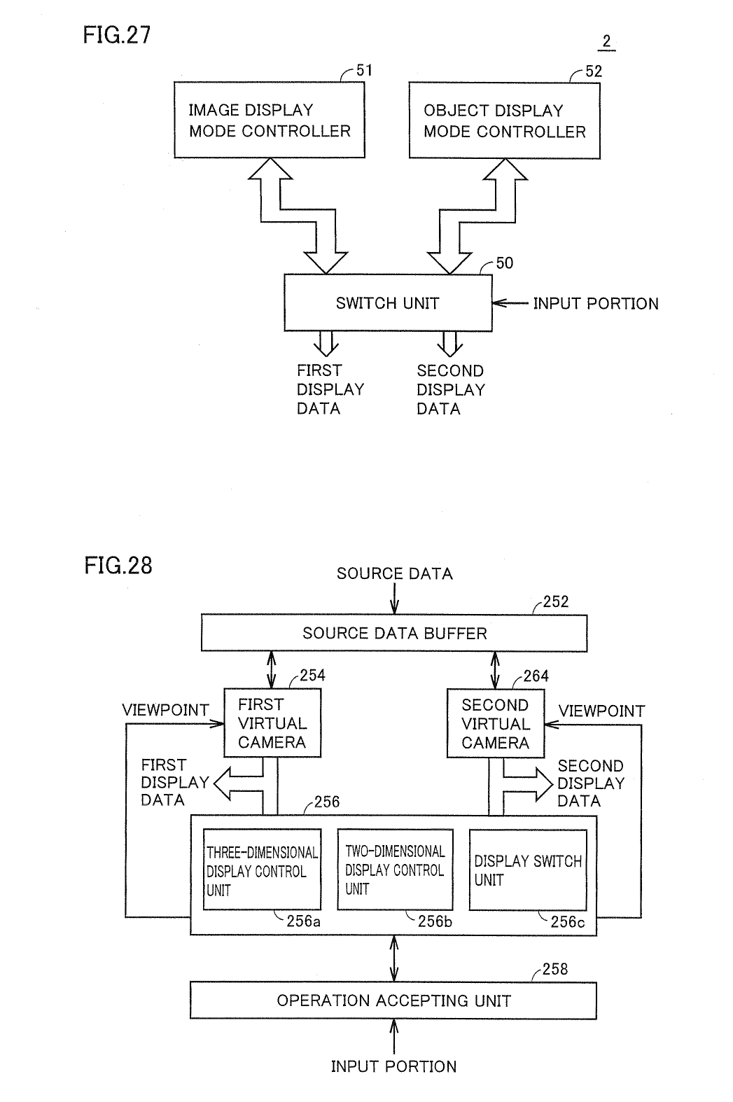

Referring to FIG. 27, information processing system 2 includes, as its control structure, a switch unit 50, an image display mode controller 51, and an object display mode controller 52.

Image display mode controller 51 provides three-dimensional display using a pair of input images having a prescribed certain parallax, similarly to the above-described first embodiment. Namely, image display mode controller 51 includes image input means for accepting a pair of input images having a prescribed parallax, and provides three-dimensional display of an object on display 10 based on the accepted pair of input images. Image display mode controller 51 can also provide two-dimensional display of an object included in an input image, using at least one of the input images of the pair used for three-dimensional display. More detailed functional blocks of image display mode controller 51 are similar to those in the functional block diagram of information processing system 1 shown in above-described FIG. 11, and the detailed description will not be repeated.

Object display mode controller 52 provides three-dimensional display using a pair of input images obtained by picking up an image of an object on a virtual space by means of a pair of virtual cameras. More specifically, object display mode controller 52 adjusts a parallax of a pair of input images generated, by successively changing the relative distance between the virtual cameras of the pair. In this way, the stereoscopic depth is adjusted by the camera position, for an object displayed on display 10, and the stereoscopic depth is freely changed.

Here, the stereoscopic depth is adjusted by means of above-described slider 1062. Namely, for the information processing system in the second embodiment in the static mode, a user can use slider 1062 as described above to adjust the stereoscopic depth by adjusting the above-described relative displacement amount and thereby setting the display displacement, similarly to the first embodiment (adjustment of stereoscopic depth by display position). Further, in the dynamic mode, a user can use the same slider 1062 to adjust the stereoscopic depth by adjusting the relative distance between virtual cameras (adjustment of stereoscopic depth by camera position).

Referring to FIG. 28, object display mode controller 52 includes a source data buffer 252, a first virtual camera 254, a second virtual camera 264, a control unit 256, and an operation accepting unit 258.

Control unit 256 generally controls image display by display 10. More specifically, control unit 256 includes: a three-dimensional display control unit 256a for controlling display 10 so that input images IMG1 and IMG2 that are respectively generated by first virtual camera 254 and second virtual camera 264 as described later are used to provide three-dimensional display of an object included in the images; a two-dimensional display control unit 256b for controlling display 10 so that an input image generated by first virtual camera 254 or second virtual camera 264 is used to provide two-dimensional display of an object included in the image; and a display switch unit 256c for making a switch between three-dimensional display and two-dimensional display of display 10.

In response to an instruction from display switch unit 256c, one of three-dimensional display control unit 256a and two-dimensional display control unit 256b is activated.

In the object display mode according to the present embodiment, as described later, the stereoscopic depth can be successively changed through adjustment of the stereoscopic depth by the camera position. Therefore, when three-dimensional display is switched to two-dimensional display, the stereoscopic depth is not suddenly lost. Therefore, in principle, display switch unit 256c does not provide an interval like the one described above in connection with the first embodiment. It should be noted that, an interval is still provided only when a prescribed condition is satisfied, such as a condition that a user adjusts the stereoscopic depth by means of the camera position to considerably decrease the stereoscopic depth.

Source data buffer 252 temporarily stores source data that is data for defining an object on a virtual space from an application or the like executed by information processing system 2. Source data buffer 252 also accepts access from first virtual camera 254 and second virtual camera 264.

First virtual camera 254 takes a picture of an object on a virtual space that is defined by the source data stored in source data buffer 252, and accordingly generates input image IMG1. Likewise, second virtual camera 264 takes a picture of an object on a virtual space defined by source data stored in source data buffer 252, and accordingly generates input image IMG2. More specifically, first virtual camera 254 and second virtual camera 264 use, as reference, respective viewpoints following an instruction from three-dimensional display control unit 256a, and perform rendering for an object or the like on the virtual space and thereby generate input images IMG1 and IMG2, respectively. Input images IMG1 and IMG2 at this time are used for generating three-dimensional display on display 10. It is noted that three-dimensional display control unit 256a sets respective viewpoints of first virtual camera 254 and second virtual camera 264, namely the relative distance between first virtual camera 254 and second virtual camera 264, to a value in accordance with a requirement of three-dimensional display (stereoscopic depth).

Input image IMG1 generated by first virtual camera 254 is output as first display data, and input image IMG2 generated by second virtual camera 264 is output as second display data. Namely, three-dimensional display control unit 256a functions as output means for outputting input images IMG1 and IMG2 to display 10.

In contrast, when display 10 is to provide two-dimensional display of an object, display switch unit 256c indicates the same viewpoint position to first virtual camera 254 and second virtual camera 264. Namely, when display 10 is to provide two-dimensional display, first virtual camera 254 and second virtual camera 264 generate respective input images IMG1 and IMG2 that are both based on the same viewpoint. Therefore, the parallax between input image IMG1 and input image IMG2 is zero. Thus, the same input images are generated from input images IMG1 and IMG2, and the input images are output as first display data and second display data.

Referring again to FIG. 27, in response to a user's operation or a request from an executed application, switch unit 50 activates one of image display mode controller 51 and object display mode controller 52. In the following description, processing for providing three-dimensional display by means of a pair of input images having a fixed parallax (processing for static mode) is also referred to as “image display mode”, and processing for providing three-dimensional display by means of a pair of input images having a variable parallax (processing for dynamic mode) is also referred to as “object display mode. “Image display mode” may also be applied, not only to images obtained by means of a pair of image pick-up portions, but also to images generated by taking a picture of an object on a virtual space by means of a pair of virtual cameras. Further, “object display mode” is also applicable, not only to images obtained by taking a picture of an object on a virtual space by means of a pair of virtual cameras, but also to images obtained by taking a picture with a pair of image pick-up portions for which the relative distance therebetween can be successively changed.

Typically, in “image display mode”, a pair of picked-up images generated by first image pick-up portion 110 and second image pick-up portion 120 as shown in FIG. 11 is set as a pair of input images IMG1 and IMG2. In contrast, in “object display mode”, a pair of images generated by first virtual camera 254 and second virtual camera 264 as shown in FIG. 28 is set as a pair of input images IMG1 and IMG2.

3D Display Processing and 2D Display Processing

Next, details of display processing in the object display mode of the present embodiment will be described.

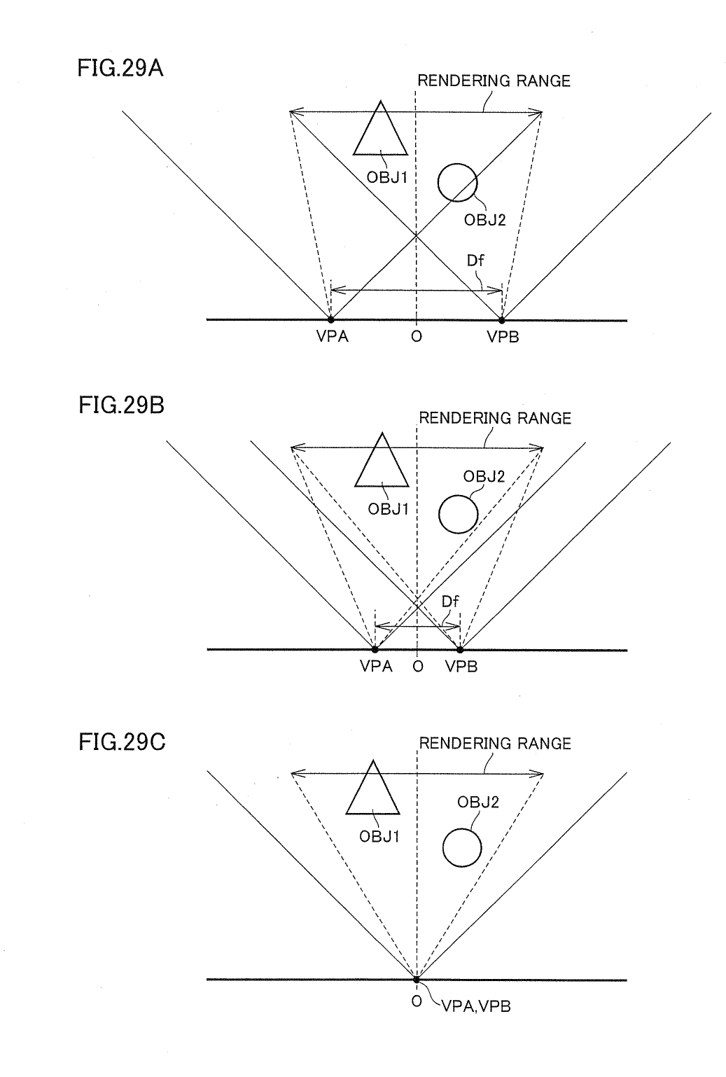

Referring to FIG. 29A, in the object display mode of the present embodiment, two virtual cameras are used for an object arranged on a virtual space to generate a pair of input images. Typically, it is supposed that the virtual cameras are arranged, on a line extending through a reference point O, at respective viewpoints VPA and VPB that are separated by the same interval from reference point O. Supposing that respective fields of view of the virtual cameras are identical, the images generated respectively by the virtual cameras taking a picture of the object have a parallax depending on a relative distance Df between the two virtual cameras.

For the purpose of lessening the processing load on generation of images, preferably only an image within an actually used range (rendering range) in the field of view of each virtual camera is generated (the range indicated by the broken line in FIGS. 29A to 29C).

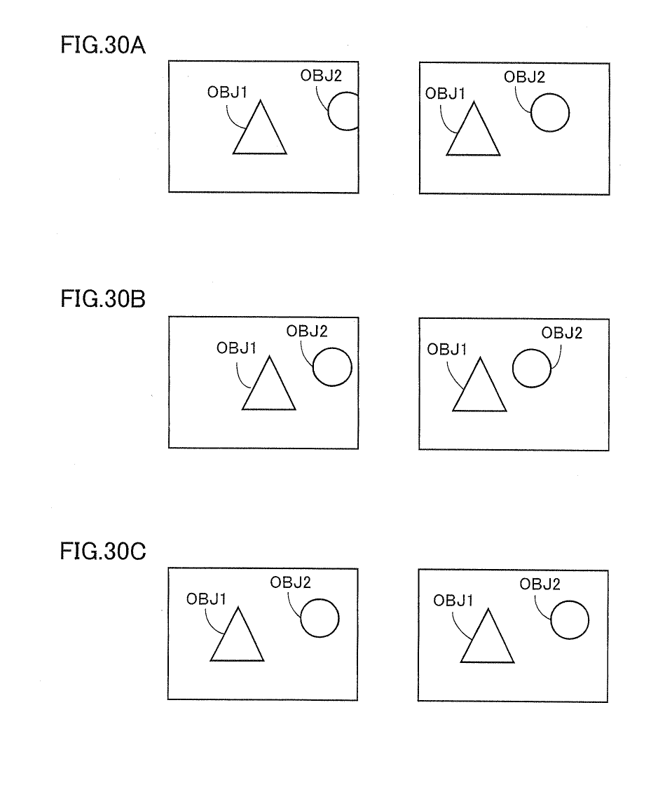

An example of input images generated based on the objects on a virtual space and the positional relation between the virtual cameras as shown in FIG. 29A is shown in FIG. 30A.

It is supposed next that relative distance Df between the two virtual cameras is decreased as shown in FIG. 29B. In this case, the distance from reference point O to viewpoint VPA and that to viewpoint VPB are each shortened. Here, the distance from reference point O to viewpoint VPA and the distance from reference point O to viewpoint VPB are made equal.

In the state shown in FIG. 29B, the parallax between paired input images generated by the two virtual cameras is smaller than the parallax between paired input images generated in the state shown in FIG. 29A. For example, a pair of input images generated based on the objects on a virtual space and the positional relation between the virtual cameras as shown in FIG. 29B is the one shown in FIG. 30B. As compared with the degree of positional displacement between respective objects appearing in respective input images of the pair shown in FIG. 30A, it is seen that the degree of positional displacement between respective objects appearing in respective input images of the pair shown in FIG. 30B is smaller.

It is also supposed that relative distance Df between the two virtual cameras is made zero as shown in FIG. 29C. In this case, viewpoint VPA and viewpoint VPB are located at the same position (reference point O), and therefore, input images generated respectively by the two virtual cameras are identical to each other. For example, a pair of input images generated based on the objects on a virtual space and the positional relation between the virtual cameras as shown in FIG. 29C is the one as shown in FIG. 30C. It is seen that, in the pair of input images shown in FIG. 30C, the same object appears at the same position in each of the input images.

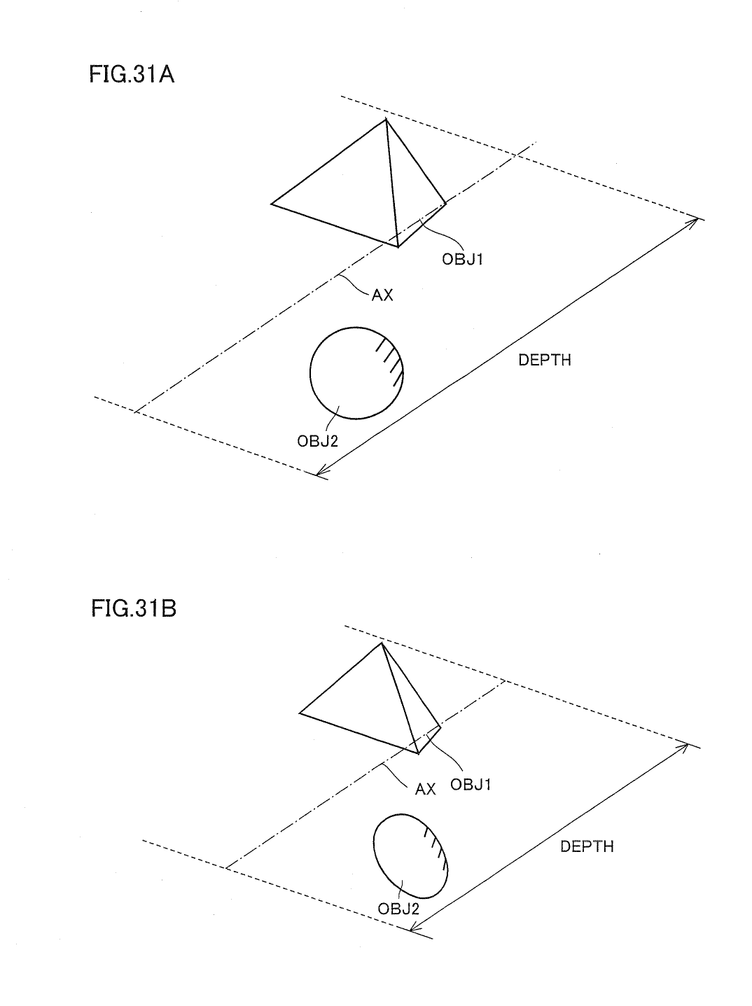

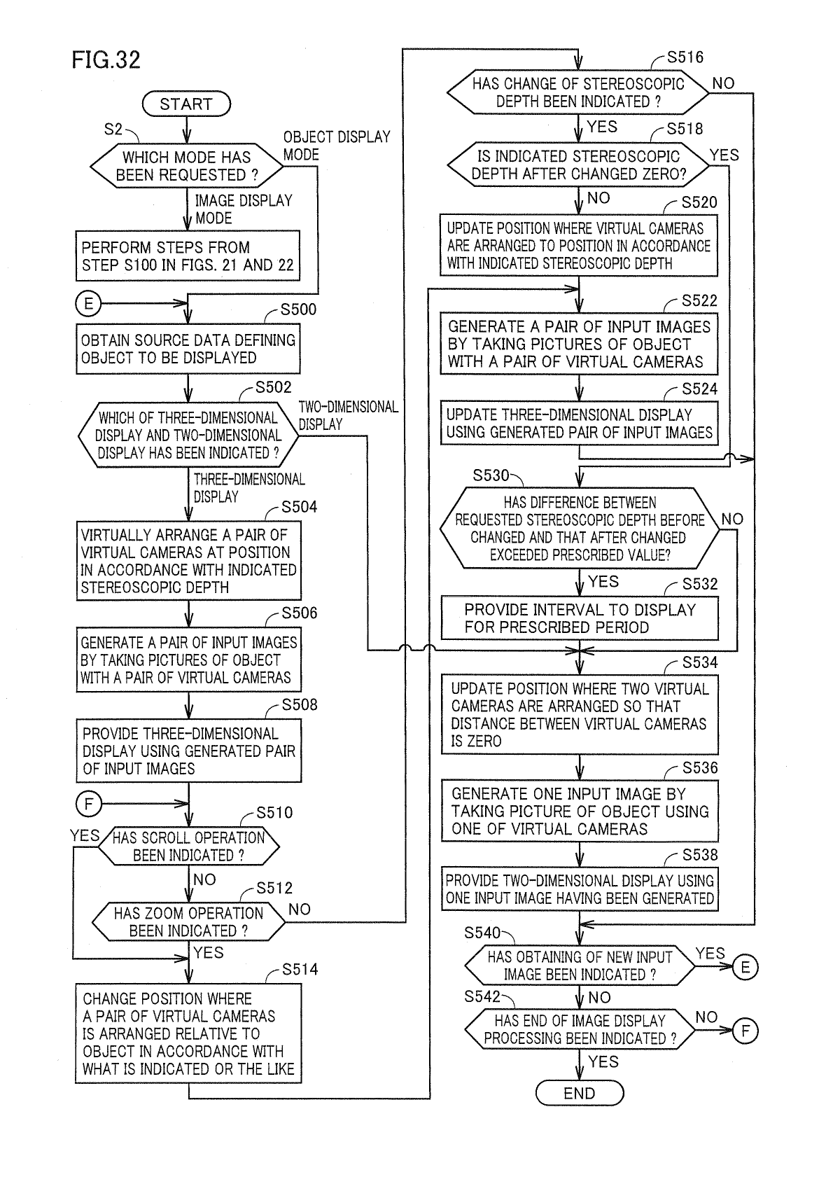

As described above, in the object display mode of the present embodiment, a pair of input images having a successively changed parallax can be generated. The parallax between input images that is determined by the camera position determines the stereoscopic depth that can be expressed. For example, three-dimensional display by means of the pair of input images generated under the condition as show in FIG. 29A is the one as shown in FIG. 31A. In contrast, when input images having a parallax therebetween that is reduced by adjustment of the stereoscopic depth by means of the camera position as shown in FIG. 29B are used, the resultant three-dimensional display has a reduced stereoscopic depth as shown in FIG. 31B. Namely, a parallax between input images of a pair to be used for three-dimensional display can be successively varied (decreased or increased) to successively adjust the stereoscopic depth of three-dimensional display expressed by display 10 (adjustment of stereoscopic depth by camera position).

Further, when relative distance Df between two virtual cameras is made zero as shown in FIG. 29C, display 10 provides three-dimensional display where the parallax between the images generated by the two virtual cameras is zero, namely two-dimensional display (not shown).

Therefore, in the object display mode of the present embodiment, display 10 is switched between three-dimensional display and two-dimensional display, by successively decreasing relative distance Df between paired virtual cameras, from a non-zero value to zero. Further, when the relative distance between paired virtual cameras is made zero, display switch unit 256c (FIG. 28) causes display 10 to display the input image that is generated by one of first virtual camera 254 and second virtual camera 264 (FIG. 28) and thereby provides two-dimensional display.

In the object display mode, as described above, the stereoscopic depth is successively decreased by adjusting the stereoscopic depth using the camera position, and therefore, this adjustment does not cause a jump-like change of the stereoscopic depth. Therefore, unlike the image display mode, an interval is not necessarily required when a switch is made from three-dimensional display to two-dimensional display.

In the case, however, where a mechanism (slider) as shown in FIGS. 12 to 14 is used for adjusting the stereoscopic depth by the camera position, the stereoscopic depth may be considerably changed by adjustment of the stereoscopic depth by means of the camera position, depending on the user's operation. In such a case, in order to provide a more naturally perceived switch of display from three-dimensional display to two-dimensional display, an interval is preferably provided. Namely, only when a user's operation for example satisfies a prescribed condition, an interval is preferably provided for a prescribed period in switch from three-dimensional display to two-dimensional display. More specifically, when a user performs a switching operation from a state of relatively large stereoscopic depth to two-dimensional display, for example, an interval is also provided even when the stereoscopic depth is adjusted by means of the camera position.

The above description provides an example of the configuration to adjust the parallax by successively changing relative distance Df between a pair of virtual cameras. Instead of changing this relative distance Df, or in addition to changing the distance, the direction in which the virtual camera is disposed may be changed. Specifically, the optical axis of the field of view of the virtual camera can be rotated about the viewpoint to adjust the parallax between generated input images. In this case, an object located at the intersection of respective optical axes of the fields of two virtual cameras is located near the display surface of display 10.

Processing Procedure

FIG. 32 is a flowchart showing an entire processing procedure of image display control by information processing system 2 according to the second embodiment of the present invention. Each step shown in FIG. 32 is typically provided by execution of a program by CPU 100 of information processing system 2.

Referring to FIG. 32, CPU 100 first determines which mode has been requested (step S2).

When the image display mode has been selected (“image display mode” in step S2), the processing in the flowchart of FIGS. 21 and 22 is performed from step S100. Details of the processing in the flowchart of FIGS. 21 and 22 have been described above, and the detailed description will not be repeated.

In contrast, when the object display mode has been selected (“object display mode” in step S2), CPU 100 obtains source data defining an object to be displayed (step S500). Specifically, the source data is obtained from an application being executed, for example, and stored in source data buffer 252 (FIG. 28). In subsequent step S502, CPU 100 determines which of three-dimensional display and two-dimensional display has been indicated. Specifically, CPU 100 determines whether the slider (FIGS. 12 to 14) which is a typical example of input portion 106 (FIG. 1) is located at the position for three-dimensional display. When three-dimensional display has been indicated (“three-dimensional display” in step S502), the process proceeds to step S504. In contrast, when two-dimensional display has been indicated (“two-dimensional display” in step S502), the process proceeds to step S534.

In step S504, CPU 100 virtually arranges a pair of virtual cameras on a virtual space so that the distance between the two cameras is a relative distance corresponding to a specified stereoscopic depth. In subsequent step S506, CPU 100 uses the pair of virtual cameras to take a picture of an object on the virtual space and thereby generate a pair of input images. In further subsequent step S508, CPU 100 uses the generated pair of input images to provide three-dimensional display on display 10. Specifically, CPU 100 writes input images IMG1 and IMG2 generated respectively by first virtual camera 254 and second virtual camera 264 in first VRAM 112 and second VRAM 122, respectively. Then, the process proceeds to step S510.

In step S510, CPU 100 determines whether a scroll operation has been indicated. When the scroll operation has been indicated (YES in step S510), the process proceeds to step S514. Otherwise (NO in step S510), the process proceeds to step S512.

In step S512, CPU 100 determines whether a zoom operation has been indicated. When the zoom operation has been indicated (YES in step S512), the process proceeds to step S514. Otherwise (NO in step S512), the process proceeds to step S516.

In step S514, CPU 100 changes the positions where the paired virtual cameras are arranged relative to the object, following what is indicated (zoom-in/zoom-out ratio or scroll amount) in step S510 or 5512. Specifically, when zoom-in (enlargement of the object) is indicated, the relative distance of the pair of virtual cameras to the object is decreased. On the contrary, when zoom-out (contraction of the object) is indicated, the relative distance of the pair of virtual cameras to the object is increased. At this time, the distance (relative distance) between the virtual cameras is maintained, in order to maintain the magnitude of a parallax between the paired images generated by the paired virtual cameras. Then, the process proceeds to step S522.

In step S516, CPU 100 determines whether change of the stereoscopic depth to be expressed by display 10 has been indicated. Specifically, CPU 100 determines whether the position of the slider (FIGS. 12 to 14) which is a typical example of input portion 106 (FIG. 1) has been changed. When change of the stereoscopic depth by adjustment of the camera position (adjustment of stereoscopic depth by camera position) has been indicated (YES in step S516), the process proceeds to step S518. In contrast, when change of the stereoscopic depth (adjustment of stereoscopic depth by camera position) has not been indicated (NO in step S516), the process proceeds to step S540.

In step S518, CPU 100 determines whether the changed stereoscopic depth (after the stereoscopic depth is adjusted by camera position) as indicated is zero. Specifically, CPU 100 determines whether the slider (FIGS. 12 to 14) which is a typical example of input portion 106 (FIG. 1) has been moved to the position for two-dimensional display (2D) (more specifically to operation parameter Omin as described above). When the changed stereoscopic depth as indicated is not zero (NO in step S518), the process proceeds to step S520.

In step S520, CPU 100 updates respective positions, on the virtual space, of the virtual cameras, so that the distance between the two virtual cameras is a relative distance corresponding to the specified stereoscopic depth. Then, the process proceeds to step S522. More specifically, as described above, while operation accepting unit 224 outputs a value from Omin to Omax as a user operation parameter value according to the position of slider 1062, control unit 222 calculates, in the dynamic mode, D2 min to D2max as a relative distance between the two virtual cameras, for operation parameter values Omin to Omax. It is supposed that, in the present embodiment, the relative distance is D2min for the user operation parameter of Omin and the relative distance is D2max for the user operation parameter of Omax. In the present embodiment, there is a relation that a value larger than Omin and smaller than Omax corresponds to a value larger than Dmin and smaller than Dmax and D2 is larger for a larger O.

In step S522, CPU 100 uses a pair of virtual cameras to take a picture of an object on the virtual space to thereby generate a pair of input images. In further subsequent step S524, CPU 100 uses the generated pair of input images to update three-dimensional display on display 10. Then, the process proceeds to step S540.

In contrast, when the changed stereoscopic depth as indicated is zero (YES in step S518), the process proceeds to step S530.

In step S530, CPU 100 determines whether a difference between the requested stereoscopic depth before changed and that after changed has exceeded a prescribed value. Namely, CPU 100 determines whether a user has performed operation that considerably decreases the stereoscopic depth.

When the difference between the requested stereoscopic depth before changed and that after changed has exceeded a prescribed value (YES in step S530), the process proceeds to step S532. Otherwise (NO in step S530), the process proceeds to step S534.

In step S532, CPU 100 provides an interval to display 10 for a prescribed period. Specifically, CPU 100 causes (i) substantial stoppage of display on display 10, (ii) display of an independent insert image, (iii) display of a predetermined effect, or the like. Then, the process proceeds to step S534.

In step S534, CPU 100 updates the position where each virtual camera is arranged on the virtual space so that the distance between the two virtual cameras is zero. Namely, CPU 100 arranges the two virtual cameras at the same portion on the virtual space. In subsequent step S536, CPU 100 generates a pair of input images by taking a picture of an object on the virtual space by means of one of the virtual cameras. In subsequent step S538, CPU 100 outputs the generated input image to display 10 so that the object is two-dimensionally displayed on display 10. Then, the process proceeds to step S540.

In step S540, CPU 100 determines whether it has been indicated that a new input image should be obtained. When it has been indicated that a new input image should be obtained (YES in step S540), the processing is repeated from step S500. Namely, new source data is read as data to be processed. Otherwise (NO in step S540), the process proceeds to step S542.

In step S542, CPU 100 determines whether it has been indicated that the image display processing should be ended. When it has been indicated that the image display processing should be ended (YES in step S542), the processing is ended. Otherwise (NO in step S542), the processing is repeated from step S510.

### OTHER MODIFICATIONS

In the embodiments described above, a processing example in which scanning in the X direction and the Y direction is carried out in determining a correspondence between input image IMG1 and input image IMG2 has been shown. In addition thereto, however, a correspondence may be determined in consideration of a direction of rotation, trapezoidal distortion, or the like. In particular, such processing is effective in determining a base position of superimposition of input image IMG1 and input image IMG2.

In addition, in the embodiments described above, a processing example where a base position of superimposition is obtained at the time of start of image display processing has been shown, however, the base position of superimposition may be stored in advance as a parameter specific to a device. In this case, such a calibration function is preferably provided to a device at the time of shipment of a product. Further, such a function may be performed at any timing, for example, by a hidden command. The calibration function preferably includes processing for setting image pick-up sensitivity of first image pick-up portion 110 and second image pick-up portion 120 to be substantially equal to each other, because occurrence of an error can be suppressed when a matching score is evaluated based on a difference in color between pixels as described above.

Furthermore, in the embodiments described above, a processing example where a base position of superimposition is updated when a new input image is obtained has been shown. On the other hand, in a case where variation in contents is very small despite the fact that an input image itself is periodically updated as in the case of a stationary camera, the base position of superimposition does not necessarily have to be updated. In this case, the base position of superimposition may be updated only when variation by an amount equal to or more than a prescribed value is produced in contents of an input image.

In the embodiments described above, the position of superimposition of input image IMG1 and input image IMG2 is adjusted such that objects OBJ1 seen in input images IMG1 and IMG2 are substantially superimposed on each other. Instead, adjustment may be made such that object OBJ1 is displayed at a position displaced by a prescribed displace amount within a range of a parallax amount tolerable by the user. In this case, for example, in step S116 in the flowchart shown in FIG. 25, display on display 10 may be controlled such that each of the input images is displaced by a prescribed amount from the position of superimposition achieving the highest matching score. By doing so, the input image can be displayed such that object OBJ1 is positioned in the front or in the rear by a prescribed amount relative to the display surface of the display.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A non-transitory storage medium encoded with a computer readable display control program and executable by a computer for controlling a display capable of providing three-dimensional display, the computer readable display control program comprising:
three-dimensional display processing instructions for performing display processing using a first input image and a second input image containing a common object to be displayed and having a parallax, so that said object is three-dimensionally displayed by said display;
two-dimensional display processing instructions for performing display processing so that said object is two-dimensionally displayed as a two-dimensional image by said display; and
display switch instructions for making a switch between three-dimensional display and two-dimensional display provided by said display,
said display switch instructions being adapted to perform display processing, when a switch is made between a state of three-dimensionally displaying said object and a state of two-dimensionally displaying said object, so that said object is substantially non-displayed by said display for a prescribed period.

2. The non-transitory storage medium encoded with a computer readable display control program according to claim 1, wherein
said three-dimensional display processing instructions include stereoscopic depth determination instructions for determining a stereoscopic depth of three-dimensional display, by setting a relative positional relation, when said first input image and said second input image are displayed, between said first input image and said second input image having a prescribed parallax.

3. The non-transitory storage medium encoded with a computer readable display control program according to claim 2, wherein
said stereoscopic depth determination instructions include stereoscopic depth adjustment instructions for adjusting the stereoscopic depth of three-dimensional display by laterally changing said relative positional relation.

4. The non-transitory storage medium encoded with a computer readable display control program according to claim 3, wherein
said stereoscopic depth adjustment instructions are adapted to successively change said relative positional relation, and
said display switch instructions are adapted to make a switch from three-dimensional display to two-dimensional display when said relative positional relation satisfies a prescribed condition.

5. The non-transitory storage medium encoded with a computer readable display control program according to claim 4, wherein
said stereoscopic depth adjustment instructions are adapted to successively adjust the stereoscopic depth of three-dimensional display within a prescribed range from a shallowest side to a deepest side, by changing said relative positional relation, and
said display switch instructions are adapted to make a switch from three-dimensional display to two-dimensional display when said stereoscopic depth reaches the deepest side of said prescribed range.

6. The non-transitory storage medium encoded with a computer readable display control program according to claim 2, wherein
said three-dimensional display processing instructions include partial image determination instructions for determining a first partial image and a second partial image that are respectively a partial area of said first input image and a partial area of said second input image and to be output to said display, in accordance with said relative positional relation set by execution of said stereoscopic depth determination instructions.

7. The non-transitory storage medium encoded with a computer readable display control program according to claim 6, wherein
said stereoscopic depth determination instructions include stereoscopic depth adjustment instructions for adjusting the stereoscopic depth of three-dimensional display by laterally changing said relative positional relation, and
said partial image determination instructions are adapted to change at least one of the partial area of said first input image and the partial area of said second input image to be output to said display, in accordance with adjustment of the stereoscopic depth made by execution of said stereoscopic depth adjustment instructions.

8. The non-transitory storage medium encoded with a computer readable display control program according to claim 6, wherein
said stereoscopic depth determination instructions include stereoscopic depth adjustment instructions for adjusting the stereoscopic depth of three-dimensional display by successively changing said relative positional relation, and
said two-dimensional display processing instructions are
adapted to determine at least one of said first partial image and said second partial image, in accordance with a relative positional relation determined independently of change of said relative positional relation by execution of said stereoscopic depth adjustment instructions, immediately after a switch is made from three-dimensional display to two-dimensional display by execution of said display switch instructions, and
adapted to cause the display to display an image based on at least one of said first partial image and said second partial image.

9. The non-transitory storage medium encoded with a computer readable display control program according to claim 8, wherein
said two-dimensional display processing instructions are adapted to determine at least one of said first partial image and said second partial image based on a base relative positional relation between said first input image and said second input image, immediately after a switch is made from three-dimensional display to two-dimensional display by execution of said display switch instructions.

10. The non-transitory storage medium encoded with a computer readable display control program according to claim 1, wherein
said display control program further comprises input instructions for accepting a user's operation for increasing or decreasing a prescribed parameter associated with a stereoscopic depth, and
said input instructions are adapted to generate a request to make a switch between three-dimensional display and two-dimensional display based on a value of said prescribed parameter.

11. The non-transitory storage medium encoded with a computer readable display control program according to claim 10, wherein
said input instructions are adapted to accept, as said user's operation for increasing or decreasing said prescribed parameter, an operation of sliding a slider in a prescribed direction.

12. The non-transitory storage medium encoded with a computer readable display control program according to claim 1, wherein
said display switch instructions are adapted to substantially stop display provided by said display for a prescribed period of making a switch from a state of three-dimensionally displaying said object to a state of two-dimensionally displaying said object.

13. The non-transitory storage medium encoded with a computer readable display control program according to claim 1, wherein
said display switch instructions are adapted to cause said display to display a presentation independent of said first input image and said second input image for a prescribed period of making a switch from a state of three-dimensionally displaying said object to a state of two-dimensionally displaying said object.

14. The non-transitory storage medium encoded with a computer readable display control program according to claim 1, wherein
said display switch instructions are adapted to cause said display to display an insert image independent of said first input image and said second input image for a prescribed period of making a switch from a state of three-dimensionally displaying said object to a state of two-dimensionally displaying said object.

15. The non-transitory storage medium encoded with a computer readable display control program according to claim 14, wherein
said display switch instructions are adapted to cause said insert image that has been prepared to be displayed.

16. The non-transitory storage medium encoded with a computer readable display control program according to claim 15, wherein
said insert image includes a substantially monochrome image.

17. The non-transitory storage medium encoded with a computer readable display control program according to claim 16, wherein
said substantially monochrome image is a black image.

18. The non-transitory storage medium encoded with a computer readable display control program according to claim 1, wherein
said two-dimensional display processing instructions are adapted to cause, immediately after a switch is made from three-dimensional display to two-dimensional display, said display to display an image that is based on at least one of said first input image and said second input image having been used for immediately preceding three-dimensional display.

19. The non-transitory storage medium encoded with a computer readable display control program according to claim 18, wherein
said two-dimensional display processing instructions are adapted to cause, immediately after a switch is made from three-dimensional display to two-dimensional display, said display to display an image that is one of said first input image and said second input image having been used for immediately preceding three-dimensional display.

20. An information processing system comprising:
a display capable of providing three-dimensional display;
a three-dimensional display processing unit for performing display processing using a first input image and a second input image containing a common object to be displayed and having a parallax, so that said object is three-dimensionally displayed by said display;
a two-dimensional display processing unit for performing display processing so that said object is two-dimensionally displayed as a two-dimensional image by said display; and
a display switch unit for making a switch between three-dimensional display and two-dimensional display provided by said display,
said display switch unit being configured to control said display, when a switch is made between a state of three-dimensionally displaying said object and a state of two-dimensionally displaying said object, so that said object is substantially non-displayed for a prescribed period.

21. The information processing system according to claim 20, wherein
said three-dimensional display processing unit includes:
a first stereoscopic depth setting unit for setting a relative positional relation between said first input image and said second input image to a value in accordance with a requirement of three-dimensional display; and
a first output unit for outputting to said display, for a first display target area and a second display target area that are set respectively for said first input image and said second input image in accordance with said relative positional relation, a first partial image included in said first display target area and a second partial image included in said second display target area, and
said two-dimensional display processing unit is configured to cause said display to display an image based on at least one of said first partial image and said second partial image obtained when the relative positional relation between said first input image and said second input image is substantially matched to a base relative positional relation determined based on a correspondence between said first input image and said second input image.

22. The information processing system according to claim 21, further comprising:
an image input unit for accepting a pair of images having a prescribed parallax;
an image generation unit for generating a pair of images by taking pictures of an object on a virtual space using a pair of virtual cameras; and
a mode switch unit for setting the pair of images accepted by said image input unit as said first input image and said second input image in a first mode, and setting the pair of images generated by said image generation unit as said first input image and said second input image in a second mode, wherein
said three-dimensional display processing unit includes:
a second stereoscopic depth setting unit for setting a relative distance between said pair of virtual cameras to a value in accordance to a requirement of three-dimensional display; and
a second output unit for outputting said first input image and said second input image to said display, and
said first stereoscopic depth setting unit and said first output unit are activated in said first mode, and said second stereoscopic depth setting unit and said second output unit are activated in said second mode.

23. The information processing system according to claim 22, wherein
said three-dimensional display processing unit successively changes a relative positional relation between said first input image and said second input image in response to a user's operation of adjusting a stereoscopic depth in said first mode, and
said three-dimensional display processing unit successively changes a relative distance between said pair of virtual cameras in response to a user's operation of adjusting a stereoscopic depth in said second mode.

24. The information processing system according to claim 23, wherein
said two-dimensional display processing unit is configured to cause said display to display one of the pair of input images generated by said image generation unit when the relative distance between said pair of virtual cameras is made zero in said second mode.

25. The information processing system according to claim 24, wherein
in said second mode, said display switch unit makes a switch between three-dimensional display and two-dimensional display of said display by giving an instruction to said second stereoscopic depth setting unit so that the relative distance between said pair of virtual cameras is zero, while providing no period in which said object is substantially non-displayed.

26. The information processing system according to claim 25, wherein
in said second mode, said display switch unit causes said object to be substantially non-displayed for a prescribed period of making a switch from three-dimensional display to two-dimensional display when a prescribed condition is satisfied.

27. The information processing system according to claim 22, wherein
said image input unit includes a pair of image pick-up portions.

28. The information processing system according to claim 20, further comprising an input unit for accepting a user's operation on a prescribed parameter associated with a degree involved with three-dimensional display and associated with a switch between three-dimensional display and two-dimensional display.

29. The information processing system according to claim 28, wherein
said three-dimensional display processing unit successively changes a relative positional relation between said first input image and said second input image, in accordance with a user's operation on said prescribed parameter in a first mode, and
said three-dimensional display processing unit successively changes a relative distance between a pair of virtual cameras, in accordance with a user's operation on said prescribed parameter in a second mode.

30. The information processing system according to claim 28, wherein
said input unit includes a mechanism capable of being slid along a prescribed uniaxial direction.
